(19) United States
(12) Patent Application Publication
(10) Pub. No.: US 2026/0148652 A1
(43) Pub. Date: May 28, 2026

(54) Artificial Intelligence (AI)-Driven Interactive Assessment Question Generation System and Method for Adaptive Personalized, Course-specific Assessment and Class Level Course-specific Assessment

(71) Applicant: The Texas A&M University System, College Station, TX (US)

(72) Inventors: Rujun Gao, College Station, TX (US); Arun Srinivasa, College Station, TX (US)

(21) Appl. No.: 19/402,828

(22) Filed: Nov. 26, 2025

Related U.S. Application Data
(60) Provisional application No. 63/725,460, filed on Nov. 26, 2024.

(51) Int. Cl. G09B 7/00; G06F 40/40

(52) U.S. Cl. CPC G09B 7/00; G06F 40/40

(57) ABSTRACT

A computer-implemented method of providing artificial intelligence (AI)-driven personalized adaptive assessment question generation based on instructor-specific course material, student-specific query-response data and student-specific assessment scores, the method including receiving course material for a particular course from a knowledge database; receiving student query-response data between an individual student and an interactive natural language-based teaching assistant and associated with the particular course; receiving student scores of the individual student associated with assessments corresponding to the particular course; identifying a knowledge concept associated with a learning difficulty of the individual student based on the course material, the student query-response data, and the student scores; generating prompts including the course material and the particular knowledge concept; initiating large-language models (LLMs) to generate questions for the individual student based on the prompts; receiving the questions from the LLMs; and outputting the questions to a user device associated with the individual student.

### CROSS-REFERENCE TO RELATED APPLICATIONS

This application claims the benefit of U.S. Provisional Application No. 63/725,460, filed Nov. 26, 2025, the contents of which are incorporated herein by reference in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Student-teacher interaction is an important part of a learning process for students and an important part of a teaching process for teachers. For example, a teacher may teach certain lessons to a class of students in a physical classroom or virtually online. As part of the teaching process, the teacher may utilize certain teaching materials (e.g., textbooks) and/or generate their own teaching materials (e.g., class notes, lecture notes, presentation slides, etc.). The teacher may also create homework assignments, quizzes, and/or exams,, or other formative or summative assessment methods such as projects and scenario-based assessments (including games, case studies, dialogues, etc.) to assess the student's understanding and knowledge of the taught lessons. As part of the learning process, the students may attend classes, work on their homework assignments, and take quizzes and/or exams. Additionally, the students may ask the teacher questions and may receive answers from the teacher. In a higher-educational institution (e.g., a university), a professor may teach multiple classes with many students (e.g., hundreds of students), thus it may be impractical for the professor to personally answer each student's question. Teaching assistants are commonly used to enhance student's learning experience and bridge the gap between students and professors. As computer technologies (e.g., using artificial intelligence (AI)) advance, there is a continual demand to integrate computer technologies to enhance the educational process.

### SUMMARY

In an embodiment, a computer-implemented method of providing artificial intelligence (AI)-driven personalized adaptive assessment question generation based on instructor-specific course material, student-specific query-response data, and student-specific assessment scores is provided. The method includes receiving, by an exam generator stored in non-transitory memory of a computer system and executable by a processor of the computer system, course material for a particular course from a knowledge database; receiving, by the exam generator, student query-response data between an individual student and an interactive natural language-based teaching assistant (TA), the student query-response data being associated with the particular course; receiving, by the exam generator, student scores of the individual student associated with assessments corresponding to the particular course; identifying, by the exam generator, at least one particular knowledge concept associated with a learning difficulty of the individual student based on the course material, the student query-response data of the individual student, and the student scores of the individual student; generating, by the exam generator, one or more prompts including the course material and the at least one particular knowledge concept; initiating, by the exam generator, one or more large-language models (LLMs) to generate one or more questions for the individual student based on the one or more prompts; receiving, by the exam generator, the one or more questions from the one or more LLMs; and outputting, by the exam generator, the one or more questions to a user device associated with the individual student.

In another embodiment, a computer-implemented method of providing artificial intelligence (AI)-driven course-specific assessment question generation based on an instructor-defined framework is provided. The method includes receiving, by an exam generator platform comprising at least one memory and at least one processor, course material for a particular course from a knowledge database; receiving, by the exam generator platform, from a user device associated with an instructor of the particular course, one or more learning concepts and an assessment goal for the particular course; generating, by the exam generator platform, one or more prompts comprising the course material, the one or more learning concepts, and the assessment goal for the particular course; initiating, by the exam generator platform, a large language model (LLM) to generate one or more questions for one or more students based on the one or more prompts; receiving, by the exam generator platform, the one or more questions from the one or more LLMs; and providing, by the exam generator platform, the one or more questions to the one or more students.

In yet another embodiment, a system for providing interactive course-specific assessment question generation with dynamic augmentation to an exam library based on instructor-verified questions is provided. The system includes at least one processor; at least one non-transitory memory; a knowledge database comprising course material of a particular course; an exam library comprising verified questions associated with the course material of the particular course; and an exam generator comprising instructions stored in the at least one non-transitory memory and executable by the at least one processor, when executed by the processor, causes the exam generator to receive an indication of one or more knowledge concepts and an assessment goal for the particular course; generate one or more prompts including the course material, the one or more knowledge concepts, and the assessment goal; initiate one or more large-language models (LLMs) to generate one or more questions for one or more students based on the one or more prompts; receive, from the one or more LLMs, the one or more questions; transmit, to a user device associated with an instructor of the particular course, the one or more questions; receive, from the user device associated with the instructor, a verification of at least a first question of the one or more questions; and add, based on the verification, the first question to the exam library.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system that provides interactive natural language-based teaching assistance to students using large language models (LLMs) according to an embodiment of the disclosure.

FIG. 2 is a sequence diagram illustrating an example method for providing interactive natural language-based teaching assistance to students according to an embodiment of the disclosure.

FIGS. 3A and 3B are flow charts illustrating an example method for providing interactive natural language-based teaching assistance to students according to an embodiment of the disclosure.

FIGS. 4A-4B are block diagrams illustrating example user interfaces (UIs) according to an embodiment of the disclosure.

FIG. 5 is a block diagram illustrating an example method for providing teaching feedback for an individual instructor according to an embodiment of the disclosure.

FIG. 6 is a block diagram illustrating an example method for providing teaching feedback across multiple instructors teaching the same course according to an embodiment of the disclosure.

FIG. 7 is a flow chart of a method according to an embodiment of the disclosure.

FIG. 8 is a flow chart of another method according to an embodiment of the disclosure.

FIG. 9 is a flow chart of yet another method according to an embodiment of the disclosure.

FIG. 10 is a flow chart of yet another method according to an embodiment of the disclosure.

FIG. 11 is a block diagram illustrating an example method for generating assessment questions according to an embodiment of the disclosure.

FIG. 12 is a block diagram illustrating an example user interface (UI) associated with assessment question generation according to an embodiment of the disclosure.

FIG. 13 is a flow chart of an example method for providing personalized adaptive assessment question generation according to an embodiment of the disclosure.

FIG. 14 is a flow chart of an example method for providing course-specific class level assessment question generation according to an embodiment of the disclosure.

FIG. 15 is a flow chart of an example method for providing interactive assessment question generation with dynamic exam library augmentation according to an embodiment of the disclosure.

FIG. 16A is a block diagram illustrating an example UI associated with evaluation of student assessment according to an embodiment of the disclosure.

FIG. 16B is a block diagram illustrating an example UI associated with an evaluation output according to an embodiment of the disclosure.

FIG. 17 is a flow chart of an example method of providing automatic evaluation of student assessment based on multiple LLMs according to an embodiment of the disclosure.

FIG. 18 is a flow chart of an example method of providing assessment evaluation with dynamic rubric update and batch re-evaluation according to an embodiment of the disclosure.

FIG. 19 is a flow chart of an example method of providing automatic evaluation of reports with evaluation comments embedded in the reports according to an embodiment of the disclosure.

FIG. 20 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The terms “teacher,” “professor,” “educator,” and “instructor” may be used interchangeably herein, such that a description referring to one of the terms shall be treated as though the description also referred to the other term. Further, the terms “teacher,” “professor,” “educator,” and “instructor” may refer to a human instructor unless otherwise stated.

The terms “course materials,” “learning materials,” and “teaching materials” may be used interchangeably herein, such that a description referring to one of the terms shall be treated as though the description also referred to the other term.

Natural language processing (NLP) is a branch of artificial intelligence (AI) technology that focuses on interaction between computers and humans through natural language. For instance, NLP may use machine learning (ML) to provide computers with the ability to interpret, manipulate, comprehend, and extrapolate human language and to respond using human-like language. Recent advancements in NLP include the development of large-language models (LLMs) (e.g., including generative pre-trained transformer (GPT) models and bidirectional encoder representations from transformer (BERT) models). An LLM may have a large number of parameters (e.g., thousands, millions, or billions of parameters) trained on large datasets (e.g., text data). The LLM may be trained to learn complex patterns and dependencies in language to generate text (e.g., for answering questions) that is coherent, contextually relevant, and often indistinguishable from text written by humans. In some cases, a small language model with fewer parameters than traditional LLMs may be trained on a specific subject matter that can be run on local servers.

As discussed above, TAs are commonly used to enhance student learning experience and to bridge the gap between students and teachers or professors. In a university setting, many professors may not teach directly from textbooks as that may not reflect the professors'voice. Instead, the professors may prepare their own lecture notes, teach their students to solve problems using their own approaches, and expect their students to answer questions in homework assignments, quizzes, and/or exams using those approaches. Thus, a TA for a particular class of students taught by a particular professor may utilize course materials (e.g., lecture notes, presentations, questions and answers, audio recordings of lectures, and/or video recordings of lectures) prepared by the respective professor to guide and assist those students in understanding lessons taught by that particular professor. More specifically, the TA may review the course materials with the students, guide the students in completing their homework assignments (e.g., solving problems using a particular approach taught by the professor), and/or explain the answers to certain questions in past quizzes and/or exams (e.g., as expected by the professor). Generally, the students may ask questions about the lessons, homework, and/or test results for that class, and the TA may provide answers according to the course materials prepared by the particular professor. Using human TAs to bridge the gap between students and professors can be costly and not easily scalable. Additionally, students may be limited to receiving assistance from a TA only during certain office hours and at a certain location.

From the teaching perspective, a professor may desire to gain insights into the student learning performance so that the professor may improve their teaching approach and better connect to the students. One way for the professor to assess the student learning performance is to gather student work products from homework assignments, student answers to reading comprehension questions directed to texts, notes, and/or videos related to the class or course, and student grades from tests (e.g., quizzes and/or exams). Another way is for the professor to ask a TA for insights into the student learning performance (e.g., prior to receiving homework and test results from the students). For instance, the professor may ask a TA: “what concept do my students struggle with the most?” However, the insights provided by the TA may be subjective and may or may not be accurate. To gain insights into teaching approaches or instructional styles, the professor may ask students for feedback (e.g., via surveys) regarding their teachings (e.g., their class notes, presentations, teaching style, etc.). However, some students may ignore the surveys or be reluctant to provide any feedback to the professor.

With the recent advancements in LLM technologies (e.g., Chat GPT), chatbots using LLMs can be developed to converse with students and answer student questions related to their studies. Unfortunately, the nature of LLM introduces unpredictability in LLM responses. For instance, an LLM may provide a response that is inaccurate or false. In some cases, LLM responses to questions may have subtle but critical errors that can only be identified by instructors or experts. Additionally, an LLM may simply provide answers to a student's specific question or homework assignment without the specific focus to guide the student in learning a concept and thinking through the steps to solve a problem by themselves, let alone a professor-specific problem-solving approach. Thus, using chatbots that are based on currently available LLMs can have a negative impact on student learning. Further, there is a lack of a model that can promote student-teacher interactions and provide insights and/or feedback to a teacher or professor.

The present disclosure provides a technical solution to the aforementioned technical problems in the technical field of NLP-based or AI-based educational assistance. The present disclosure provides an interactive NLP-based, course-specific, and/or instructor-specific educational assistance computer system (e.g., an integrated computer system platform) that can enhance learning experience for students, teaching experience for teachers, and student-teacher interactions. More specifically, the present disclosure provides an advanced architecture for an intelligent TA system (referred to as a “ChaTA system” hereinafter) that can provide efficient, context-aware responses to student inquiries using multiple LLMs. To provide course-specific and/or instructor-specific teaching assistance, the ChaTA system utilizes a knowledge database built from course-specific and/or instructor-specific course materials and utilizes LLMs to generate responses to student queries using the knowledge database. To verify the accuracy of responses generated by an LLM, the ChaTA system utilizes software tools (e.g., mathematical software, software development tools, course-specific software and simulators, other LLM(s), etc.) independent of (separate from) the LLM that generated the response. The ChaTA system may only provide an LLM generated response to a student query after the LLM generated response is verified to be accurate. To promote student-teacher interaction and enable reinforcement learning with human feedback (RLHF), the ChaTA system includes a student-teacher communication channel or pipeline that enables a student to communicate with a human instructor when an LLM generated response to a student query is unsatisfactory (e.g., the response is incomplete, does not make sense, seems inaccurate, and/or, generally, does not answer the student query). The communication channel also enables a human instructor to provide feedback about an LLM generated response to a student query. For instance, the human instructor may indicate, via the communication channel, that an LLM generated response is accurate (e.g., in alignment with the respective course materials) or provide a modified response when an LLM generated response is inaccurate. The ChaTA system (e.g., parameters of the LLMs and/or the content of the knowledge database) may be fine-tuned based on feedback from the student and/or the human instructor.

According to an embodiment of the present disclosure, a network system for providing interactive NLP-based, course-specific, and/or instructor-specific teaching assistance to students may include a knowledge database (e.g., a first database), an experience database (e.g., a second database), multiple LLMs, and a ChaTA system. The knowledge database may include course-specific and/or instructor-specific course materials and/or course-specific logistic information. The course materials may include, for example, but are not limited to, textbooks, class notes, presentation slides (e.g., Microsoft PowerPoint presentations), documents (e.g., Microsoft Word documents, portable document format (PDF) documents), audio and/or video recordings of lectures or lessons, transcripts of lecture or lesson recordings for a specific course and/or prepared by a specific instructor. The course-specific logistic information may include, for example, but is not limited to, course enrollment information, course syllabus, professor office hours, human TA office hours, homework schedules, quizzes schedules, and exam schedules. The ChaTA system may include a natural language-based TA agent (which may be referred to as a ChaTA agent) including instructions stored in memory of the ChaTA system and executable by a processor of the ChaTA system. The natural language-based TA application may communicate with a student and a human instructor respectively via a student client application executing on a computing device of the student and an instructor client application executing on a computing device of the instructor.

At a high level, the natural language-based TA agent (e.g., a server application) may communicate with the student client application to receive student queries from the student. The natural language-based TA application may utilize one or more of the LLMs to generate responses to the student queries using the knowledge database. The student and/or the human instructor may provide feedback about responses generated by an LLM. The student may also request a response from the human instructor upon receiving an unsatisfactory response generated by an LLM. The natural language-based TA application may cache or store a history of student queries and corresponding responses communicated with the student and/or the human instructor in the experience database. To ensure data privacy, the knowledge database and the experience database may be stored in a private network system of an educational institution (e.g., university, college, school) and the LLMs may be executed locally on a computer system (e.g., the ChaTA system) within the private network system.

In an embodiment, the natural language-based TA agent may receive a student query in natural language from the student client application executing on the student computing device. Upon receiving the student query, the natural language-based TA application may apply a query filter to the student query to eliminate a list of questions of particular type(s) (e.g., irrelevant or offensive). The filtering may include keyword filtering (e.g., using keyword searches) and/or content filtering (e.g., using sentiment analysis with LLM processing). If the student query is of one of the particular type(s) (i.e., irrelevant or offensive), the natural language-based TA agent may return a response, for example, indicating that the student query cannot be answered. Otherwise, the natural language-based TA agent may proceed to generate one or more system prompts (e.g., multiple system prompts) based on the student query. Generally, the filtering may be applied to eliminate questions that are unassociated with any one of the learning concepts or learning goals of the specific course. The system prompts may be used to guide (or prompt) an LLM in generating a response to the student query. More specifically, the system prompts may indicate which course is associated with the student query, who is the instructor, and where the LLM can find course materials or information to answer the student query. The system prompts may also provide specific instructions (e.g., step-by-step instructions) to guide the LLM in determining a response to the student query. For instance, the system prompts may include a list of questions that the LLM may answer to guide the student in understanding a certain concept requested by the student query. As an example, the student query may be “what is circuit modelling?”, and the system prompts may include a list of questions, such as, “What are basic circuit components? What are the different types of circuits? What are the different types of circuit modelling techniques? What are some examples of circuit simulation software?” to guide the LLM in providing information that may explain circuit modelling to the student. Stated differently, the natural language-based TA agent is to convert a student query (which may be vague) into a sequence of directed prompts based on the student query and the learning objectives of the class. In some instances, the system prompts may further include an output configuration including a textual description of instructions, example question and response pairs, and/or an output format (e.g., certain syntax, sentence structure, programming code format, etc.) that the LLM may follow to provide a final answer to the student query.

Stated differently, the system prompts may include contextual information, a reference to the knowledge database, and/or a reference to the experience database based on the student query. The context information may include an indication of a certain subject or course (e.g., a math course, a programming course, an engineering science course, etc.) associated with the student query. In some examples, a school or university may offer multiple classes for the same course but may be taught by different instructors. Thus, the contextual information may also include an indication of a certain instructor associated with the student query. The context information may further include a list of specific instructions to guide an LLM in providing information relevant to the student query. The contextual information may further include a guardrail to limit an LLM output to be within the scope of the specific course. The contextual information may further include an output configuration (e.g., including an example question-response pair, or an output response form or structure) to guide an LLM in generating a final output or final answer for the student query. The reference to the knowledge database may be determined based on the contextual information (e.g., the class or course indication). For instance, the knowledge database may include multiple course-specific and/or instructor-specific knowledge databases and the reference may include an indication (e.g., a storage path or a link) to the corresponding course-specific and/or instructor-specific knowledge database. Similarly, the experience database may be based on the course indication and/or the instructor indication in the contextual information. For instance, the experience database may include multiple course-specific and/or instructor-specific experience databases and the reference may include an indication (e.g., a storage path or a link) to the corresponding course-specific and/or instructor-specific experience database. In an embodiment, the knowledge database and/or the experience database may be stored in a vector database format to provide efficient search.

Next, the natural language-based TA agent may determine a category or a classification of the student query. In some examples, the natural language-based TA agent may utilize a classifier, an ML model, or an LLM to perform the classification. In an example, student queries may be classified into a general question category, a knowledge question category, or a deep reasoning question category. The general question category may include queries that are not related to a specific course and do not require information from the knowledge database. The knowledge question category may include queries that are related to a specific course and require information (e.g., excerpts of course materials, such as documents, slides, audio and/or video recordings) from the knowledge database. The deep reasoning question category may include queries that require reasoning rather than simply course-specific knowledge and may or may not require information from the knowledge database depending on the student query. As an example, a query under the general question category may be “what is python programming language used for?”, a query under the knowledge question category may be “can you provide example guidelines for solving homework XXX in computing class YYY?”, and a query under the deep reasoning category may be “what is wrong with this python script?”.

Based on the classification or category associated with the student query, the natural language-based TA agent may select a particular LLM (e.g., a first LLM) from the multiple LLMs. The LLMs may include, for example, but are not limited to, one or more OpenAI® models (e.g., a GPT-3 model, a GPT-3.5 model, a GPT-4 model), one or more open-source LLMs, an LLM Meta AI (Llama) model, and a Google Gemini® model. The different LLMs may have different performances. For instance, the different LLMs may have different architectures (e.g., different transformers) and may be trained on different types of datasets and/or different amounts of data. The different LLMs may also have different associated costs (e.g., in terms of computational resources, memory resources, and/or subscription or service costs for using the respective LLMs). Generally, the higher the performance of the LLM, the higher the cost. In an example, a high-performance (or heavy-weight) LLM may be good at answering questions that require deep insights or deep reasoning, a mid-performance (or mid-weight) LLM may be sufficient for answering knowledge (e.g., course-specific) related questions, and a low-performance (or lightweight) LLM may be sufficient for answering general questions. Accordingly, selecting a particular LLM based on the category or classification of the student query can reduce processing and cost. Generally, there may be any suitable number of question categories (e.g., 2, 3, 4 or more), each mapped to a different one of the LLMs.

To further reduce the amount of processing and/or cost, the natural language-based TA agent may first check whether there is an available response to the student query stored or cached in the experience database. In some examples, the natural language-based TA agent may utilize a semantic search or an LLM (e.g., a lightweight LLM) to perform the check. If there is an available response cached in the experience database, the natural language-based TA agent may provide the student with the cached response instead of invoking a heavyweight or costly LLM to generate a response. If, however, there is no available response to the student query cached in the experience database, the natural language-based TA agent may then initiate the selected LLM (e.g., via an application programming interface (API) call) to generate, using the knowledge database, a response to the student query based on the system prompts and the user prompt (the student query).

In an embodiment, the natural language-based TA agent may utilize a retrieval-augment generation (RAG) process to retrieve relevant information from the knowledge database. Generally, RAG is a technique for enhancing the accuracy and reliability of a generative AI model with facts fetched from external sources (e.g., an authoritative knowledge base outside of the training data sources used for training the AI model). The natural language-based TA agent may further instruct the selected LLM to use the retrieved information for generating the response to the student query. As discussed above, the knowledge database may be stored in a vector database format. When utilizing RAG, the RAG process may identify multiple pieces of information (e.g., top 10 relevant information pieces, which may include document(s), presentation slide(s), audio and/or video recording(s)) from the knowledge database based on a similarity measure (e.g., a cosine similarity measure), and the selected LLM may generate the response to the student query using the identified information pieces. In an embodiment, the natural language-based TA agent may further apply a ranking process to narrow down the number of information pieces identified from the RAG process. For instance, the ranking process may identify a subset of the information pieces (e.g., the top 5 out of the 10 relevant information pieces) identified from the RAG process, and the selected LLM may use the subset of the information pieces to generate the response to the student query. In some examples, the natural language-based TA agent may utilize ML (e.g., a maximum marginal relevance (MMR) model) to perform the ranking.

In response to the initiation of the selected LLM, the natural language-based TA agent may receive returned data (e.g., a first response including textual data) from the selected LLM. The natural language-based TA agent may decode the returned data from the selected LLM. For instance, the decoding may include parsing the first response into a specific format. To ensure that the first response generated by the selected LLM (the decoded returned data) is accurate, the natural language-based TA agent may execute software tool(s) to confirm the accuracy of the first response from the selected LLM. The software tool(s) may be independent of (separate from) the selected LLM (that generated the first response). Based on the execution of the software tool(s), the natural language-based TA agent may determine whether the first response from the selected LLM satisfies one or more criteria. As an example, the student query may request for a python code example to delete a certain word from a document, and the selected LLM may generate a piece of python code to delete the certain word from a document. The software tool(s) may include a python code simulator/debugger that can execute the piece of python code (generated by the selected LLM). To test the LLM generated python code, the natural language-based TA agent may provide an input document including the certain word (to be deleted) as an input to the python code, execute the LLM generated python code in the python code simulator/debugger, and check that an output document generated from the execution of the LLM generated python code does not include the certain word. Stated differently, in such an example, the one or more criteria may include checking that the LLM generated python code can execute without errors and that the output of the python code is as expected.

If the natural language-based TA agent determines that the LLM generated response is inaccurate (e.g., failing to satisfy the one or more criteria), the natural language-based TA agent may repeat the process of initiating the selected LLM to generate a response to the student query based on the system prompts and user prompts and using the knowledge database (e.g., the relevant and/or narrowed down information pieces identified from the RAG process). In some instances, the natural language-based TA agent may also make observations based on the evaluation and provide additional feedback information to the selected LLM when repeating the initiation of the selected LLM.

If, however, the natural language-based TA agent determines that the LLM generated response is accurate (e.g., satisfying one or more criteria), the natural language-based TA agent may initiate a second LLM to generate a final answer or final response in natural language to the student query. In some examples, the second LLM may be the same as the selected LLM. In other examples, the second LLM may be different than the selected LLM. As part of the initiation, the natural language-based TA agent may provide the system prompts, the student query, and the most recent data received from the selected LLM (that is confirmed to be accurate) as an input to the second LLM. In an example, the second LLM may generate the final answer according to the output configuration included in the system prompts. Subsequently, the natural language-based TA agent may receive the final answer from the second LLM. Upon receiving the final answer, the natural language-based TA agent may provide the final answer to the student by transmitting the final answer to the student client application. In an embodiment, the natural language-based TA agent may store the student query and the final answer in the experience database.

To enhance student learning experience and student-teacher interactions, the natural language-based TA agent may allow the student and/or human instructor to provide feedback about the final answer provided by an LLM (e.g., the second LLM). In an embodiment, if the student is unsatisfied with the final answer provided by the LLM, the student may query the human instructor. For instance, the natural language-based TA agent may subsequently receive an indication that the final answer is unsatisfactory, where the indication may include the same student query but directing to the human instructor (e.g., the professor that teaches the specific course). Upon receiving the student query directing to the human instructor, the natural language-based TA agent may forward the student query to the instructor client application executing on the computing device of the human instructor. In response, the natural language-based TA agent may receive a modified (or corrected) answer from the human instructor via the instructor computing device.

Subsequently, the natural language-based TA agent may provide the modified answer to the student by transmitting the modified answer to the student client application. When the final answer based on the LLM generated response is unsatisfactory, the natural language-based TA agent may store the student query and the instructor modified or corrected answer to the experience database. Generally, the student and/or the human instructor can provide feedback to LLM generated responses, and the natural language-based TA agent may store student queries and corresponding answers, student feedback, and/or instructor feedback in the experience database.

In an embodiment, the natural language-based TA agent may periodically (e.g., hourly, daily, biweekly, or monthly) check to determine if any student query and corresponding answer are to be promoted from the experience database to the knowledge database. For instance, an answer provided by the human instructor and/or with an LLM generated answer with positive instructor feedback (approving or “liking” the LLM generated answer) may be considered as a golden or verified answer to be promoted. The natural language-based TA agent may store the promoted data (e.g., a student query and a corresponding answer) in the knowledge database. After promoting the data to the knowledge database, the natural language-based TA agent may remove the promoted data from the experience database. Accordingly, the knowledge database may continually be augmented and enriched. In an embodiment, the natural language-based TA agent may update (fine-tune) parameters of an LLM based on positive and/or negative feedback from the student, positive and/or negative feedback from the human instructor, and/or corrected responses from the human instructor. In some examples, the fine-tuning may apply different weights (or rewards) based on whether the feedback is from the student or the human instructor. For instance, human instructor feedback may be assigned with a higher weight than student feedback. Accordingly, the LLM(s) can be continually fine-tuned to improve the performance and/or accuracy of the LLM(s).

In an embodiment, the natural language-based TA agent may summarize student queries and correspond answers (generated by LLMs and/or from a human instructor) into a frequency question answer (FAQ) list and publish the FAQ list in a dashboard (e.g., a web server). For instance, the natural language-based TA agent may publish the student query and the final answer (or the modified answer when the final answer is unsatisfied) in the dashboard. The dashboard may be a public dashboard that can be accessed by all students in the class, and thus may further enhance student learning experience. In some instances, a student may check the dashboard for an answer to a question prior to sending the question to the ChaTA system. In an embodiment, the natural language-based TA agent may further generate and/or provide various information to assist the student in learning the course materials. For instance, the natural language-based TA agent may generate a student profile including progress tracking information (e.g., personalized study schedules and progress tracking, such as learning progress and data analytics). Additionally or alternatively, the natural language-based TA agent may provide study group coordination based on the students'learning profiles and data analytics (e.g., the students'quantitative learning data from quizzes and/or homework assignments and the students'qualitative learning data such as conversations with the natural language-based TA agent). For instance, the natural language-based TA agent may recommend a suitable study buddy for a student based on that student's learning profiles and data analytics. Additionally or alternatively, the natural language-based TA agent may provide note summarization and organization to assist students in their studies.

According to a further embodiment of the present disclosure, the ChaTA system may further include a teaching feedback generator including instructions stored in the memory of the ChaTA system and executable by the processor of the ChaTA system. As discussed above, the natural language-based TA agent may converse with students to provide responses to student queries using LLM(s) and the course materials in the knowledge database and/or request responses from a human instructor (e.g., when an LLM generated response is determined to be unsatisfactory by a student). The natural language-based TA agent may also store student queries in association with corresponding responses (LLM generated responses and/or human instructor generated responses) in the experience database. In an embodiment, the teaching feedback generator may utilize the student queries and corresponding responses (which may be referred to as student query-response data) collected in the experience database to generate a teaching feedback report for a specific human instructor (who provided the course materials and taught the students who generated those student queries). The teaching feedback report may include an indication of a student learning performance, for example, indicating student learning difficulties in certain learning concepts associated with the specific course. The learning concepts may correspond to learning objectives or goals defined for the specific course. The teaching feedback report may also include an indication of the effectiveness of the course materials (prepared by the specific human instructor) in teaching certain learning concepts associated with the specific course. The effectiveness of the course materials may be assessed based on whether there are issues with the course materials in teaching certain learning concepts (e.g., in terms of the content, language, and instruction styles) and/or whether there is any concept missing in the course materials. The teaching feedback may also include the extent to which each formative and summative assignment is related to the course learning outcomes and cumulative score of the student on each of the learning outcomes. This may also be provided to the student as feedback. Another aspect is the automatic generation of reports for accreditation organizations such as Accreditation Board for Engineering and Technology (ABET), or Association to Advance Collegiate Schools of Business (AACSB).

For example, to determine the student learning performance, the teaching feedback generator may retrieve the student queries from the experience database, classify each of the retrieved student queries into one or more of the learning concepts or learning goals (e.g., using a classifier, a ML model, or an LLM). The teaching feedback generator may determine a student learning difficulty in a first learning concept of learning concepts based on the number of student queries associated with the first learning concept being high (e.g., meeting or exceeding a certain threshold). In some instances, the teaching feedback generator may also determine the top X (e.g., 1, 2, 3 or more) number of learning concepts with which the student struggled most (e.g., by identifying those learning concepts that are associated with the highest number of student queries among all the learning concepts). Stated differently, the teaching feedback generator may generate a list of FAQs from the retrieved student queries, and the learning concepts covered by the FAQs may indicate learning concepts that the students may have difficulties in learning.

The teaching feedback generator may also identify, for each of the retrieved responses that are generated by the LLM(s), a corresponding portion of the course materials from the knowledge database that was referenced or included by the respective response generated by the LLM(s). The teaching feedback generator may analyze the identified portions of the course materials to determine the effectiveness of the course materials. For instance, the teaching feedback generator may classify each of the identified portions of the course materials into one or more of the learning concepts (e.g., using a classifier, a ML model, or an LLM). The teaching feedback generator may determine an issue associated with a certain learning concept in the course materials based on a number of the identified portions of the course materials associated with the certain concept being high (e.g., meeting or exceeding a certain threshold). The issue may be associated with the content, the language, and/or the instructional style. The teaching feedback generator may further analyze the content, the language, and/or the instructional style in the identified portions of course materials (e.g., using ML or LLMs) to determine the reasons for having a large number of student queries directed to those portions of course materials. As an example, the teaching feedback generator may flag an issue based on the inconsistent use of certain diagrams (e.g., free body diagrams) across the course materials. As another example, the teaching feedback generator may flag an issue based on the course materials providing different explanations for similar topics (e.g., forces or moments). As yet another example, the teaching feedback generator may flag an issue based on a textual or verbal description in the course materials needs some supplementary picture for better clarity. To analyze the course materials and flag these issues, the teaching feedback generator may compare the texts in these differing portions of the course materials. The teaching feedback generator may also flag these issues based on the number of queries related to the particular concept (e.g., greater than a certain threshold), the amount of time the students lingered on the videos associated with these particular portions (e.g., longer than a certain duration), or the percentage of students giving wrong answers to conceptual quizzes generated based on the course materials (e.g., greater than a certain percentage threshold). As a further example, the teaching feedback generator may flag that there was not enough discussion of torques when discussing free body diagrams (e.g., related texts or paragraphs is below a certain threshold), causing the natural language-based TA agent to be unable to answer a particular question and has to elevate the question to the TA or the instructor.

The teaching feedback generator may also determine issues in the course materials and/or learning concepts that are covered by the course materials based on the retrieved responses that are generated by the human instructor. For instance, the teaching feedback generator may compare each human instructor generated response to information provided in the course materials (e.g., using semantic searches, ML, and/or LLMs) to determine whether there is a discrepancy in the course materials. The discrepancy may be the course materials provide different or contradicting information compared to the respective human instructor generated response. Alternatively, the discrepancy may be the course materials do not cover certain knowledge information provided by the respective human instructor generated response.

In some scenarios, multiple classes for the same course may be taught by different professors or instructors. Thus, the knowledge database may include different course materials prepared by different instructors for the same course, and the experience database may include student query-response data associated with the different course materials and different instructors. Accordingly, in an embodiment, the teaching feedback generator may generate a teaching feedback report to provide an assessment across the different instructors (or more specifically, across the different course materials) based on the student query-response data retrieved from the experience database. The teaching feedback report may include an indication of an effectiveness comparison or ranking among the different course materials in teaching certain concepts. To that end, the teaching feedback generator may link each of the LLM generated responses in the student query-response data to a corresponding course material prepared by the respective instructor (e.g., using ML and/or LLMs). Stated differently, the teaching feedback generator may determine an association between each of the LLM generated responses and a respective one of the different course materials. The teaching feedback generator may compare the effectiveness of the different course materials (provided by the different instructors) in teaching a certain concept based on the determined association.

For instance, the teaching feedback generator may compare a number of the LLM generated responses that are associated with a portion of a first course material (prepared by a first instructor) for teaching a particular concept to a number of the LLM generated responses that are associated with a portion of a second course material (prepared by a second instructor) for teaching the same particular concept. The teaching feedback generator may determine that the course material associated with the smaller number of LLM generated responses may be more effective in teaching the certain concept as less student queries related to that course material are received. As an example, the teaching feedback generator may determine that the first instructor may be more effective based on fewer students asked questions related to the first course material or that the students give a higher rating to the answers provided by the first instructor. As part of comparing the effectiveness of the different course materials, the teaching feedback generator may further determine a difference in instructional styles (e.g., via textual, visual diagrams, problem-solving examples, etc.) between the portion of the first course material associated with the particular concept and the portion of the second course material associated with the particular concept. The teaching feedback generator may further determine a difference in content (e.g., the actual learning information) between the portion of the first course material associated with the particular concept and the portion of the second course material associated with the particular concept. In some instances, for each course, there may be corresponding exercises, quizzes, and information collected by the natural language-based TA agent. As such, the teaching feedback generator can collect comprehensive students'data by topics or concepts. Thus, the teaching feedback generator may have statistics of students'overall performance by topics. For instance, if the performance of students being taught using a certain course material is higher than another course material, the certain course material is more effective. Additionally, students'engagements may be another indicator (e.g., based on the number of queries and feedback collected by the natural language-based TA agent). Generally, the teaching feedback generator may use a variety of metrics to determine the effectiveness of course materials. The metrics may include, for example, but are not limited to, students'average performance (e.g., quiz scores) by different course materials, students'engagements analytics, student conversational information (e.g., the number of questions related to the same topic or concept), and student feedback (or satisfaction indications).

In some higher-level education scenarios, the same course (e.g., mathematics) may be taught in different classes offered by different faculties (e.g., an engineering faculty and a general science faculty). For instance, the first course material may be associated with a first faculty, and the second course material may be associated with a second faculty different than the first faculty. Thus, the teaching feedback generator may also provide an assessment of student learning performance and/or teaching performance for the same course across faculties. In some instances, a professor may rework how they teach a concept based on the feedback. In some instances, a professor may adopt the teaching style on a particular concept as another professor (who provided the more effective course materials). In some instances, the knowledge base may be updated or fine-tuned on a particular concept, for example, by modifying the course materials of a professor based on the course materials of the other professor who achieved the better teaching performance. As an example, in teaching the concept of gradient of a function, the teaching feedback generator may compare two different explanations or examples by two instructors (e.g., a first instructor and a second instructor) and suggest alternative approaches to the second instructor based on the first instructor's explanation. This in turn can help the second instructor to use the explanation of the first instructor in their class. As student feedback (and formative assessments) accumulates as discussed above, the teaching feedback instructor may point to one explanation example being more effective based on a comparison of the number of student queries and/or the assessment scores of the students. Generally, the teaching feedback generator may utilize the metrics discussed above to determine the effectiveness of course materials across faculties.

An effective learning process may include several interconnected components, such as teaching, teaching feedback, student feedback, and student assessment (e.g., including formative assessments and summative assessments), to ensure knowledge is delivered, understood, applied, and improved over time. Assessment may operate as feedback to inform both instructors and students about the progress and/or extent to which learning objectives have been achieved. Assessment may include exam generation (or more generally, scenario generation for students to respond to homework, quizzes, etc.) and exam grading. Traditionally, instructors (e.g., professors and/or TAs) may manually generate exam questions and manually grade students on those exam questions. Manual exam generation can be time consuming and often leads to a one size fits all approach. Manual exam grading can be time intensive especially when the questions are conceptual questions that require written answers beyond a multiple-choice answer or a right or wrong numerical answer. In some cases, exams for a class of students (e.g., especially for a large class) may be graded by different instructors and/or across different times, maintaining accuracy and consistency can be challenging. Thus, it may be difficult for manual exam grading to maintain fairness in assessing answers across students.

Furthermore, as different students may have different learning styles and may make progress at different paces, it may be desirable to provide personalized assessments in addition to delivering personalized teaching material (e.g., via the natural language-based TA agent) discussed above. The manual process of generating exam questions and exam grading may not be easily scaled and/or adapted to provide personalized assessment, which may be an important component for effective learning. While LLMs may be good for a wide range of applications involving understanding, generating, and processing human language, LLMs may not simply be applied to generate effective exam questions and/or grading exams, for example, due to the lack of a deep understanding of certain knowledge domains. LLM may also lack the judgement needed for creating questions that are fair and effective in assessing specific learning objectives and/or student performances without introducing unintended biases.

Accordingly, in further embodiments of the present disclosure, the ChaTA system may further include an exam generator (e.g., software executing on the ChaTA system) and an exam grader (e.g., software executing on the ChaTA system) to respectively address the aforementioned manual exam generation and manual exam grading problems. While named exam generator and exam grader, these components may generate and grade other things besides exams (e.g., projects, reports, scenarios, scenario responses, labs, lab reports, etc.). The exam generator may use the course material provided by the professor and stored in the knowledge database, the student conversational data (e.g., student query-response data) between students and the natural language-based TA agent stored in the experience database, and/or student scores on previous exam questions to generate questions for student assessment, aligned with learning objectives and student proficiency. In one embodiment, the assessment can be a class level assessment (e.g., quizzes, midterm exams, final exams, assignments, projects, reports, etc.) based on specific course material and an instructor-defined framework. In another embodiment, the assessment can be a personalized student assessment (e.g., exercises, quizzes, etc.) adaptively responding to individual progress based on specific course material, student-specific query-response data associated with the specific course material, and student-specific score data associated with the specific course material. For instance, the specific course material may include a list of topics, chapters, or modules, each student-specific query-response may be related to a corresponding one of the topics, chapters, or modules, and each student-specific score for a corresponding question may be related to a corresponding one of the topics, chapters, or modules. Thus, the specific course material, the student-specific query-response data, and student-specific score data are related to or linked to each other topic-by-topic, chapter-by-chapter, or module-by-module, etc.

The exam generator may also generate reference answers (e.g., based on the knowledge database or the list of knowledge that the student should be able to demonstrate) corresponding to generated questions. The exam grader may grade exam questions based on corresponding answers and associated rubrics (e.g., a scoring guide with a set of criteria and performance levels or score points). The exam questions and the corresponding answers can be provided by a professor or a TA or automatically generated by the exam generator. The rubrics may be provided by the professor or the TA or automatically generated by the exam grader.

Further, each of the exam generator and the exam grader may have an associated user interface (UI) to interface with professors. A professor or a TA may also edit questions generated by the exam generator and/or rubrics generated by the exam grader to ensure the accuracy of the questions and corresponding answers generated by the exam generator and rubrics and/or scores generated by the exam grader. Generally, the exam grader may interact with the exam generator, the knowledge database, and the experience database to provide a full view of student learning progress in a systematic and consistent manner. The exam generation and/or the exam grading may be driven by AI (e.g., generative AI (GAI) using LLMs). In some instances, an exam generator platform may refer to the exam generator executing on the ChaTA system, and an exam grading platform may refer to the exam grader executing on the ChaTA system.

In an embodiment, the exam generator may be used for generating personalized assessments or exams for individual students according to each respective individual student's learning level (e.g., for self-learning). For instance, the exam generator may receive course material for a particular course from the knowledge database. The course material may be provided (e.g., uploaded to the ChaTA system) by a professor of the particular course. The exam generator may also receive student query-response data (e.g., conversational data) between an individual student and the interactive natural language-based TA agent. The student query-response data may include student queries associated with the particular course and corresponding responses from the natural language-based TA agent and/or a human instructor (e.g., a professor or a teaching assistant). The student query-response data may be received from the experience database. As discussed above, the ChaTA system may collect and store all student queries and corresponding responses from the natural language-based TA agent and/or human instructor(s) in the experience database. The experience database can further store the student query-response data in association with identification information of corresponding students who initiated the query or asked the questions. For instance, the identification information may include the student name, the student identification number, and/or the student login identifier. As further discussed above, certain student queries and corresponding responses (e.g., “golden response” or “verified response”) from a professor or a teaching assistant can be promoted from the experience database to the knowledge database. As such in some instances, the course materials in the knowledge database may also include those golden or verified queries-responses in addition to lecture notes, presentations, questions and answers, audio recordings of lectures, and/or video recordings of lectures provided by the professors. In some instances, the exam generator may receive the course material and/or the student query-response data in the form of a reference or a link to the storage of the course material.

The exam generator may further receive student scores of the individual student associated with assessment corresponding to the particular course (e.g., from a score database). The assessments associated with the student scores of the individual student may comprise at least one of a quiz, a midterm exam, a final exam, an assignment, or a project associated with the course material. For instance, the course material may include quizzes at the end of certain chapters, sections, sub-sections, and the individual student may have previously taken those quizzes and obtained corresponding scores (e.g., graded by the exam grader). In some instances, the individual student may have also taken quizzes, and/or midterm exams for that course and may have obtained corresponding scores (e.g., graded by the exam grader). In some instances, the individual student may have worked on certain assignments and/or projects and may have obtained corresponding scores (e.g., graded by the exam grader).

The student query-response data may be indicative of certain topics, concepts, or portions (e.g., chapters, sub-chapters, sections, modules, sub-modules, etc.) of the particular course that the individual student may have difficulty in learning. Similarly, the student scores may be indicative of the understanding and performance of the individual student on certain topics, concepts, or portions of the particular course. Thus, the exam generator may identify at least one particular knowledge concept in the course material associated with a learning difficulty (e.g., a learning gap) of the individual student based on the course material, the student query-response data (of the individual student), and the student scores (of the individual student). Stated differently, the student qualitative data (e.g., the student query-response data) and the student quantitative data (e.g., the student scores) associated with the individual student can provide insight into areas where the individual student may be struggling.

Next, the exam generator may generate one or more prompts including the course material and the at least one knowledge concept. The generation of the one or more prompts may be responsive to a request from a user device of the individual student (e.g., initiated by the individual student for reviews and/or self-learning). In some instances, the generation of the one or more prompts may be responsive to a request from a user device of a professor and/or a TA, for example, to assign a specific assessment task to the individual student. In some instances, the one or more prompts can also include a question format. For example, the question format can be multiple-choice, true or false, free response (e.g., essay or writing assessment), word problem-solving, numerical problem-solving, coding, scenario-based (e.g., adaptive to a student learning level), etc.

In some instances, the question format may be received as part of the request from the individual student, the professor, and/or the TA. In other instances, the question format can be generated automatically by the exam generator based on the knowledge domain (e.g., science, humanity, engineering, medical, law, etc.) of the course material and/or the identified knowledge concept. As an example, if the course material is related to computer science, the exam generator may determine that coding questions are to be generated. As another example, if the course material is related to mathematics or physics, the exam generator may determine that numerical problem-solving questions are to be generated. As another example, if the course material is related to humanity, the exam generator may determine that essay questions are to be generated.

Next, the exam generator may initiate one or more LLMs to generate questions for the individual student based on the one or more prompts. The exam generator may receive the questions from the one or more LLMs. If the one or more prompts include the question format, the questions may be in the format specified by the one or more prompts. Generally, the questions may be multiple-choice questions, true or false questions, short answer questions, essay questions, word problem-solving questions, numerical problem-solving questions, coding questions, etc. The exam generator may then output the questions to the user device of the individual student.

In some instances, as part of generating the questions, the one or more LLMs may also generate answers corresponding to the questions. In one example, the exam generator may output the corresponding answers to the exam grader. In this way, after the individual student has answered the questions, the exam grader may grade the answers provided by the individual student. In some examples, the exam generator may output the corresponding answers to the user device of the individual student for review (e.g., after the individual student has completed answering the questions). Using the exam grader in conjunction with the exam generator can provide dynamic real-time feedback to the student. Further, the exam generator can sequence questions based on the student's score (e.g., output by the exam grader) and adapt as the student progresses.

In some cases, exam questions may be generated based on the learning level or the proficiency of the individual student (e.g., using gamification mechanisms). For instance, a professor may generate a set of criteria to gate the learning progress or pace of a student. The set of criteria may specify a list of learning levels (e.g., related to certain topics or a certain depth of a particular topic) and a corresponding expected performance (e.g., in terms of scores, such as above 100% accuracy) for each learning level before the student can advance to the next learning level. In some instances, the learning levels may be beginner, intermediate, or advanced. In some instances, the learning levels may be level 1, level 2, level 3, level 4, etc. Generally, the learning levels may be in any suitable granularities. Accordingly, in some instances, the exam generator may further determine whether one or more of the student scores of the individual student satisfies the expected student performance for a first learning level. If the one or more of the student scores of the individual student satisfies the expected student performance for the first learning level, the one or more prompts may further include an indication of a second learning level more advanced than the first learning level. Otherwise, the one or more prompts may include an indication of the first learning level. By including information about the student's learning level in the one or more prompts, the exam generator can deliver personalized and targeted assessments corresponding to the individual student's skills.

The one or more LLMs may include a multimodal LLM such as OpenAI® GPT-4, GPT-5 or higher versions, Google® Gemini, OpenAI, Claude, or any open-source LLMs such as LLaMA 3, Mistral, etc. In some instances, the exam generator can select a particular LLM from multiple different LLMs based on the knowledge domain of the course material and/or the question format. In some instances, the exam generator may use the one or more LLMs in conjunction with RAG-based techniques, RLHF-based techniques, and/or supervised fine tuning (SFT) techniques to generate the questions. In some instances, the identifying of the knowledge concept associated with the learning difficulty of the individual student based on the student conversational data and the student scores of the individual student and the course material can also be based on LLM processing. In some instances, the same LLM(s) may be used for identifying the knowledge concept associated with the individual student's learning difficulty and generating the questions. In other instances, different LLMs may be used for identifying the knowledge concept associated with the individual student's learning difficulty and generating the questions. In some embodiments, the exam generator may initiate multiple different LLMs to generate questions based on the course material, student-query response data, and/or student score and the exam generator may select the questions generated by the LLM with the highest confidence score among the multiple LLMs. The different LLMs may have different architectures or may be trained differently (e.g., using different input and/or reference data). In some instances, the different LLMs may include a small language model (e.g., with fewer model parameters than a typical LLM) trained on local server(s) based on a single course material and may be executed on local server(s).

In an embodiment, the ChaTA system may further include a recommendation engine (e.g., software executing on the ChaTA system) to recommend learning material for students. For example, the exam generator may initiate, based on the identified learning difficulty of the individual student, the recommendation engine to identify recommended learning material from the course material in the knowledgebase for the individual student. In an example, the recommendation engine may be a machine learning (ML) model (e.g., a decision tree branching-based models, extreme gradient boosting (XGBoost) model, a neural network, etc.). The exam generator may receive the recommended learning material from the recommendation engine. The recommended learning material may be in the form of text, audio, and/or video extracted from the course material in the knowledge database. The exam generator may output the recommended learning material to the user device of the individual student. In some instances, the recommendation engine may generate the recommended learning material further based on a learning pattern or preference of the individual student. For instance, if the individual student frequently selects video format learning materials over text or audio format learning materials from the course material, the recommendation engine may recommend learning materials that are in video format to the individual student. By providing adaptive content delivery according to the individual student's learning pattern or preference, the individual student may learn more effectively (e.g., saving time and making faster progress).

In an embodiment, the exam generator may be used for generating course-specific assessments or exams for a class of students based on a professor or instructor-defined scope or framework, for example, for monitoring student progress during the course or for evaluating the students at the end of the course. For monitoring student progress during the course (e.g., formative assessment), a professor or a teaching assistant may use the exam generator to generate quizzes at the end of certain topics, certain chapters, certain sub-chapters or sections, weekly tests, weekly assignments, minor projects, etc. For evaluating the students at the end of the course (e.g., summative assessment), a professor or a teaching assistant may use the exam generator to generate midterm exams, final exams, major projects, etc. Generally, the exam generator may be used for generating exam questions for individual learning or for class level assessment.

For example, the exam generator may receive one or more learning concepts (e.g., core learning concepts) and an assessment goal (or learning goals) for a particular course from a professor. For example, the assessment goal may indicate whether questions are to be generated for formative assessment or summative assessment. Stated differently, the assessment goal may indicate whether questions are to be generated for quizzes, assignments, projects, reports, midterm exams, final exams, etc. The exam generator platform may generate one or more prompts comprising course material for the particular course from the knowledge database, the one or more learning concepts and the assessment goal for the particular course. In some instances, the generation of the one or more prompts may be responsive to a request from a professor and/or a request from a TA. In some instances, the one or more prompts may also include a question format (e.g., multiple-choice, true or false, free response, word problem-solving, numerical problem-solving, coding, scenario-based, etc.). The question format can be received from the professor or automatically determined by the exam generator based on the knowledge domain of the particular course or the learning concepts as discussed above. In some instances, the one or more prompts may also include information about the one or more students who will be receiving and answering the questions. This information may include information about the student's learning level such as beginner, intermediate, or advanced.

In an embodiment, the one or more prompts may further include an indication to prioritize a first portion of the course material associated with the one or more learning concepts over a second portion of the course material associated with the one or more learning concepts for generating the questions. The prioritizing is based on an indicator associated with the first portion of the course material. In an example, the indicator may be a tag generated by the professor and/or the TA. In another example, the indicator may be a highlight indicator, where the first portion of the course material is highlighted. In yet another example, the indicator may indicate that the first portion includes the professor's response to a student's query (e.g., that was stored in the experience database and promoted to the knowledge database as part of the course material as discussed above).

The exam generator may then initiate one or more LLMs to generate questions for the one or more students based on the one or more prompts. The exam generator may receive the questions from the one or more LLMs. In some instances, the exam generator may transmit the questions to one or more user devices associated with the one or more students. In some instances, the questions may be transmitted to the one or more students responsive to a publish request from the professor. For instance, the exam generator may output the questions to the user device of the instructor, and the instructor may review and/or edit the questions to ensure the accuracy of the generated questions in terms of the content and/or the style. That is, the instructor may determine whether each question is ready for publishing or releasing to the one or more students. If so, the instructor may request the exam generator to publish the questions.

In some embodiments, the exam generator may receive feedback from professors and/or TAs. The feedback may be related to the style or phrasing of the generated questions and/or the content of the generated questions. This feedback may be provided to the one or more LLMs for training the one or more LLMs and generating future questions. In an example, the exam generator may output a generated question and a corresponding answer via a user interface (UI), and the professors and/or the TAs may provide the feedback by editing the generated question and/or the answer. In some embodiments, the exam generator may also receive feedback from and interact with students regarding the generated questions. For instance, a student may provide an answer to a question generated by the exam generator, receive a grade or a score for the answer (e.g., from the exam grader), and may be unsatisfied with the score. Thus, the student may submit a complaint to the ChaTA system. The student complaint may be evaluated, e.g., by the professors and/or the TAs. If the student complaint is unreasonable, no action will be taken. If, however, the student complaint is reasonable (e.g., due to the content and/or style of the question), the student complaint may be provided as student feedback to the exam generator for training the one or more LLMs.

In an embodiment, the LLM may be trained by providing the course material as input to the LLM and reference exam questions generated by the professor based on the corresponding course material as the ground truth. As part of the training, the LLM parameters (e.g., weights) may be updated based on an error measure between the output of the LLM (e.g., the LLM generated questions) and the reference exam questions. In some instances, the error measure may be based on a multi-dimensional evaluation of an LLM generated question. The multi-dimensional evaluation may include evaluating the quality (e.g., the effectiveness in eliciting an insightful or relevant answer), the alignment to the learning concepts and/or assessment goal (provided in the prompts), and interpretability of the generated question. In some instances, a gradient descent algorithm may be used to update the LLM parameters to minimize the error. The training may go through multiple iterations of parameter adjustment and error measures until the error between the LLM output and the reference exam questions satisfies a certain threshold. In some instances, the LLM may also be trained for generating answers for corresponding questions in a substantially similar way. Similar to training the LLM for question generation, the LLM may receive the course material as input. However, the ground truth or reference for calculating the LLM output error may include reference question-answer pairs provided by the professor. Generally, the LLMs used for question and/or answer generation and/or the ML model used for recommending learning material may be trained using similar mechanisms discussed above and may be combined with RLHF techniques (e.g., training a reward model to score different outputs of an LLM based on human rankings and optimizing the LLM to maximize its score from the reward model).

In an embodiment, the ChaTA system may further include an exam library comprising exam questions generated by the exam generator and verified by a professor and/or a teaching assistant. The exam library may be generated and updated dynamically in real-time. For instance, after the exam generator generated questions for a particular course as discussed above, the exam generator may provide the generated questions to the professor and/or the teaching assistant (e.g., via a UI). The professor and/or teaching assistant may accept or reject each question. If the professor and/or the TA accepts the question, the question may be added to the exam library. In some instances, the professor and/or teaching assistant may edit the question before accepting the question. If, however, the professor and/or the TA rejects the question, the question may not be added to the exam library. The professor and/or teaching assistant may request the exam generator to remove the rejected question or to re-generate the question. In some instances, the exam generator may receive feedback indicating an issue with the style or content of a question in the exam library. In response to the feedback, the exam generator may remove that question from the exam library. The continual update of the exam library can result in a repository of “golden” or verified/approved questions for the particular course.

In some instances, upon the exam generator receiving a request to generate questions for a particular course (for a particular learning concept and/or a learning goal), the exam generator may check whether the exam library already includes questions for the request. To reduce processing overhead and resource usage, the exam generator may generate only questions that are not already included in the exam library. Stated differently, the exam generator may generate questions for the particular course (or the particular learning concept and/or learning goal) based on an absence of the questions associated with the particular learning concept and/or learning goal for the particular course. Generally, upon the exam generator receiving a request to generate questions for a particular course (for a particular learning concept and/or a learning goal), the exam generator may generate some questions and/or reuse some questions from the exam library.

The exam grader disclosed herein may use multiple independent LLMs to provide accurate, consistent, and fair evaluation of student assessments with dynamic rubric generation and modification capabilities while also handling diverse assessment formats (e.g., handwritten submissions, structured exams, unstructured reports, etc.). The exam grader may grade various types of assessments including quizzes, midterm exams, final exams, assignments, projects, and lab reports and/or scenario-based assessments (including gamification and dialogue-based efforts).

As discussed above, the computer system may send one or more questions to a user device associated with a student, and the one or more questions may be associated with a particular course. The exam grader may receive, from the user device of the student, a data object comprising one or more answers (e.g., text answers, etc.) with each answer corresponding to one of the one or more questions. In embodiments where student answers are handwritten, the exam grader applies optical character recognition (OCR) processing to the data object to obtain the one or more text answers. This OCR capability converts handwritten information into machine-readable text before processing by the LLMs, eliminating the manual document preparation burden experienced with conventional systems.

The exam grader may generate one or more prompts comprising the one or more questions and the corresponding one or more answers as well as predefined scoring points. The one or more prompts provide the contextual framework for the plurality of LLMs to perform evaluation in accordance with grading criteria. In an embodiment, the exam grader initiates a plurality of LLMs to independently evaluate the one or more answers based on the predefined scoring points. The predefined scoring points may be in the form of a rubric, which will be discussed in more detail below. The plurality of LLMs may comprise different LLM models including a multimodal LLM such as OpenAI® GPT-4, GPT-5 or higher versions, Google® Gemini, OpenAI, Claude, or any open-source LLMs such as LLaMA 3, Mistral, etc. The plurality of LLMs may comprise different model architectures, or the plurality of LLMs may be tuned based on different input data, different reference data, or different error evaluation metrics. This diversity in LLM architecture and training enables the system to leverage different strengths of different LLMs.

Different LLMs often excel at different tasks. For example, certain LLMs such as ChatGPT may perform well for general evaluations, while Claude and similar models may perform better for coding exams. The system may select particular LLMs based on the particular subject matter of the course. For instance, for computer science courses identified as programming-heavy classes based on course catalog descriptions, the system may select LLMs particularly suited for evaluating code.

In an embodiment, the exam grader receives a plurality of evaluation outputs for an individual question from the plurality of LLMs. The exam grader may also receive a plurality of confidence scores associated with respective ones of the plurality of evaluation outputs for the individual questions. The confidence scores indicate how certain each LLM was about the grade it assigned. The confidence score may be used by the exam grader to select one of the plurality of evaluations. The confidence score may allow an instructor of the course to identify evaluations that require closer review.

The exam grader may select a particular evaluation output of the plurality of evaluation outputs from an LLM of the plurality of the LLMs for the individual question based on one or more criteria. The one or more criteria used for selecting the particular evaluation output from among the plurality of evaluation outputs for the individual question may comprise the confidence scores. In embodiments, the evaluation outputs from multiple LLMs are provided to another LLM to consolidate the results and determine which evaluation should be selected. The exam grader may output the particular evaluation output selected to the user device of the student. In an embodiment, the particular evaluation output is not provided to the user device of the student until it has been reviewed and approved by the instructor, maintaining instructor oversight and grading responsibility.

Alternatively or concurrently, different LLMs may be tasked with evaluating different aspects of the student answer and may play either the role of advocate or critic of the student answer with other LLMs being tasked with being the judge or the jury. Some of the LLMs (tasked with assessing knowledge for example) may be locally run open source specially trained small language models and only the judgement may be based on a LLM with API calls, which can help promote computation and network efficiency. The one or more criteria used to select one of the plurality of evaluation outputs may be based on what aspect each LLM was evaluating and the role of the particular LLM (e.g., advocate, critic, or judge).

In an embodiment, the exam grader generates contextual comments associated with evaluation outputs. For example, the exam grader may generate a comment associated with the particular evaluation output based on at least one of course material associated with the individual question, the individual question, or a corresponding one of the one or more answers. The comments may be automatically generated by the one or more LLMs. The comments may comprise specific feedback tied to particular portions or sections of the student's work. The comments may be contextual to the individual student's specific mistakes, explaining what the student did wrong and how many points were lost. This contextual commenting performed by the exam grader helps enable students to understand their errors and improve.

The exam grader may receive one or more reference answers, each corresponding to a question of the one or more questions. The reference answers may be received from the exam generator or an instructor of the class. In an embodiment, the exam grader generates predefined scoring points based on the reference answers. The generation of the predefined scoring points may be based on analysis by one or more of LLMs. For example, the exam grader may analyze the individual question and a corresponding reference answer to determine one or more evaluation criteria for evaluating the individual question. The exam grader may then assign a scoring point for each of the one or more evaluation criteria. In an embodiment, this automated rubric generation capability is based on chain of thought reasoning performed by the one or more LLMs. An instructor may specify a type of evaluation being performed. The one or more LLMs may perform chain of thought reasoning based on this categorization, generating the chain of thought and a tentative answer. The chain of thought may then be converted into a rubric by the one or more LLMs, reflecting how students should learn to think through problems. The one or more LLMs may assign points to each rubric element or evaluation objective based on the difficulty of that particular aspect of the chain of thought. The exam grader may receive and display the generated rubric to an instructor. The instructor, via an exam grader user interface, may then modify, correct, and/or approve the rubric.

In some embodiments, a plurality of LLMs may be used to generate a plurality of rubrics for each question for consideration and selection similar to the use of multiple LLMs to generate a plurality of evaluation outputs per question. The exam grader may also receive a plurality of confidence scores associated with respective ones of the plurality of rubrics. The confidence scores indicate how certain each LLM was about the rubric generated. The confidence score may be used by the exam grader to select one of the plurality of rubrics. The confidence score may allow an instructor of the course to identify rubrics that require closer review.

Alternatively or concurrently, different LLMs may be tasked with evaluating different aspects of the rubric and may play either the role of advocate or critic of the rubric with other LLMs being tasked with being the judge or the jury. Some of the LLMs (tasked with assessing knowledge for example) may be locally run open source specially trained small language models and only the judgement may be based on a LLM with API calls, which can help promote computation and network efficiency. The one or more criteria used to select one of the plurality of rubrics may be based on what aspect each LLM was evaluating and the role of the particular LLM (e.g., advocate, critic, or judge).

The exam grader may generate different kinds of rubrics depending upon the assessment type (e.g., homework assignments, projects, exams, etc.), the type of evaluation (e.g., formative or summative), and/or what is being evaluated (e.g., factual knowledge, procedural items, conceptual items, or comprehensive diagnostic ability). The exam grader may enable configurable weighting between process evaluation and outcome evaluation. For example, a rubric may place a heavier weighting on a final answer as opposed to the process steps, or conversely, emphasize the processing steps over the final answer based on instructor preference for a given evaluation.

The exam grader enables dynamic rubric updates and batch re-evaluation. In an embodiment, the exam grader receives a question associated with a particular course, a rubric including one or more evaluation objectives and corresponding scoring points for the question, and a plurality of student answers. As discussed above, the rubric may be automatically generated by the exam grader based on the question and a corresponding reference answer. The exam grader may initiate one or more LLMs to evaluate each of the plurality of student answers based on the rubric and receive, from the one or more LLMs, a plurality of first evaluation outputs for the plurality of student answers. The exam grader may then transmit, to the user device of the instructor, the plurality of student answers and corresponding ones of the plurality of first evaluation outputs for instructor review. If the instructor, for example via the exam grader UI, approves the first evaluation outputs, the exam grader may then publish the plurality of first evaluation outputs for the plurality of students. The exam grader may maintain the first evaluation outputs in association with the corresponding student answers in a score database, preserving the computational state and enabling subsequent reprocessing. The score database may maintain associations between student identification information, questions, answers, rubrics, and/or evaluation outputs. This persistent state enables efficient retrieval and reprocessing operations without data loss or degradation.

In an embodiment, the exam grader subsequently receives, from the user device of the instructor, a modification to the rubric. For instance, the instructor may discover during review that something is wrong with the rubric based on patterns observed across multiple student evaluations. The modification to the rubric received from the instructor may comprise: (1) a modification to at least one of the evaluation objectives or one of the scoring points, (2) a deletion of at least one of the evaluation objectives or a corresponding one of the scoring points, or (3) an addition of one or more additional evaluation objectives or additional scoring points.

Upon receiving the rubric modification, the exam grader may automatically initiate a batch re-evaluation process. For example, the exam grader may initiate the one or more LLMs to re-evaluate each of the plurality of student answers based on the modified rubric. This re-evaluation leverages the system's maintained data structures and processing pipelines to efficiently reprocess the entire batch of student submissions without re-input or re-formatting of data, thereby promoting computational efficiency.

The exam grader may receive, from the one or more LLMs, a plurality of second evaluation outputs for the plurality of student answers based on the modified rubric. The exam grader may then transmit, to the user device of the instructor, the plurality of student answers and corresponding ones of the plurality of second evaluation outputs for instructor review. If the instructor, for example via the exam grader UI, approves the second evaluation outputs, the exam grader may then publish the plurality of second evaluation outputs for the plurality of students. The instructor verification helps ensure that grading responsibility remains with the faculty while the grading activity is performed by the exam grader.

The exam grader helps establish a uniform rubric that is systematically applied. For example, each time the exam grader confirms that a rubric criterion is satisfied, it awards the specified points (e.g., 2 points, etc.). Each student for a course is evaluated by the exam grader against identical criteria with identical point allocations. This uniformity extends across different professors teaching the same course. The systematic and rule-based nature of the exam grader assessment ensures that even when different professors use the system, consistent grading standards can be maintained.

In some embodiments, the exam grader evaluates unstructured documents such as lab reports or project reports. Unlike conventional systems that force students to submit reports in fixed formats with predefined section locations, the disclosed exam grader handles flexible, unstructured document formats. The exam grader may receive, from a user device associated with a student, a report for a particular assignment associated with a particular course. The exam grader may generate one or more prompts comprising the report, a rubric comprising evaluation objectives and corresponding scoring points for the particular assignment, and a reference report. The reference report may comprise an example of a good report rather than a rigid template. The rubric may indicate how closely the student report must match the structure of the reference report versus the content of the report.

The exam grader may initiate one or more LLMs to evaluate the report based on the rubric and the reference report. In some embodiments, the exam grader initiates a plurality of LLMs to evaluate the report based on the rubric and the reference report and selects one of a plurality of evaluation outputs. The exam grader, via the one or more LLMs, may interpret the report structure and match content to rubric requirements, eliminating the need for manual section identification required with traditional grading systems. The exam grader may receive, from the one or more LLMs, an evaluation output for the report. One of more of these evaluation outputs for the report may be in the form of advocacy or critique of particular aspects of the report (evaluating for example, just the logic, or just the specificity of the description or just the computations) with other reports focused on overall judgement of quality. The evaluation output may comprise: (1) a plurality of scoring points, each for a corresponding one of the evaluation objectives and based on a corresponding one of the scoring points, and/or (2) a copy of the report with at least one comment associated with one of the evaluation objectives and embedded in a corresponding portion of the copy of the report.

A first content of the received report may be organized differently than a second content of the reference report. The exam grader can handle this situation. For example, one of the evaluation objectives in the rubric may comprise evaluation of a first content of the received report based on a second content of the reference report. This flexibility enables the system to evaluate content regardless of its organizational structure, focusing on whether required elements are present rather than where they are located.

The exam grader may output, to a user device associated with an instructor, the report and the evaluation output to the report. The exam grader may receive, from the user device associated with the instructor (e.g., via the exam grader UI), feedback associated with at least one of the comment or one of the plurality of scoring points in the evaluation output. The exam grader may then initiate training of the one or more LLMs based on the feedback, enabling continuous improvement of the exam grader. The approach of the exam grader to evaluation helps enable formative assessment by providing feedback to students beyond just a score and by enabling resubmission and regrading cycles to allow students to iteratively improve their work product based on the feedback.

The exam grader may include multiple levels of verification to ensure grading accuracy and appropriateness. For example, the exam grader may check whether there is consistency in grading among students in a course (e.g., regardless of instructor) and whether the comments from the one or more LLMs are related to course material in the knowledge database associated with the particular course. Additionally, the exam grader may implement a verification process that maintains instructor authority while leveraging AI capabilities. For instance, evaluation outputs (e.g., grades) may not be displayed to students until they have been reviewed and approved by the instructor via the exam grader UI.

The exam grader may provide multiple different reports to the instructor via the exam grader UI to support instructional decision-making. For example, reports may be generated per student to track individual performance across all assessments, per exam to identify which questions students had difficulty with, and/or per topic to track performance on the same conceptual material across multiple assessments. The exam grader may provide student performance distribution reports to the instructor via the exam grader UI to show overall class performance. The exam grader may provide student participation analytics to the instructor via the exam grader UI to show engagement with course materials and discussion boards. The exam grader may provide performance by chapter or concept reports to the instructor via the exam grader UI to illustrate which conceptual areas require additional instruction. This comprehensive analytics capability provided by the exam grader enables instructors to identify weaknesses for their students and adjust their teaching accordingly.

The exam grader may integrate with the knowledge database. The exam grader may include course material (e.g., lectures, transcripts, instructor notes, textbooks, instructor presentations, instructor question-answer pairs, etc.) in the prompts provided to the one or more LLMs for the generation of rubrics and evaluation of student work.

In an embodiment, the exam grader incorporates mechanisms for continuous improvement through instructor and student feedback. For example, the exam grader may receive, from the user device associated with an instructor of the particular course, feedback associated with evaluation outputs. The exam grader may then initiate training of the LLMs based on this feedback.

The feedback may relate to the style or phrasing of generated rubrics, the appropriateness of assigned scores, and/or the clarity of generated comments. Student complaints about grades can also provide feedback for system refinement. When students believe a question was confusing or inappropriately graded, the instructor may evaluate the complaint. Reasonable complaints indicating content or style issues can be fed back to the exam generator for training LLMs, clarifying confusing questions in future question generation. Reasonable complaints may also cause updating of the rubric and reassessment of the answer(s) by the exam grader. The iterative refinement process, applied across a plurality of different courses and course sections, enables continuous enhancements of grading accuracy and appropriateness.

Providing LLMs in an interactive NLP-based education assistance system with course-specific and/or instructor-specific knowledge database can provide students with teaching assistance that is consistent and aligned with expectations of corresponding instructors. The interactive NLP-based educational assistance system can save educators'time and energy for answering general queries and/or at least some course-specific queries. The interactive NLP-based educational assistance system can also provide students with real-time feedback and guidance without being limited to certain TA or professor office hours and/or being at certain office or classroom locations. Storing a knowledge database and/or an experience database and/or executing LLMs locally at a private network system of an education institution can ensure data privacy. Evaluating the accuracy of LLM generated responses prior to providing the LLM generated responses to students can ensure that the students are given accurate information. Providing a communication channel or pipeline between students and instructors within the interactive NLP-based education assistance system can enable human instructors to correct LLM generated responses and promote student-teacher interactions. Feedback from students and/or human instructors and/or corrected responses from human instructors can be used to fine-tune parameters of LLMs, and thus the performance and/or the accuracy of the LLMs can be continually enhanced. Tracking and storing exchanges between a ChaTA system and students and/or human instructors in an experience database and using stored (or cached) responses whenever possible can reduce processing complexity and/or cost. Further, promoting student queries and corresponding responses from the experience database to the knowledge database based on positive feedback from the human instructor can allow the knowledge database to be continually augmented and enriched. Using different LLMs (of different performances and/or different costs) for different types of student queries can allow for processing and cost reduction.

Collecting student query-response data generated from the interactive NLP-based education assistance system that uses a knowledge database with course-specific and instructor-specific course materials can provide valuable insights into student or class learning performance and teaching performance (e.g., effectiveness of course materials). For instance, at an individual level, an instructor feedback report can be generated for a specific instructor based on student query-response data associated with the specific instructor and specific course materials provided by that instructor. At a group level, an instructor assessment report can be generated based on student query-response data associated with the same course but different instructors to provide a comparison of teaching performances across different instructors that teach the same course. At an institution level, an assessment report can be generated based on student query-response data associated with the same course but across different faculties to provide a comparison of student learning performances and/or teaching performances among different instructors across different faculties. In some instances, best practices for instructors and/or provisioning of course materials may be developed based on the feedback reports across instructors and/or across faculties. These best practices may also be useful for new instructors. The interactive NLP-based educational assistance and teaching feedback mechanisms may be suitable for use in any educational institutions (e.g., schools, colleges, universities) and/or any organizations that provide educational training.

Using generative AI (e.g., LLMs) to automatically create or generate assessment questions and/or answers based on course material of a particular course provided by a professor and learning concepts (e.g., topics, sub-topics, chapters, sub-chapters, sections, modules, etc.) and/or assessment goals (e.g., including quizzes, midterm exams, final exams, assignments, projects, reports, etc.) guided and defined by the professor can ensure the generated questions are relevant to and aligned with the learning objectives of the course. Collecting student-specific query-response data and student-specific scores of individual students and generating assessment questions and/or answers further based on the student-specific query-response data and/or student-specific scores can provide an individual student with personalized assessment that targets specific concepts that the student may have difficulties in learning. Generating assessment questions based on a student's learning level or proficiency can allow the student to learn and test at their own pace. Using the exam grader in conjunction with the exam generator can provide dynamic real-time progress feedback to the student and allow for adaptive questions sequencing based on the student's progress. Recommending learning materials to individual students based on the individual students'learning levels, learning pattern, and/or preference can allow for a more effective learning process and improved user experience. Updating the LLMs based on feedback on the LLM generated questions from professors, TAs, and/or students can allow the LLMs to continue to improve, thereby generating high-quality assessment questions and/or answers. Using multiple different LLMs (e.g., having different model architectures and/or trained using different input data and/or different reference data) to generate assessment questions and/or answers and selecting questions and/or answers generated by the LLM with the highest confidence score among the multiple LLM can allow the assessment question generation to leverage the different strengths of the different LLMs (e.g., to cover different knowledge domains, different types of questions, etc.).

Creating an exam library and dynamically adding LLM generated questions and/or answers that are verified by an instructor to the exam library (as questions are verified) can build a golden or verified exam questions and/or answers repository over time. Reusing questions from the exam library and only generating questions that are not already in the exam library can allow for resource usage and/or processing overhead reduction. The automatic AI-driven assessment or exam question and/or answer generation discussed herein can save time and/or instructor resources in exam generation and cater to the growing demand for personalized learning and assessment. The automatic AI-driven assessment question and/or answer generation discussed herein may be suitable for online learning and/or in-person learning.

The AI-driven multi-LLM assessment evaluation system disclosed herein provides numerous technical advantages over conventional approaches. The use of multiple independent LLMs with different architectures and training by the exam grader for assessments enables the system to leverage the distinct strengths of different models, improving overall evaluation accuracy and coverage across different knowledge domains and question types. The dynamic rubric modification and batch re-evaluation capability provided by the exam grader enables computationally efficient iterative refinement and also helps to ensure fairness when rubric issues are discovered. The contextual comment generation by the exam grader provides students with detailed, specific feedback tied to their individual mistakes, supporting formative learning and mastery-based education through resubmission and regrading cycles.

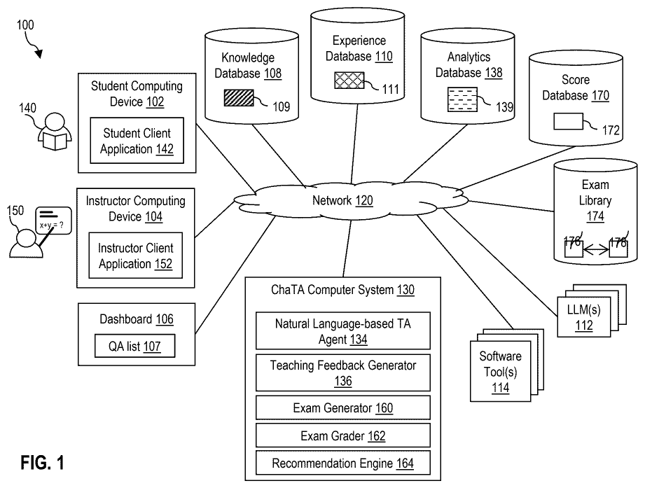

Turning now to FIG. 1, a network system 100 that provides interactive natural language-based teaching assistance to students using LLMs is described. The network system 100 provides an integrated platform including a dashboard 106, a knowledge database 108, an experience database 110, multiple LLMs 112, software tools 114, a network 120, a ChaTA system 130, and an analytics database 138. The network 120 promotes communication between the components of the network system 100. The network 120 may be any communication network including a public data network (PDN), a public switched telephone network (PSTN), a private network, and/or a combination.

The knowledge database 108 may include course-specific and/or instructor-specific course materials 109. The course materials 109 may include, for example, but are not limited to, textbooks, class notes, presentation slides, documents, audio and/or video recordings of lectures or lessons, transcripts of lecture or lesson recordings for a specific course and/or prepared by a specific instructor. The course material 109 for a particular course may also include indications (e.g., headings) of topics, sub-topics, chapters, sub-chapters, sections, sub-sections, modules, sub-modules, etc. for different portions of the course material 109. The headings may generally be organized in any suitable way. In some instances, the knowledge database 108 may also include other information, such as course-specific logistic information. The course-specific logistic information may include, for example, but is not limited to, course enrollment information, course syllabus, professor office hours, homework schedules, quiz schedules, and exam schedules. In an example, the knowledge database 108 may include multiple course-specific knowledge databases. For instance, the knowledge database 108 may include a first database for physics, a second database for calculus, and a third database for engineering drawings. In another example, the knowledge database 108 may include instructor-specific knowledge databases. For instance, the knowledge database 108 may include a first database including course materials 109 prepared and/or taught by professor A, a second database including course materials 109 prepared and/or taught by professor B, and a third database including course materials 109 prepared and/or taught by professor C. In a further example, the knowledge database 108 may include multiple course-specific and instructor-specific knowledge databases. For instance, the knowledge database 108 may include a first database including course materials 109 for physics and prepared and/or taught by professor A, a second database including course materials 109 for physics and prepared and/or taught by professor B, and a third database including course materials 109 for physics and prepared and/or taught by professor C. In other instances, the knowledge database 108 may be a single database storing course materials 109 from different instructors in different portions or sections of the database. In some examples, the knowledge database 108 may include different databases for different faculties (e.g., one for mechanical engineering and another one for electrical engineering). Generally, the knowledge database 108 may include one or more knowledge databases with course materials 109 organized in any suitable format. In some examples, the course materials 109 may be stored in the knowledge database 108 in a vector database format. For instance, each data entry in the knowledge database 108 may be represented as a vector in a multi-dimensional space. The vectors can represent a wide range of information, such as embeddings from text, images, audio recordings, video recordings, etc. A vector database can efficiently store and index multi-dimensional data and allow for efficient search in the multi-dimensional data.

The ChaTA system 130 may include at least one non-transitory memory and at least one processor. The ChaTA system 130 may include a natural language-based TA agent 134 (a ChaTA agent) including instructions stored in the memory and executable by the processor. The natural language-based TA agent 134 may communicate with the student 140 via a student client application 142 executing on a computing device 102 of the student 140 and may communicate with the instructor 150 via an instructor client application 152 executing on a computing device 104 of the instructor 150. For ease of illustration, FIG. 1 illustrates one student 140 and corresponding student computing device 102 and one human instructor 150 and corresponding instructor computing device 104. However, the network system 100 can include any suitable number of students 140 and corresponding student computing devices 102 (e.g., 2, 3, 4, 10, 20, 30, 40, 50, 100 or more) and any suitable number of human instructors 150 and corresponding instructor computing devices 104 (e.g., 2, 3, 4, 5, 6, 7, 8 or more).

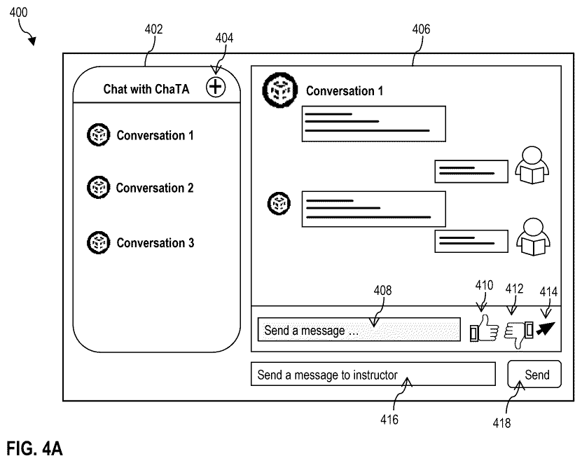

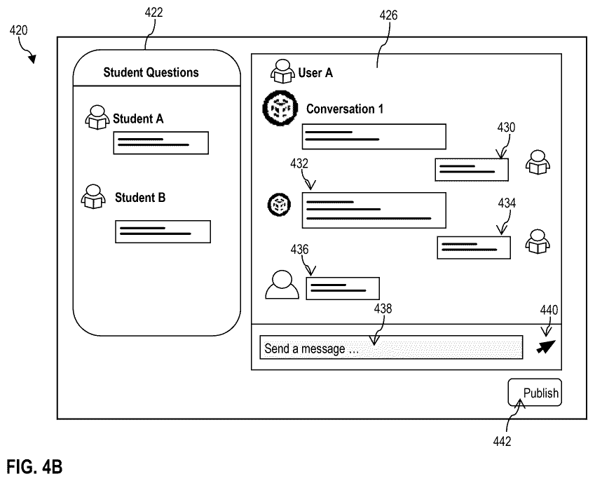

Each of the student computing device 102 and the instructor computing device 104 may be a cell phone, a mobile phone, a smart phone, a smart watch, a personal digital assistant (PDA), a laptop computer, a tablet computer, a notebook computer, a virtual reality headset, or a desktop computer. In some examples, the student client application 142 and/or the instructor client application 152 may render a frontend user interface (UI) with a natural language interface (e.g., the UIs 400 and 420 shown in FIG. 4A-4B), and the natural language-based TA agent 134 may communicate with the front UI via application programming interfaces (APIs). In some examples, the student client application 142 and/or the instructor client application 152 may be web frontend applications, and the natural language-based TA agent 134 may be a web server application. In general, the natural language-based TA agent 134, the student client application 142, and/or the instructor client application 152 may be implemented using any suitable server-client architecture that enables communications among each other.

At a high level, the natural language-based TA agent 134 may communicate with the student client application 142 to receive student queries in natural language from the student 140. The natural language-based TA agent 134 may utilize one or more of the LLMs 112 to generate responses (answers) in natural language to the student queries using the knowledge database 108. The student 140 and/or the human instructor 150 may provide feedback about responses generated by an LLM 112. The student 140 may also request a response from the human instructor 150 upon receiving an unsatisfactory response generated by an LLM 112. The natural language-based TA agent 134 may cache or store a history of student queries and corresponding responses communicated with the student 140 and/or the human instructor 150 in the experience database 110 (as shown by the student query-response data 111).

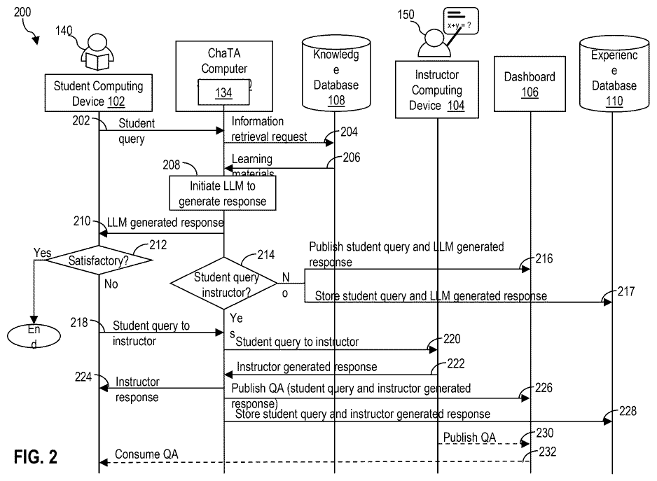

Further, the natural language-based TA agent 134 may publish student queries and corresponding responses (e.g., a list of question-answers (QAs) shown by the QA list 107) in the dashboard 106 to further enhance student learning experience. For instance, the dashboard 106 may be a public dashboard that can be accessed by any student in a class (taught by a certain professor). In some instances, a student may check the dashboard 106 for an answer to a question prior to sending the question to the ChaTA system 130. In an example, the dashboard 106 may be an application executed on a computer system (e.g., similar to the ChaTA system 130). For instance, the dashboard 106 may be a web application executed on a web server with a database that stores the QA list 107, and the student 140 may access the QA list 107 via a web link. The interactions between the components of the network system 100 are described more fully below with reference to FIG. 2.

In an embodiment, the LLMs 112 may be of different LLM types having different attributes. For instance, the LLMs 112 may include, but are not limited to, one or more OpenAI® models (e.g., a GPT-3 model, a GPT-3.5 model, a GPT-4 model, a GPT-5 model or higher versions), one or more open-source LLMs, an LLM Meta AI (Llama) model, Google Gemini® model, or Claude. The different LLMs 112 may have different performances. For instance, the different LLMs 112 may have different transformer architectures and may be trained on different types of datasets (e.g., from different knowledge fields and in various data modes, such as audio, video, and/or texts) and/or different amounts of data. In an example, a high-performance (or heavy-weight) LLM 112 may be good at answering questions that require deep insights or deep reasoning, a mid-performance (or mid-weight) LLM 112 may be sufficient for answering knowledge (e.g., course-specific) related questions, and a low-performance (or lightweight) LLM 112 may be sufficient for answering general questions.

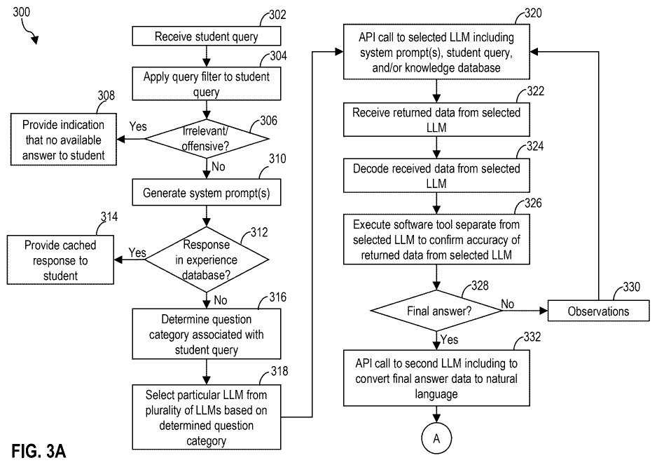

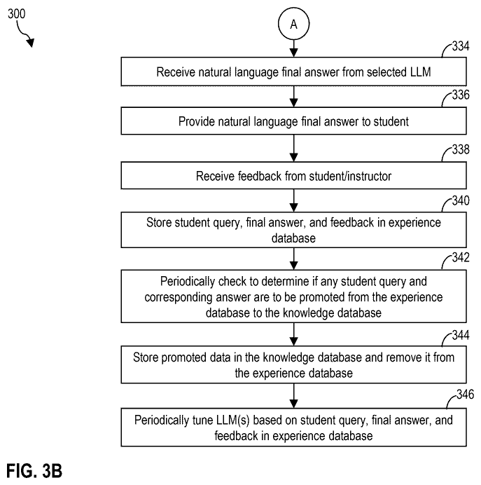

The different LLMs 112 may also have different associated costs. For instance, the different LLMs 112 may utilize different amounts of computational resources and/or memory resources. Additionally or alternatively, the different LLMs 112 may be associated with different subscription or service costs (e.g., each call to an OpenAI LLM incurs a fee). Generally, the higher the performance of the LLM 112, the higher the cost. As will be discussed more fully below with reference to FIGS. 3A and 3B, the natural language-based TA agent 134 may select a particular LLM 112 from the multiple LLMs 112 to answer a student query based on a question type or question category of the student query. Further, at least some of the LLMs 112 may be fine-tuned for operations associated with teaching assistance, such as providing responses to student queries, (e.g., during an initial tuning phase or during an operational phase).

To ensure the accuracy of a response generated by an LLM 112, the natural language-based TA agent 134 may evaluate the LLM generated response using software tools 114 that are independent of (separate from) the respective LLM 112 that generated the response as will be discussed more fully below with reference to FIGS. 3A and 3B. The software tools 114 may include, for example, but are not limited to, mathematical software, software development tools, and/or course-specific software and simulators (e.g., Matlab simulator, Spice circuit simulator, Microsoft Visual Studio, other LLMs, etc.) or web-based systems (e.g., Wolfram Alpha).

To ensure data privacy of the knowledge database 108, the experience database 110, the dashboard 106 may be stored in a private network of an educational institution (e.g., university, college, school), the ChaTA system 130 may be located within the private network, and the LLMs 112 may be executed locally on the ChaTA system 130 or another computer system within the private network.

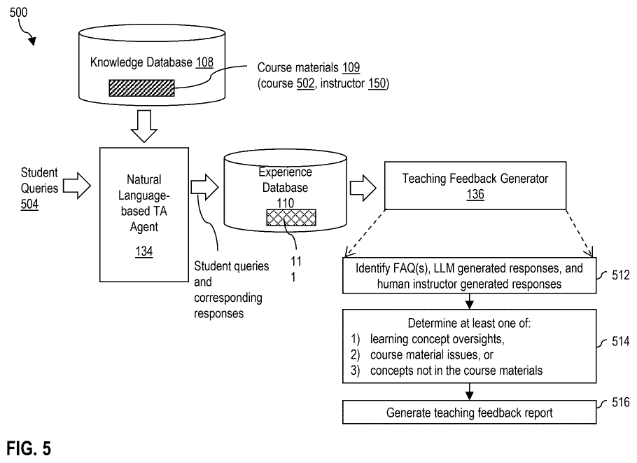

As further shown in FIG. 1, the ChaTA system 130 further includes a teaching feedback generator 136. The teaching feedback generator 136 may include instructions stored in the memory of the ChaTA system 130 and executable by the processor of the ChaTA system 130. The teaching feedback generator 136 may utilize the student query-response data 111 collected from the natural language-based TA agent 134 and stored in the experience database 110 to provide insights into student learning performance and teaching performance. In some instances, the teaching feedback generator 136 may generate analytics data 139 based on the experience database 110 (including student queries and corresponding LLM generated responses and interactions between various students 140 and the human instructor 150). The teaching feedback generator 136 may store the analytics data 139 in the analytics database 138. As will be discussed more fully below with reference to FIGS. 5-6 and 9-10, the teaching feedback generator 136 may generate feedback for a specific instructor (at an individual level), an assessment across multiple instructors teaching the same course (at a group level), and/or an assessment for the same course across faculties (at an institution level).

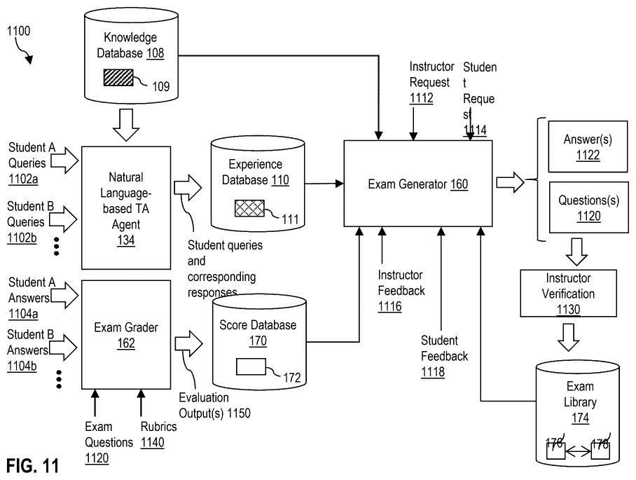

As further shown in FIG. 1, the ChaTA system 130 further includes an exam generator 160. The exam generator 160 may include instructions stored in the memory of the ChaTA system 130 and executable by the processor of the ChaTA system 130. The exam generator 160 may use the course materials 109 (e.g., provided by the instructor 150) in the knowledge database 108, the student query-response data 111 (e.g., between students 140 and the natural language-based TA agent 134) in the experience database 110, and/or student scores of the students 140 on previous exam or assessment questions to generate targeted questions for student assessment. The assessment can be for a class level assessment (e.g., quizzes, midterm exams, final exams, assignments, projects, reports, etc.) and/or an individual or a personalized student assessment (e.g., exercises, quizzes, etc.) for self-learning. The exam generator 160 may also generate reference answers corresponding to generated questions. The exam generator 160 may use one or more LLMs 112 to generate questions and corresponding answers. In some instances, the generated questions and corresponding answers (if generated) may be provided to the instructor 150 for verification. The exam generator 160 may dynamically add the verified questions and corresponding verified answers to an exam library 174 respectively as verified questions 176 and verified answers 178 (e.g., to create a “golden” exam question repository). Mechanisms for exam generation will be discussed more fully below with reference to FIGS. 11-15.

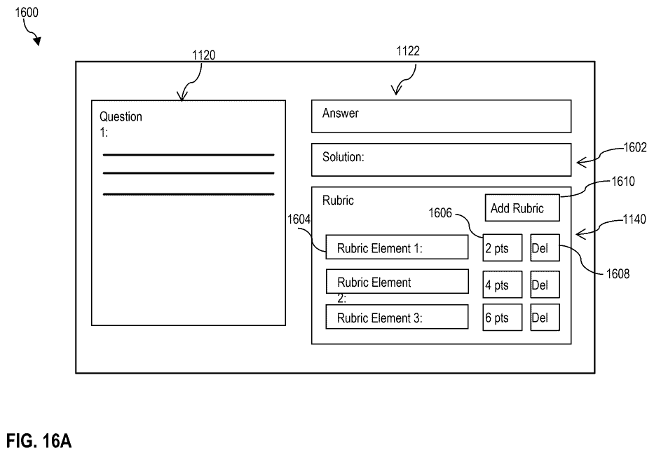

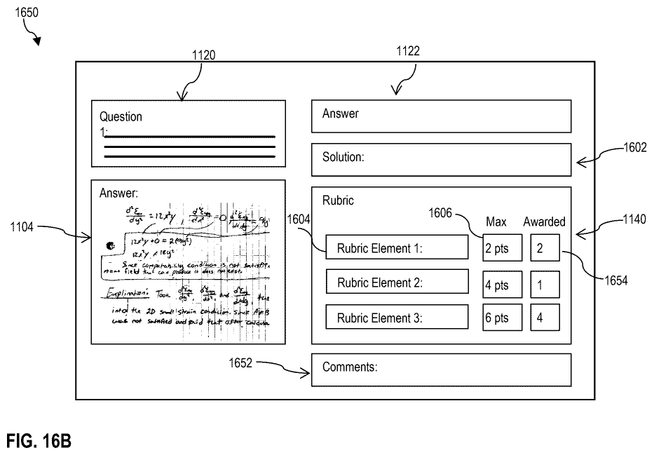

As further shown in FIG. 1, the ChaTA system 130 further includes an exam grader 162. The exam grader 162 may include instructions stored in the memory of the ChaTA system 130 and executable by the processor of the ChaTA system 130. The exam grader 162 may grade exam questions based on corresponding answers and associated rubrics (e.g., a scoring guide with a set of criteria and performance levels or score points). The exam questions and corresponding answers can be provided by an instructor 150. Alternatively, the exam questions and corresponding answers may be generated by the exam generator 160 as discussed herein. The rubrics may be automatically generated by the exam grader 162 based on the questions or provided by the instructor 150. Alternatively, the rubrics may be provided by an instructor 150. The exam grader 162 may grade student-by-student and question-by-question and may store the grades or scores (shown by the scores 172) of the students 140 in a score database 170. The exam grader 162 may grade quizzes, midterm exams, final exams, assignments, projects, lab reports, etc. The exam grader 162 may generate rubrics and/or grade various assessments using one or more LLMs 112. The exam grader 162 may operate together with the exam generator 160 to provide a full view of student learning progress in a systematic and consistent manner. Mechanisms for exam grading will be discussed more fully below with reference to FIGS. 16-19.

As further shown in FIG. 1, the ChaTA system 130 further includes a recommendation engine 164. The recommendation engine 164 may include instructions stored in the memory of the ChaTA system 130 and executable by the processor of the ChaTA system 130. The recommendation engine 164 may recommend learning materials from the course materials 109 for a student 140 based on the learning level, the skills, the learning patterns, and/or the preference of the student 140.

FIG. 1 is merely an example of components of a network system that provides interactive NLP-based teaching assistance to students and feedback to teachers or instructors, and variations are contemplated to be within the scope of the present disclosure. In embodiments, the network system may include other components not illustrated in FIG. 1. In embodiments, the network system may not include every component illustrated in FIG. 1. In embodiments, the components and connections may be implemented with different connections than those illustrated in FIG. 1. Such and other embodiments are contemplated to be within the scope of the present disclosure.

Turning now to FIG. 2, an example method 200 for providing interactive natural language-based teaching assistance to students is described. The method 200 illustrates operations performed by various components of the network system 100. Specifically, the components include the ChaTA system 130 (or more specifically, the natural language-based TA agent 134), the student 140 and corresponding student computing device 102, the human instructor 150 and corresponding instructor computing device 104, the knowledge database 108, the dashboard 106, and the experience database 110. However, it is contemplated that other component(s) of the network system 100 may be involved in performing the operations of the method 200. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

As shown in FIG. 2, at operation 202, the student 140 transmits, via the student computing device 102, a student query to the natural language-based TA agent 134 at the ChaTA system 130. At operation 204, in response to the student query, the natural language-based TA agent 134 transmits an information retrieval request to the knowledge database 108. At operation 206, the natural language-based TA agent 134 receives course materials 109 (e.g., course-specific and/or instructor-specific course materials that are factual information) from the knowledge database 108. At operation 208, after receiving the course materials 109, the natural language-based TA agent 134 initiates one or more LLMs 112 to generate a response to the student query using the retrieved course materials 109 as will be discussed more fully below with reference to FIGS. 3A-3B. At operation 210, the natural language-based TA agent 134 transmits the LLM generated response to the student computing device 102. In some examples, the LLM generated response may include excerpts of the course materials 109 (e.g., including documents, slides, audio files, and/or video files) that are relevant to the student query. For instance, the student query may ask about a deep learning model, and the LLM generated response may include information and/or examples about deep learning models extracted from the course materials 109.

At operation 212, after receiving the LLM generated response, the student 140 determines whether the LLM generated response is satisfactory or not. If the LLM generated response received at operation 210 is satisfactory, the student 140 may not take another action regarding the student query requested at operation 202 (e.g., may move on to another student query). If, however, the LLM generated response received at operation 210 is unsatisfactory (e.g., the response is incomplete, does not make sense, seems inaccurate, and/or, generally, does not answer the student query), the student 140 may ask the human instructor 150 (e.g., a professor) for an answer to the query. For instance, at operation 218, the student 140 transmits, via the student computing device 102, the student query directing to the human instructor 150.

Generally, the natural language-based TA agent 134 may monitor whether the LLM generated response provided to the student 140 at operation 210 is satisfactory to the student 140 as shown by operation 214. At operation 220, upon receiving the student query directing to the human instructor 150, the natural language-based TA agent 134 forwards the student query to the instructor computing device 104. At operation 222, in response to the student query forwarded to the human instructor 150, the human instructor 150 transmits, to the natural language-based TA agent 134 via the instructor computing device 104, a modified response to the student query. For instance, the human instructor 150 may review the LLM generated response and correct the LLM generated response. At operation 224, upon receiving the modified response from the human instructor 150, the natural language-based TA agent 134 forwards the modified response to the student computing device 102.

As discussed above, the natural language-based TA agent 134 may publish student query and corresponding responses to the dashboard 106 and store a history of student query and corresponding responses in the experience database 110. Returning to operation 214, if the natural language-based TA agent 134 does not receive any student query, from the student 140, directing to the human instructor 150, the natural language-based TA agent 134 proceeds to operation 216. At operation 216, the natural language-based TA agent 134 publishes the student query and the corresponding LLM generated response in the dashboard 106. Further, at operation 217, the natural language-based TA agent 134 stores the student query in association with the corresponding LLM generated response in the experience database 110. Similarly, at operation 226, after receiving the modified response from the human instructor 150, the natural language-based TA agent 134 publishes the student query in association with the modified response (from the human instructor 150) in the dashboard 106. Further, at operation 228, the natural language-based TA agent 134 stores the student query in association with the corresponding instructor generated response in the experience database 110. Generally, all interactions between students 140 and human instruction(s) 150 may be stored in the experience database 110 for generating analytics to assist human instructor(s) 150 in understanding the needs and/or performance of the students 140 as will be discussed more fully below with reference to FIG. 5.

In some examples, the human instructor 150 may publish FAQs and corresponding answers (related to a certain course) in the dashboard 106 (e.g., at operation 230). The student 140 may consume information published in the dashboard 106 (e.g., at operation 232). In an example, the student 140 may search the dashboard 106 for an answer to a question prior to asking the natural language-based TA agent 134. In some instances, the dashboard 106 may be a public dashboard that can be accessed by any student within a certain department or faculty.

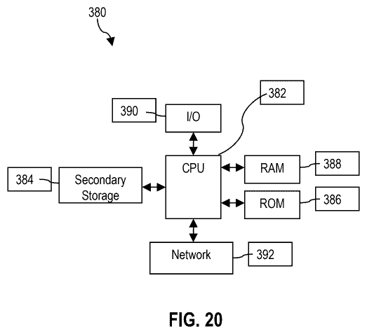

Turning now to FIGS. 3A and 3B, an example method 300 for providing interactive natural language-based teaching assistance to students is described. The method 300 may include similar mechanisms as discussed above with reference to FIGS. 1-2. The method 300 may be implemented by the natural language-based TA agent 134. In embodiments, the method 300 may be implemented using a computer system with components as shown in FIG. 20. As illustrated, FIGS. 3A and 3B include a number of enumerated operations, but embodiments of the operations in FIGS. 3A and 3B may include additional operations before, after, and in between the enumerated operations. In some embodiments, one or more of the enumerated operations may be omitted or performed in a different order.

At block 302, the natural language-based TA agent 134 receives a student query in natural language from the student client application 142 executing on the student computing device 102. At block 304, upon receiving the student query, the natural language-based TA agent 134 applies a query filter to the student query. At block 306, based on the application of the query filter, the natural language-based TA agent 134 determines if the student query is irrelevant and/or offensive. If the student query is irrelevant and/or offensive, the natural language-based TA agent 134 may proceed to block 308. At block 308, the natural language-based TA agent 134 provides a simple response to the student, for example, indicating that the student query cannot be answered. Otherwise, the natural language-based TA agent 134 proceeds to block 310.

At block 310, the natural language-based TA agent 134 generates system prompts based on the student query. As part of generating the system prompts, the natural language-based TA agent 134 may determine a context, a reference to the knowledge database 108, and a reference to the experience database 110 based on the student query. The context may include an indication of a certain subject or course (e.g., a math course, a programming course, an engineering science course, etc.) associated with the student query. In some examples, a school or university may offer multiple classes for the same course but may be taught by different instructors. Thus, the context may also include an indication of a certain instructor associated with the student query. For instance, the natural language-based TA agent 134 may determine that the student 140 is in a class taught by the certain instructor based on account information associated with the student 140. The reference to the knowledge database 108 may be determined based on the context (e.g., the class or course indication).

As discussed above, in some examples, the knowledge database 108 may include multiple course-specific and/or instructor-specific knowledge databases 108, and thus the reference may include an indication (e.g., a storage path or a link) to the corresponding course-specific and/or instructor-specific knowledge database. Similarly, the experience database 110 may be based on the course indication and/or the instructor indication in the context. As discussed above, the experience database 110 may include multiple course-specific and/or instructor-specific experience databases, and thus the reference may include an indication (e.g., a storage path or a link) to the corresponding course-specific and/or instructor-specific experience database. The context may include an output configuration including an example question-response pair and/or an output response form or structure to guide an LLM in generating a final output or final answer to the student query. As an example, a student query may be “Where is the recitation session for this class?”. If the natural language-based TA agent 134 finds the answer to the question in the knowledge database 108 provided by the instructor 150, the natural language-based TA agent 134 may respond with “According to the instructors syllabus which can be found at http// . . . the recitations are on Tuesdays 3:00 to 5:00 PM in Helendefels 205”. If, however, the natural language-based TA agent 134 fails to find the answer in the knowledge database 108, the natural language-based TA agent 134 may respond with “I am sorry. This information is not listed in the syllabus, I will elevate your query to the instructor.” Generally, the natural language-based TA agent 134 may use the specific problem-solving forms and models in the instructor's 150 lecture notes (in the knowledge database 108) to answer student's 140 relevant questions.

At block 312, the natural language-based TA agent 134 determines whether there is an available response to the student query in the experience database 110. If there is an available response to the student query stored or cached in the experience database 110, the natural language-based TA agent 134 proceeds to block 314. In some examples, the natural language-based TA agent 134 may utilize an LLM (e.g., a lightweight LLM) to perform the check. At block 314, the natural language-based TA agent 134 provides the cached response to the student 140 (e.g., by transmitting the cached response to the student client application 142). Otherwise, the natural language-based TA agent 134 proceeds to block 316.

At block 316, the natural language-based TA agent 134 determines a question category associated with the student query. In some examples, the natural language-based TA agent 134 may utilize a classifier, an ML model, or an LLM 112 to perform the classification. In an embodiment, student queries may be classified into a general question category, a knowledge question category, or a deep reasoning (or deep insight) question category. The general question category may include queries that are not related to a specific course and do not require information from the knowledge database 108. The knowledge question category may include queries that are related to a specific course and require information (e.g., excerpts of course materials 109) from the knowledge database 108. The deep reasoning question category may include queries that require reasoning rather than simply course-specific knowledge and may or may not require information from the knowledge database 108.

At block 318, the natural language-based TA agent 134 selects a particular LLM 112 from the multiple LLMs 112 based on the determined question category associated with the student query. In an embodiment, the LLMs 112 may include a high-performance LLM 112 (e.g., an OpenAI® GPT-4 or higher version model), a mid-performance LLM 112 (e.g., an open-source LLM with additional RAG), and a low-performance LLM 112 (e.g., a Llama model). If the student query is in the deep reasoning question category, the natural language-based TA agent 134 may select the high-performance LLM 112. If the student query is in the knowledge question category, the natural language-based TA agent 134 may select the mid-performance LLM 112. If the student query is in the general question category, the natural language-based TA agent 134 may select the low-performance LLM 112. Generally, there may be any suitable number of question categories (e.g., 2, 3, 4 or more), each mapped to a different one of the LLMs 112, and the natural language-based TA agent 134 may select the LLM 112 based on the mapping.

At block 320, after selecting the particular LLM 112, the natural language-based TA agent 134 invokes an API call to the selected LLM 112. The natural language-based TA agent 134 may include the system prompts, the student query (the user prompt), and/or relevant information or course materials in the knowledge database 108 in an input to the API call. In some examples, the natural language-based TA agent 134 may include the system prompts and the student query in the input to the API call, for example, when the student query is under the general question category or the deep reasoning category. In some examples, the natural language-based TA agent 134 may include the system prompts, the student query, and the relevant information or course materials 109 (from the knowledge database 108) in the input to the API call, for example, when the student query is under the knowledge question category or the deep reasoning category.

In some examples, the natural language-based TA agent 134 may apply a RAG process to retrieve relevant information from the knowledge database 108 and direct the selected LLM 112 to use the retrieved information for generating the response to the student query. The RAG process may use a similarity measure between the student query and the information in the knowledge database 108 to identify the most relevant information (e.g., the top 10 most relevant information pieces) from the knowledge database 108 to be used for answering the student query. In some examples, the natural language-based TA agent 134 may further apply a ranking process to narrow down the number of information pieces identified from the RAG process. For instance, the ranking process may identify a subset of the information pieces (e.g., the top 5 out of the 10 relevant information pieces) identified from the RAG process, and the selected LLM 112 may use the subset of the information pieces to generate the response to the student query. In some examples, the natural language-based TA agent 134 may utilize ML (e.g., an MMR model) to perform the ranking.

In an example, the system prompts generated at block 310 may be in the form of reasoning and action (ReACT). For instance, the system prompts may include a sequence of one or more thoughts, each followed by an action and an action input. In such an example, the API call at block 320 for initiating the selected LLM 112 to generate a response to the student query may include input arguments including a question (e.g., the student query) and the sequence of one or more thoughts and corresponding actions and action inputs. In an example, the API call may be as shown below:
API call (question, thought, action, action input).

As an example, the student query received at block 302 includes “what is circuit modeling?”. In such an example, the system prompts may include a series of thoughts. For instance, a first thought may be “collect information about basic circuit components,” a second thought may be “collect information about circuit analysis,” a third thought may be “collect information about types of circuit models (e.g., direct current (DC) vs alternate current (AC)), a fourth thought may be “collect information about circuit modelling techniques,” and a fifth thought may be “collect information about circuit simulation software tools”. Each of the thoughts may be followed by an action indicating “to search” and an action input including a reference to certain section(s) or portion(s) of the course materials 109 in the knowledge database 108 (or excerpts of certain section(s) or portion(s) of the course materials 109) that include relevant information related to the respective thought. In general, the system prompts or the sequence of thoughts, actions, and action inputs may guide the selected LLM 112 to think and act autonomously (which may include using external tools) based on the user prompt (the received student query) and the knowledge database 108 (e.g., the relevant portions of the knowledge database 108).

At block 322, in response to the API call at block 320, the natural language-based TA agent 134 receives returned data (e.g., textual data) from the selected LLM 112. At block 324, the natural language-based TA agent 134 may decode the data received from the selected LLM 112. The decoding may include parsing the received text data into a specific format. As an example, the student query may request assistance in understanding a certain concept, the received text data may be a sequence of characters, sub-words, and/or words, and the decoding may format the received data into meaningful sentences. As another example, the student query may request for a piece of JavaScript object notation (JSON) code for performing a certain operation, the received text data may be a sequence of characters, numerical values, sub-words, and/or words, and the decoding may format the received data into the JSON code format. As a further example, the student query may request for a piece of python code that performs a certain operation, the received text data may be a sequence of characters, numerical values, sub-words, and/or words, and the decoding may format the received data into the python code format.

At block 326, the natural language-based TA agent 134 executes one or more software tools 114 that are independent of (separate from) the selected LLM 112 to confirm the accuracy of the data received from the selected LLM 112. For instance, the natural language-based TA agent 134 may determine whether the LLM generated data satisfies one or more criteria based on the execution of the one or more software tools 114.

As an example, the student query may request for a python code example to delete a certain word from a document, and the selected LLM 112 may generate a piece of python code to delete the certain word from a document. The one or more software tools 114 may include a python code simulator/debugger that can execute the piece of python code (generated by the selected LLM 112 and formatted by the decoding at block 324). To test the LLM generated python code, the natural language-based TA agent 134 may provide an input document including the certain word (to be deleted) as an input to the formatted python code, execute the formatted python code in the python code simulator/debugger, and check that an output document generated from the execution does not include the certain word. Stated differently, in such an example, the one or more criteria may include checking that the LLM generated python code can execute without errors and that the output of the python code is as expected. In some instances, the software tools 114 may include another LLM 112 different than the selected LLM 112, and the natural language-based TA agent 134 may use the other LLM 112 to judge the output returned by the selected LLM 112. For instance, the other LLM 112 may determine whether the output returned by the selected LLM 112 is in coherence and compliant with the context provided in the system prompts (generated at block 310).

At block 328, the natural language-based TA agent 134 determines whether the data returned from the selected LLM 112 at block 322 is the final answer based on the execution of the one or more software tools 114. If the natural language-based TA agent 134 determines that the returned data from the selected LLM 112 at block 322 is inaccurate (e.g., failing to satisfy the one or more criteria), the returned data is not the final answer. If the returned data is not the final answer, the natural language-based TA agent 134 proceeds to block 330. At block 330, the natural language-based TA agent 134 makes observations (e.g., errors or inaccuracies, missing information, etc.) based on the evaluation (e.g., the execution of the software tools at block 326) and returns to block 320 to repeat the process of initiating the selected LLM 112 to generate a response to the student query. When repeating this process, the natural language-based TA agent 134 may provide additional feedback observed from the execution of the one or more software tools 114 (at block 328) to the selected LLM 112 in addition to the system prompts and the user prompt that were previously provided to the selected LLM 112. As an example, if a student 140 requests a piece of code for generating the factorial of a number, a request for a factorial of zero or a negative number may not be correct. In this case, the LLM 112 may repeat the process (of generating the factorial) with the additional requirement to include the case of 0 factorial and additionally an error message if a negative number is input to the factorial generation code. As another example, if a student 140 requests an algorithm for a simulation task, the natural language-based TA agent 134 may invoke an additional software tool 114 to run the code to make sure the code is bug-free. In this case, the observation may be the bug information from the additional software tool 114. As a further example, the code for the algorithm may go into an infinite loop if a wrong termination condition is set or if indices are mishandled. The infinite loop information may assist the natural language-based TA agent 134 to revise the final answer. Generally, in each repeating API call to the LLM 112, the natural language-based TA agent 134 may include a previous response or data generated by the selected LLM 112 in the API call input and/or feedback based on observations made by the natural language-based TA agent 134. If, however, the natural language-based TA agent 134 determines that the LLM generated response is accurate (e.g., satisfying the one or more criteria), the data returned from the selected LLM 112 at block 322 is the final answer. Accordingly, the natural language-based TA agent 134 proceeds to block 332.

At block 332, the natural language-based TA agent 134 may initiate a second LLM 112 to generate a final answer in natural language to the student query. In some examples, the second LLM 112 may be the same as the selected LLM 112. In other examples, the second LLM 112 may be different than the selected LLM 112. At block 334, the natural language-based TA agent 134 may receive the final answer from the selected LLM 112. At block 336, upon receiving the final answer, the natural language-based TA agent 134 may provide the final answer to the student 140 by transmitting the final answer to the student client application 142.

At block 338, the natural language-based TA agent 134 receives feedback from the student 140 (via the student computing device 102) and/or the human instructor 150 (via instructor computing device 104). In an example, the student 140 may provide a thumbs up indicator or a thumbs down indicator to indicate whether the final answer provided by the natural language-based TA agent 134 is satisfactory or unsatisfactory, respectively. Similarly, the human instructor 150 may review the final answer (provided by the natural language-based TA agent 134) and provide a thumbs up indicator or a thumbs down indicator to indicate whether the final answer is satisfactory or unsatisfactory, respectively. Other forms of feedback may additionally and/or alternatively be provided by the student 140 and/or human instructor 150.

At block 340, the natural language-based TA agent 134 stores the student query, the final answer, and the received feedback in the experience database 110. In general, the natural language-based TA agent 134 may store the entire conversation with the student 140 and/or the human instructor 150 in the experience database 110. As discussed above with reference to FIG. 2, in some instances, the student 140 may query the human instructor 150 when the response provided by the natural language-based TA agent 134 (or more specifically, by the selected LLM 112) is unsatisfactory. In such instances, the natural language-based TA agent 134 may store the response provided by the human instructor 150 in the experience database 110 instead of the LLM generated response.

At block 342, the natural language-based TA agent 134 periodically (e.g., hourly, daily, biweekly, or monthly) determines if any student query and corresponding answer are to be promoted from the experience database 110 to the knowledge database 108. For instance, the natural language-based TA agent 134 may determine to promote a certain student query and corresponding answer based on the answer being a “golden answer” provided by the human instructor 150 or a reception of positive feedback from the human instructor 150. At block 344, the natural language-based TA agent 134 stores the promoted data (e.g., a student query and a corresponding answer) in the knowledge database 108. After promoting the data to the knowledge database 108, the natural language-based TA agent 134 may remove the promoted data from the experience database 110. Generally, the natural language-based TA agent 134 may promote student queries and corresponding responses from the experience database 110 to the knowledge database 108 at any suitable time.

At block 346, the natural language-based TA agent 134 periodically (e.g., hourly, daily, biweekly, or monthly) tunes parameters of the one or more of the LLMs 112 based on the student queries and corresponding responses and/or feedback. Generally, an LLM 112 may include various types of parameters, such as embedding parameters and transformer parameters. The embedding parameters (which may be referred to as embeddings) are used to map words or tokens into continuous vector representations. Each word or token in the model's vocabulary is associated with a unique embedding vector. These embeddings capture semantic relationships between words, allowing the model to understand the meaning and context of the text. The LLM 112 may have a transformer architecture including a plurality of self-attention layers and feedforward neural networks. The transformer parameters may include attention parameters, feedforward parameters, output parameters, positional encoding parameters, and normalization parameters. The attention parameters may determine how much importance the LLM 112 may give to each word or token in the input sequence when processing a given word or token. The feedforward parameters are parameters in each transformation layer of the feedforward neural networks. The output parameters are used to generate the final output of the LLM 112, which may be a probability distribution over the vocabulary. The output parameters are learned based on the context provided by the input text and are used to predict the next word or token in a sequence. The positional encoding parameters are used to provide information about the position of words in the input sequence and may assist the LLM 112 to maintain the sequential order of words during processing. The normalization parameters are used to normalize the activations of neurons in each transformer layer, ensuring that the model learns effectively. In an example, parameters of an LLM 112 may be trained or fine-tuned based on a student query and a response provided or corrected by the human instructor 150. In another example, the parameters of an LLM 112 may be trained or fine-tuned based on a student query, a response generated by the LLM 112, and feedback from the student 140. In some examples, the tuning or training may apply different weights (or rewards) depending on whether the feedback is from the student 140 or the human instructor 150. Generally, the natural language-based TA agent 134 may tune parameters of the one or more LLMs 112 at any suitable time.

Generally, the operations of the method 300 may be implemented in any suitable way. In some examples, the natural language-based TA agent 134 may include multiple software modules, for example, including a preprocessor, system prompt generator, a router, and a natural language-based TA agent (“ChaTA agent”). In such examples, the operations at blocks 302 to 308 may be performed by the preprocessor, the operations at block 310 may be performed by the system prompt generator, the operations at blocks 316 to 318 may be performed by the router, and the operations at blocks 320 to 346 may be performed by the ChaTA agent.

Turning now to FIG. 4A, an example UI 400 is described. In an embodiment, the UI 400 may be rendered by the student client application 142 and communicate with the natural language-based TA agent 134 (e.g., via APIs,). For instance, the student 140 may execute the student client application 142 on the student computing device 102 and may communicate with the natural language-based TA agent 134 using the UI 400.

As shown in FIG. 4A, the UI 400 may include a left panel 402 and a right panel 406. The left panel 402 may indicate conversation threads (shown by Conversation 1, Conversation 2, and Conversation 3) between the student 140 and the natural language-based TA agent 134. The left panel 402 may also include an interface 404 that the student 140 may click to start another conversation thread (e.g., conversation 4). The top portion of the right panel 406 may include a display of a current conversation (e.g., conversation 1) between the student 140 (on the right side) and the virtual, intelligent TA provided by the natural language-based TA agent 134 (on the left side). The middle portion of the right panel 406 may include a text box 408, a thumbs up indicator 410, a thumbs down indicator 412, and an interface 414. The student 140 may enter a query in the text box 408 and send the query to the natural language-based TA agent 134 by clicking the interface 414. The student 140 may also provide feedback to a response provided by the natural language-based TA agent 134 by clicking the thumbs up indicator 410 to indicate that the response is satisfactory or the thumbs down indicator 412 to indicate that the response is unsatisfactory. The bottom portion of the right panel 406 may include a text box 416 and a button 418. The student 140 may enter a query directing to the human instructor 150 in the text box 416 and may click the interface 414 to send the query to the human instructor 150 (e.g., when the student 140 is unsatisfied with a response returned by the natural language-based TA agent 134).

Turning now to FIG. 4B, an example UI 420 is described. In an embodiment, the UI 420 may be rendered by the instructor client application 152 and communicate with the natural language-based TA agent 134 (e.g., via APIs,). For instance, a human instructor 150 may execute the instructor client application 152 on the instructor computing device 104 and may communicate with the natural language-based TA agent 134 using the UI 420. The UI 420 may operate in relation to the UI 400. That is, the instructor 150 interacts with the natural language-based TA agent 134 via the UI 420 while a student 140 interacts with the natural language-based TA agent 134 via the UI 400.

As shown in FIG. 4B, the UI 420 may include a left panel 422 and a right panel 426. The left panel 422 may show questions from the students 140 (e.g., a student A and a student B). Generally, the UI 420 may indicate a student 140 using any suitable identification (e.g., by names, student identification numbers, student login identifiers, etc.). The right panel 426 may show conversations between the students 140 and the natural language-based TA agent 134 (e.g., as shown by the conversations thread in the panel 406 of FIG. 4A). In the illustrated example of FIG. 4B, the right panel 426 shows conversations between a particular student 140 A and the natural language-based TA agent 134. As shown, the student 140 A may ask a question 430, and the natural language-based TA agent 134 may send a response 432 to the question 430 (using mechanisms discussed above with reference to FIGS. 1-2 and 3A-3B). As an example, the student 140 A may not understand (or may be unsatisfied with) the response 432 provided by the natural language-based TA agent 134, and thus may direct the question 430 to the instructor 150. The instructor 150 may respond by providing an explanation through the response 436. The instructor 150 may enter the response 436 in the text box 438 and may click the interface 440 to send the response 436. In some instances, when the instructor 150 may determine that a certain student's 140 question may be a common question among students 140 in a class, the instructor 150 may also publish the student's 140 question and a corresponding response (e.g., from the instructor 150 or the natural language-based TA agent 134) to the whole class (e.g., via the dashboard 106) by clicking the interface 442.

FIGS. 4A-4B are merely an example of components of a UI, and variations are contemplated to be within the scope of the present disclosure. In embodiments, the UI may include other components not illustrated in FIGS. 4A-4B. In embodiments, the UI may not include every component illustrated in FIGS. 4A-4B. In embodiments, the components of the UI may be arranged differently than those illustrated in FIGS. 4A-4B. Such and other embodiments are contemplated to be within the scope of the present disclosure.

Turning now to FIG. 5, an example method 500 for providing teaching feedback for an individual instructor is described. The method 500 utilizes the student query-response data 111 collected from the natural language-based TA agent 134 to generate teaching feedback for a specific instructor 150. As shown in FIG. 5, the natural language-based TA agent 134 receives a plurality of student queries 504 associated with a course 502, for example, from one or more students 140 taught by the specific instructor 150. The natural language-based TA agent 134 may respond to the student queries 504 using the methods 200 and 300 discussed above with reference to FIGS. 2 and 3A-3B, respectively. For instance, the natural language-based TA agent 134 may respond to the student queries 504 using LLM(s) 112 and the knowledge database 108 (or more specifically, the course materials 109 prepared by the specific instructor 150 for the course 502). The natural language-based TA agent 134 may also request responses from the specific instructor 150 (e.g., when an LLM generated response is determined to be unsatisfactory by a respective student 140). The natural language-based TA agent 134 may also output and store student queries 504 in association with corresponding responses (e.g., including LLM generated responses and/or human instructor generated responses) as student query-response data 111 in the experience database 110.

The teaching feedback generator 136 may retrieve and process the student query-response data 111 collected in the experience database 110 to generate a teaching feedback report for the specific instructor 150. For instance, at block 512, the teaching feedback generator 136 identifies, from the student query-response data 111, a list of FAQs, LLM generated responses (generated by the LLM(s) 112), and human instructor generated responses (generated by the specific instructor 150). In an example, the teaching feedback generator 136 may identify the list of FAQs from the student query-response data 111 based on a number of occurrences of certain student queries 504 related to a certain learning concept in the student query-response data 111 is high (e.g., meeting a certain threshold). Alternatively, the teaching feedback generator 136 may select the top X (e.g., 5, 10, 20, 30 or more) number of highest occurrences student queries 504 as FAQs.

At block 514, the teaching feedback generator 136 determines, based on the FAQs, the LLM generated responses, and the human instructor generated responses, at least one of learning concept oversights (e.g., concepts in which students 140 may have difficulties in learning), issues with the course materials 109, or core problems that are not in the course materials 109. In an example, the teaching feedback generator 136 may determine learning concepts oversights based on the FAQs. For instance, the teaching feedback generator 136 may classify (e.g., using a classifier, a ML model, or an LLM) the student queries 504 (in the student query-response data 111) into categories of various learning concepts corresponding to learning goals for the specific course 502. The learning concepts covered by the FAQs may indicate learning concepts that the students 140 may have difficulties in learning.

In another example, the teaching feedback generator 136 may identify, for each LLM generated response (retrieved from the student query-response data 111), a corresponding portion of the course materials 109 from the knowledge database 108. The teaching feedback generator 136 may classify (e.g., using a classifier, a ML model, or an LLM) each of the identified portions of course materials 109 into one of the learning concepts. The learning concepts covered by the identified portions of course materials 109 (used for generating the responses to the student queries 504) may indicate learning concepts that the students 140 may have difficulties in learning. The learning concepts covered by the identified portions of course materials 109 may also indicate issues in the course materials 109. For instance, the teaching feedback generator 136 may analyze the content, the language, and/or the presentation style in the identified portions of course materials 109 (e.g., using ML or LLMs) to determine the reasons for having a large number of student queries 504 directed to those portions of the course materials 109.

In yet another example, the teaching feedback generator 136 may determine issues in the course materials 109 and/or core problems or learning concepts that are not in the course materials 109 based on the human instructor generated responses (retrieved from the student query-response data 111). For instance, the teaching feedback generator 136 may compare the human instructor generated responses to information provided in the course materials 109 (e.g., using semantic searches, ML, and/or LLMs). In one example, the feedback generator 136 may determine that the course materials 109 provide different or contradicting information compared to the respective human instructor generated response. In another example, the feedback generator 136 may determine, based on the comparison, that course materials 109 do not cover certain knowledge information provided by the respective human instructor generated response. In some other instances, the teaching feedback generator may determine an issue in a certain portion or a certain concept of the course materials when there is a high number of student queries (e.g., greater than a certain threshold) directing to that portion or concept.

At block 516, the teaching feedback generator 136 generates a teaching feedback report including the learning concept oversights, the course material issues, and/or the core problems not in the course materials 109 determined at block 514. Subsequently, the teaching feedback generator 136 may provide the teaching feedback report to the specific instructor 150 (e.g., via instructor client application 152 or any other suitable forms of communications). In some examples, the teaching feedback generator 136 may provide the teaching feedback report to the specific instructor 150 based on a request from the specific instructor 150. In some examples, the teaching feedback generator 136 may provide the teaching feedback report to the specific instructor 150 based on a certain schedule (e.g., weekly, monthly, etc.). In this way, the specific instructor 150 may adjust the course materials 109 to cover missing concepts and/or correct issues and/or teachings in class to focus on concepts that the students 140 have difficulties in learning.

In some examples, the teaching feedback generator 136 may generate analytics data 139 based on the experience database 110 (including student queries and corresponding LLM generated responses and interactions between various students 140 and the human instructor 150), and the teaching feedback report may be based on the analytics data 139. The analytics data 139 may include a variety of information related to class management and student data analytics. For instance, the analytics data 139 may include student overall performance by topics or learning concepts (e.g., based on the number of questions asked by the students for corresponding topics). In an example, quizzes, tests, and/or exams may be generated based on the course materials 109, and scores or results of the students 140 may be collected for analysis. Additionally or alternatively, the analytics data 139 may include student engagement analytics (e.g., based on the number of questions asked by the students and/or the number of ratings from the students for corresponding topics). Additionally or alternatively, the analytics data 139 may include identification of at-risk students 140. For instance, an at-risk student 140 may ask a large amount of questions related to a certain topic and/or have a poor performance in quizzes, tests, and/or exams. Identifying at-risk students 140 may allow the human instructor 150 to reach out to those students 140 or add additional classes to assist those students 140. Additionally or alternatively, the analytics data 139 may include teaching adjustment recommendations and feedback (e.g., based on issues and/or teaching effectiveness of the course materials 109 identified as discussed).

In an embodiment, the analytics data 139 related to the student overall performance by topics or learning concepts may be presented in a report format. For instance, the report may include, for each topic, an average score (e.g., in percentage (%)), a standard deviation, the percentage of students receiving a score below a certain threshold (e.g., 70%), and a summary of most common issues experienced (or mistakes made) by the students 140. Some examples of most common issues may be confusion over certain topics, misapplication of certain equations or concepts, errors in specific calculations, etc.

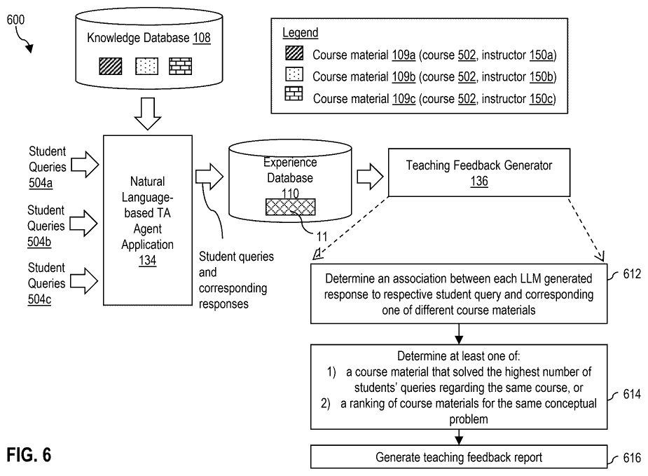

Turning now to FIG. 6, an example method 600 for providing teaching feedback across multiple instructors teaching the same course is described. The method 600 utilizes the student query-response data 111 collected from the natural language-based TA agent 134 to generate teaching feedback or an assessment across multiple instructors 150 teaching the same course 502. For ease of illustrations, FIG. 6 illustrates three instructors 150a, 150b, and 150c. However, the method 600 can be used to provide teaching feedback across any suitable number of instructors (e.g., 2, 3, 4 or more) teaching the same course 502.

As shown in FIG. 6, the natural language-based TA agent 134 receives a plurality of student queries 504a, 504b, and 504c associated with the same course 502. The student queries 504a may be received from students 140 in a class taught by the instructor 150a. The student queries 504b may be received from students 140 in a class taught by the instructor 150b. The student queries 504c may be received from students 140 in a class taught by the instructor 150c. The natural language-based TA agent 134 may respond to the student queries 504a, 504b, and 504c using the methods 200 and 300 discussed above with reference to FIGS. 2 and 3A-3B, respectively. For instance, the natural language-based TA agent 134 may respond to each of the student queries 504a, 504b, or 504c by initiating LLM(s) 112 to generate corresponding responses using the course materials 109 prepared by the respective instructor 150. That is, the natural language-based TA agent 134 may respond to the student queries 504a by initiating LLM(s) 112 to generate corresponding responses using the course materials 109a prepared by the instructor 150a, and so on.

The natural language-based TA agent 134 may also request responses from the instructors 150a, 150b, and/or 150c. For instance, when an LLM generated response to a student query 504a is determined to be unsatisfactory by a respective student 140, the natural language-based TA agent 134 may transmit the student query 504a to the instructor 150a. Similarly, when an LLM generated response to a student query 504b is determined to be unsatisfactory by a respective student 140, the natural language-based TA agent 134 may transmit the student query 504a to the instructor 150b, and so on.

The natural language-based TA agent 134 may also output and store student queries 504 in association with corresponding responses (e.g., including LLM generated responses and/or human instructor generated response) as student query-response data 111 in the experience database 110. In some instances, the natural language-based TA agent 134 may store student queries 504 and corresponding responses associated with different instructors 150 in different sub-databases within the experience database 110. In general, the natural language-based TA agent 134 may organize the student queries 504 and corresponding responses in any suitable arrangement.

The teaching feedback generator 136 may retrieve and process the student query-response data 111 collected in the experience database 110 to generate a teaching report providing an assessment across the different instructors 150 (or more specifically across the different course materials 109 provided by the different instructors 150). For instance, at block 612, the teaching feedback generator 136 determines an association between each LLM generated response (retrieved from the student query-response data 111) to respective student queries 504 and corresponding one of the different course materials 109 (e.g., using ML and/or LLMs). For instance, an LLM generated response to a student query 504a may include wordings and/or information from the course materials 109a because the natural language-based TA agent 134 may have instructed an LLM 112 to generate the response using the course materials 109a based on the student query 504a associated with the instructor 150a.

At block 614, the teaching feedback generator 136 determines, based on the association, a course material 109 that solved the highest number of student queries 504 regarding the same course 502 and/or a ranking of the course materials 109a-c for the same conceptual problem. As an example, the teaching feedback generator 136 may determine that 100 LLM generated responses are based on the course materials 109 a, 200 LLM generated responses are based on the course materials 109b, and 300 LLM generated responses are based on the course materials 109c. Thus, the course materials 109c may have solved the highest number of student queries 504.

As another example, the teaching feedback generator 136 may determine which of the course materials 109 are better or more effective in teaching a certain learning concept. For instance, the teaching feedback generator 136 may compare a number of the LLM generated responses associated with a portion of the course materials 109a (prepared by the instructor 150a) that teaches a particular learning concept to a number of the LLM generated responses associated with a portion of the course materials 109b (prepared by the instructor 150b) that teaches the same particular learning concept. The teaching feedback generator 136 may determine that the course materials 109 associated with the smaller number of LLM generated responses may be more effective in teaching the certain learning concept as less student queries 504 related to that course materials 109 are received. As an example, the teaching feedback generator 136 may determine that the first instructor's 150 answer may be more effective based on fewer students 140 asking questions related to the first course material 109 or that the students 140 give a higher rating to the answers provided by the first instructor 150. As part of comparing the effectiveness of the different course materials 109a and 109b, the teaching feedback generator 136 may further determine a difference in instructional styles (e.g., via textual, visual diagrams, problem-solving examples, etc.) between the portion of the course materials 109a (associated with the particular learning concept) and the portion of the course materials 109b (associated with the particular learning concept). The teaching feedback generator 136 may further determine a difference in content (e.g., the actual learning information) between the portion of the course materials 109a (associated with the particular learning concept) and the portion of the course materials 109b (associated with the particular learning concept). In some instances, for each course, there may be corresponding exercises, quizzes, and information collected by the natural language-based TA agent 134. As such, the teaching feedback generator 136 can collect comprehensive student data by topics or concepts. Thus, the teaching feedback generator 136 may have statistics of the student's 140 overall performance by topics. For instance, if the performance of the students 140 being taught using a certain course material 109 is higher than another course material 109, that certain course material 109 is better (more effective in teaching). Additionally, the student's 140 engagements may be another indicator (e.g., based on the number of queries and feedback collected by the natural language-based TA agent 134). Generally, the teaching feedback generator 136 may use a variety of metrics to determine the effectiveness of course materials 109. The metrics may include, for example, but are not limited to, student's 140 average performance (e.g., quiz scores) by different course materials 109, student's 140 engagement analytics, student conversational information (e.g., the number of questions related to the same topic or concept), and student feedback (or satisfaction indications).

At block 616, the teaching feedback generator generates a teaching report including an indication of the course material 109 that solved the highest number of student queries 504 regarding the same course 502 and/or the ranking of the course materials 109 for the same conceptual problem determined at block 614. In some higher-level education scenarios, the same course 502 (e.g., mathematics) may be taught in different classes offered by different faculties (e.g., an electrical engineering faculty and a general science faculty). For instance, the course materials 109a may be associated with a first faculty, and the course materials 109b may be associated with a second faculty different than the first faculty. Thus, the teaching feedback generator 136 may also provide an assessment of student learning performance and/or teaching performance for the same course 502 across faculties.

As discussed above with reference to FIGS. 3A-3B, student query and corresponding response may be promoted from the experience database 110 to the knowledge database 108 and may subsequently be removed from the experience database 110. To enable teaching feedback generation as discussed above in the methods 500 and 600, promoted student query-response may be marked as promoted in the experience database 110 without deletion from the experience database 110. Alternatively, the ChaTA system 130 may store student query-response data 111 in an additional database without data promotion.

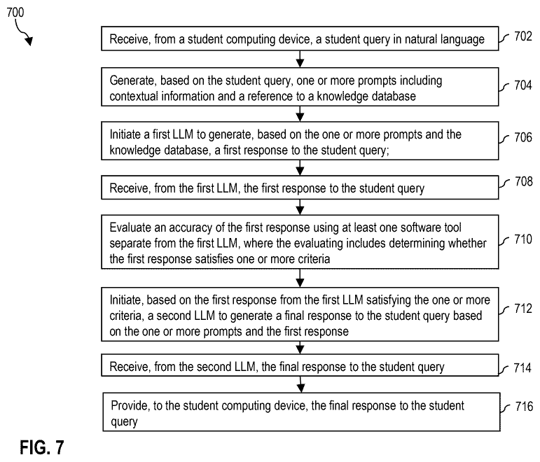

Turning now to FIG. 7, an example method 700 is described. In an embodiment, the method 700 is a method for providing interactive natural language-based, course-specific teaching assistance to students using one or more LLMs with LLM output accuracy evaluation. The method 700 may include similar mechanisms as discussed above with reference to FIGS. 1-2, 3A-3B, and 4A-4B. The method 700 may be implemented by the natural language-based TA agent 134. In embodiments, the method 700 may be implemented using a computer system with components as shown in FIG. 20. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, the natural language-based TA agent 134 receives a student query 504 in natural language from a student computing device 102.

At block 704, the natural language-based TA agent 134 generates, based on the student query 504, one or more prompts. The one or more prompts include contextual information associated with the student query 504 and a reference to a knowledge database 108 comprising course materials 109 for a specific course 502 associated with the student query 504. In an embodiment, the course materials 109 for the specific course 502 in the knowledge database 108 includes at least one of an instructor-led lecture recording, a transcript of an instructor-led lecture recording, instructor-specific notes, a textbook, an instructor-specific document, an instructor-specific presentation, or instructor-specific question-answer pair.

At block 706, the natural language-based TA agent 134 initiates a first LLM 112 to generate, based on the one or more prompts and the knowledge database 108, a first response to the student query 504.

At block 708, the natural language-based TA agent 134 receives, from the first LLM 112, the first response to the student query 504.

At block 710, the natural language-based TA agent 134 evaluates an accuracy of the first response using at least one software tool 114 separate from the first LLM 112. The evaluation includes determining whether the first response satisfies one or more criteria.

At block 712, the natural language-based TA agent 134 initiates, based on the first response from the first LLM satisfying the one or more criteria, a second LLM 112 to generate a final response in natural language based on the one or more prompts and the first response from the first LLM 112. In some examples, the first LLM 112 and the second LLM 112 correspond to the same LLM. In other examples, the first LLM 112 may be different than the second LLM 112.

At block 714, the natural language-based TA agent 134 receives, from the second LLM 112, the final response to the student query 504.

At block 716, the natural language-based TA agent 134 provides, to the student computing device 102, the final response to the student query 504.

In an embodiment, the natural language-based TA agent 134 further applies a filter to the student query 504 to eliminate a question unassociated with a learning concept of the specific course (e.g., prior to generating the one or more prompts at block 704). In some instances, the filtering may eliminate at least one of an irrelevant question or an offensive question. In an embodiment, the natural language-based TA agent 134 further identifies, from the course materials 109 in the knowledge database 108, a plurality of course material pieces relevant to the student query based on a RAG process and selects a subset of the plurality of course material pieces based on a ranking process. In such an embodiment, the first response received from the first LLM 112 at block 708 is further based on the selected subset of the plurality of course material pieces. In an embodiment, the initiating the first LLM 112 to generate the first response to the student query 504 is further based on a determination that a previous response from the first LLM 112 fails to satisfy the one or more criteria and an observation (e.g., errors or inaccuracies, missing information, etc.) made from the previous response based on an evaluation of the previous response (e.g., as discussed above with reference to FIGS. 3A-3B).

In an embodiment, the one or more prompts generated at block 704 further includes a guardrail to limit an output of the first LLM 112 to be within a scope of the specific course 502. The guardrail can be a policy or a set of rules (e.g., “The model should not generate violent content,” “The model should generate responses using only the knowledge database 108,” and/or “The model should not generate responses outside the learning concepts for the course 502”). In an embodiment, the one or more prompts generated at block 704 further includes at least one of an example question-response pair or an output response format, and the final response received at block 714 is generated by the second LLM 112 based on the at least one of the example question-response pair or the output response format.

In an embodiment, the natural language-based TA agent 134 further stores the student query 504 received at block 702 and the corresponding final response received from the second LLM 112 at block 714 in an experience database 110. In an embodiment, the initiating the first LLM 112 to generate the first response to the student query 504 is further based on a determination that there is a lack of an available response to the student query 504 in the experience database 110. In an embodiment, the natural language-based TA agent 134 further generates and publishes a question-answer (QA) list including the student query 504 and the corresponding final response in a dashboard 106.

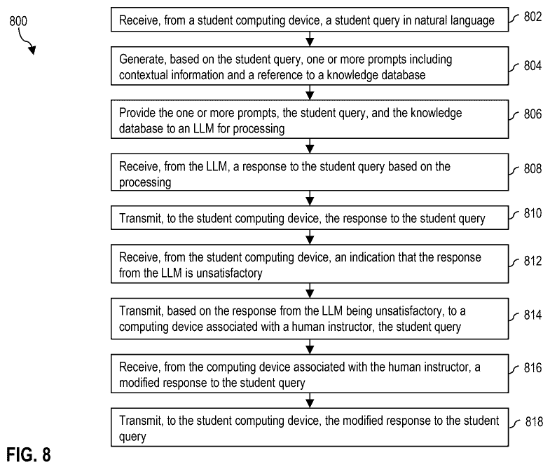

Turning now to FIG. 8, an example method 800 is described. In an embodiment, the method 800 is a method for providing interactive natural language-based, course-specific teaching assistance to students using artificial intelligence with reinforcement learning from human instructor feedback. The method 800 may include similar mechanisms as discussed above with reference to FIGS. 1-2, 3A-3B, 4A-4B, and 7. The method 800 may be implemented by the natural language-based TA agent 134. In embodiments, the method 800 may be implemented using a computer system with components as shown in FIG. 20. As illustrated, FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At block 802, the natural language-based TA agent 134 receives a student query 504 in natural language from a student computing device 102.

At block 804, the natural language-based TA agent 134 generates prompts based on the student query 504. The prompts include contextual information associated with the student query 504 and a reference to a knowledge database 108 including knowledge information associated with a specific course 502.

At block 806, the natural language-based TA agent 134 provides the prompts, the student query 504, and the knowledge database 108 as an input to an LLM 112 for processing.

At block 808, the natural language-based TA agent 134 receives, from the LLM 112, a response to the student query 504 based on the processing.

At block 810, the natural language-based TA agent 134 transmits, to the student computing device 102, the response to the student query 504.

At block 812, the natural language-based TA agent 134 receives, from the student computing device 102, an indication that the response from the LLM 112 is unsatisfactory. In an embodiment, the indication includes the student query 504 directing to the human instructor 150.

At block 814, the natural language-based TA agent 134 transmits, based on the response from the LLM 112 being unsatisfactory, the student query 504 to a computing device 104 associated with a human instructor 150.

At block 816, the natural language-based TA agent 134 receives, from the student computing device 102 associated with the human instructor 150, a modified response to the student query 504.

At block 818, the natural language-based TA agent 134 transmits the modified response to the student computing device 102.

In an embodiment, the natural language-based TA agent 134 further updates one or more parameters of the LLM 112 based on the modified response from the human instructor 150. In an embodiment, the natural language-based TA agent 134 stores the student query 504 and the modified response from the human instructor 150 in an experience database 110 instead of the response from the LLM 112 based on the response from the LLM 112 being unsatisfactory. In an embodiment, the natural language-based TA agent 134 promotes the student query 504 and the modified response from the experience database 110 to the knowledge database 108, where the promoting is based on the modified response being a golden answer received from the human instructor 150. In an embodiment, the natural language-based TA agent 134 further generates and publishes a QA list based at least in part on the student query 504 (received at block 802) and the modified response from the human instructor 150 (received at block 816) in a dashboard 106.

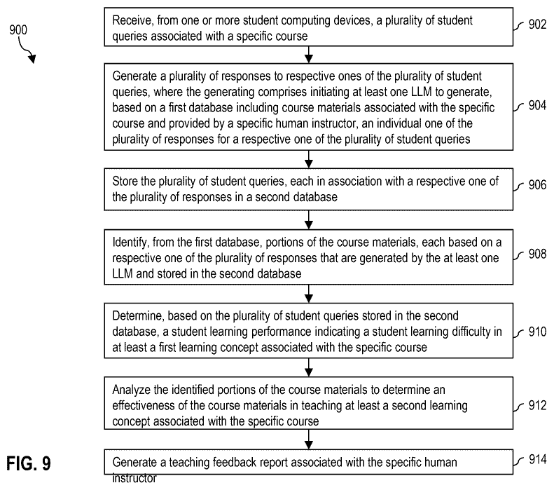

Turning now to FIG. 9, an example method 900 is described. In an embodiment, the method 900 is a method for providing teaching feedback to an individual human instructor. The method 900 may include similar mechanisms as discussed above with reference to FIGS. 1-2, 3A-3B, 4A-4B, 5, and 7-8. The method 900 may be implemented by the natural language-based TA agent 134 and the teaching feedback generator 136. In embodiments, the method 900 may be implemented using a computer system with components as shown in FIG. 20. As illustrated, FIG. 9 includes a number of enumerated operations, but embodiments of the operations in FIG. 9 may include additional operations before, after, and in between the enumerated operations. In some embodiments, one or more of the enumerated operations may be omitted or performed in a different order.

At block 902, the natural language-based TA agent 134 receives, from one or more student computing devices 102, a plurality of student queries 504 associated with a specific course 502. In some instances, the plurality of student queries 504 are associated with an individual student 140. In other instances, the plurality of student queries 504 are associated with a plurality of students 140 (e.g., associated with a certain class).

At block 904, the natural language-based TA agent 134 generates a plurality of responses to respective ones of the plurality of student queries 504. As part of generating the plurality of responses, the natural language-based TA agent 134 initiates at least one LLM 112 to generate, based on a first database (e.g., the knowledge database 108) including course materials 109 associated with the specific course 502 and provided by a specific human instructor 150, an individual one of the plurality of responses for a respective one of the plurality of student queries 504. In an embodiment, the course materials 109 for the specific course 502 in the first database includes at least one of a lecture recording, a transcript of a lecture recording, lecture notes, a textbook, lecture slides, question-answer pairs provided by the specific human instructor 150.

At block 906, the natural language-based TA agent 134 stores the plurality of student queries 504, each in association with a respective one of the plurality of responses in a second database (e.g., the experience database 110).

At block 908, the teaching feedback generator 136 identifies, from the first database, portions of the course materials 109, each based on a respective one of the plurality of responses that are generated by the at least one LLM 112 and stored in the second database. In other words, the teaching feedback generator 136 identifies portions of the course materials 109 that were used by the LLM 112 to generate respective ones of the plurality of responses.

At block 910, the teaching feedback generator 136 determines, based on the plurality of student queries 504 stored in the second database, a student learning performance indicating a student learning difficulty in at least a first learning concept associated with the specific course 502. In an embodiment, as part of determining the student learning performance, the teaching feedback generator 136 classifies the plurality of student queries 504 into a plurality of learning concepts including the first learning concept. The teaching feedback generator 136 further determines the student learning difficulty in the first learning concept based on a number of the plurality of student queries 504 associated with the first learning concept being high (e.g., exceeding a certain threshold). In an embodiment, the determining the student learning difficulty in the first learning concept is further based on the number of the plurality of student queries 504 associated with the first learning concept is greater than a number of the plurality of student queries associated with another learning concept of the plurality of learning concepts. For instance, the number of the plurality of student queries 504 associated with the first learning concept may be the highest among all the learning concepts. In other words, the first learning concept may be the most challenging concept for the student(s). In an embodiment, the plurality of learning concepts are based on learning concept goals for the specific course 502.

At block 912, the teaching feedback generator 136 analyzes the identified portions of the course materials 109 to determine an effectiveness of the course materials 109 in teaching at least a second learning concept associated with the specific course 502. In an embodiment, as part of analyzing the identified portions of the course materials 109 to determine the effectiveness of the course materials 109, the teaching feedback generator 136 may determine an issue associated with the second learning concept based on a number of the identified portions of the course materials 109 associated with the second learning concept being high (e.g., exceeding a certain threshold). In some instances, the second learning concept may be the same as the first learning concept (that is based on the number of student queries at block 910). This may be the case when the most frequently asked questions are all answered by the natural language-based TA agent 134 using the knowledge database 108. That is, the particular concept may be well addressed by the course materials 109. In other instances, the second learning concept may be different than the first learning concept. This may be the case when some of the most frequently asked questions were answered by the human instructor 150 (e.g., because the second concept may not be adequately addressed in the course materials 109 and hence the natural language-based TA agent 134 may have elevated the questions to the human instructor 150).

At block 914, the teaching feedback generator 136 generates a teaching feedback report associated with the specific human instructor 150, where the teaching feedback report includes an indication of the student learning performance and the effectiveness of the course materials 109. Generally, the teaching feedback generator 136 may generate and provide various feedback information, to the human instructor 150. For instance, the feedback information may include course material information (e.g., indicating topics that are not well addressed). Additionally or alternatively, the feedback information may include student's 140 learning performance and engagement. In an example, quizzes and/or exams can be generated based on the course materials 109, the quizzes and/or exams can also be graded based on the course materials 109, and the student's 140 learning performance can be collected based on the student's 140 scores from the quizzes and/or exams. Additionally or alternatively, the feedback information may include indications of learning resources that may be lacking for the students 140, for example, based on the conversation information from the interactions between the students 140 and the human instructor 150 (e.g., collected by the natural language-based TA agent 134 stored in the experience database 110).

In an embodiment, as part of generating the plurality of responses for the respective ones of the plurality of student queries 504 at block 904, the natural language-based TA agent 134 receives student feedback indicating that a response generated by the at least one LLM 112 is unsatisfactory for a first student query 504 of the plurality of student queries 504. The natural language-based TA agent 134 further transmits, to an instructor computing device 104 associated with the specific human instructor 150, the first student query 504 based on the student feedback indicating that the response generated by the at least one LLM 112 for the first student query 504 is unsatisfactory. In response, the natural language-based TA agent 134 receives, from the instructor computing device 104, a human instructor generated response to the first student query 504, where the determining the effectiveness of the course materials 109 at block 912 is further based on the human instructor generated response. In an embodiment, the human instructor generated response is associated with the second learning concept, and as part of determining the effectiveness of the course materials 109, the teaching feedback generator 136 determines that there is a lack of information associated with the second learning concept in the course materials 109 based on a comparison of the human instructor generated response and the course materials 109.

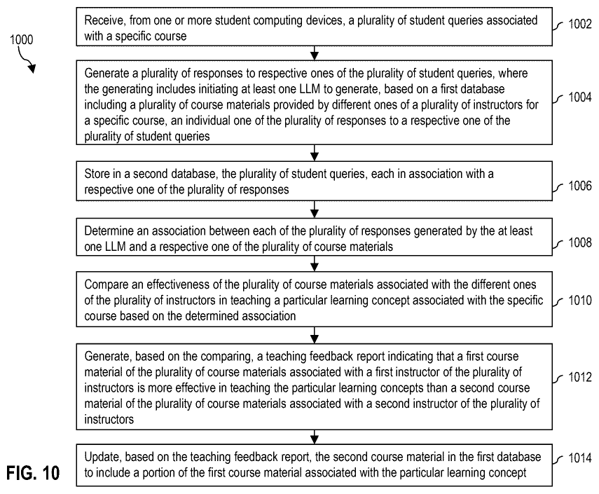

Turning now to FIG. 10, an example method 1000 is described. In an embodiment, the method 1000 is a method for providing teaching feedback across different instructors teaching the same course. The method 1000 may include similar mechanisms as discussed above with reference to FIGS. FIGS. 1, 2, 3A-3B, 4A-4B, and 6-8. The method 1000 may be implemented by the natural language-based TA agent 134 and the teaching feedback generator 136. In embodiments, the method 1000 may be implemented using a computer system with components as shown in FIG. 20. As illustrated, FIG. 10 includes a number of enumerated operations, but embodiments of the operations in FIG. 10 may include additional operations before, after, and in between the enumerated operations. In some embodiments, one or more of the enumerated operations may be omitted or performed in a different order.

At block 1002, the natural language-based TA agent 134 receives, from one or more student computing devices 102, a plurality of student queries 504.

At block 1004, the natural language-based TA agent 134 generates a plurality of responses to respective ones of the plurality of student queries 504. As part of generating the plurality of responses, the natural language-based TA agent 134 initiates at least one LLM 112 to generate, based on a first database (e.g., the knowledge database 108) including a plurality of course materials 109 provided by different ones of a plurality of instructors 150 (e.g., human instructors) for a specific course 502, an individual one of the plurality of responses for a respective one of the plurality of student queries 504. In an embodiment, each of the plurality of course materials 109 for the specific course 502 in the first database includes at least one of a lecture recording, a transcript of a lecture recording, lecture notes, a textbook, lecture slides, question-answer pairs provided by a respective one of the plurality of instructors 150.

At block 1006, the natural language-based TA agent 134 stores the plurality of student queries 504, each in association with a respective one of the plurality of responses in a second database (e.g., the experience database 110).

At block 1008, the teaching feedback generator 136 determines an association between each of the plurality of responses generated by the at least one LLM 112 and a respective one of the plurality of course materials 109.

At block 1010, the teaching feedback generator 136 compares an effectiveness of the plurality of course materials 109 associated with the different ones of the plurality of instructors 150 in teaching a particular learning concept associated with the specific course 502 based on the determined association at block 1008.

At block 1012, the teaching feedback generator 136 generates, based on the comparing at block 1010, a teaching feedback report indicating that a first course material 109 of the plurality of course materials 109 associated with a first instructor 150a of the plurality of instructors 150 is more effective in teaching the particular learning concepts than a second course material 109b of the plurality of course materials 109 associated with a second instructor 150 of the plurality of instructors 150. In an embodiment, the first course material 109 is associated with a different faculty than the second course material 109.

At block 1014, the teaching feedback generator 136 updates, based on the teaching feedback report at block 1012, the second course material 109b in the first database to include a portion of the first material 109a associated with particular learning concept. In some instances, the teaching feedback generator 136 may also delete a portion of the second course material 109a associated with the particular learning concept.

In an embodiment, as part of comparing the effectiveness of the plurality of course materials 109 associated with the different ones of the plurality of instructors 150 at block 1010, the teaching feedback generator 136 compares a number of the plurality of responses that are associated with a portion of the first course material 109 associated with the particular learning concept to a number of the plurality of responses that are associated with a portion of the second course material 109 associated with the particular learning concept. In an embodiment, as part of comparing the effectiveness of the plurality of course materials 109 associated with the different ones of the plurality of instructors 150 at block 1010, the teaching feedback generator 136 determines a difference in instructional styles between a portion of the first course material 109 associated with the particular learning concept and a portion of the second course material 109 associated with the particular learning concept. In an embodiment, as part of comparing the effectiveness of the plurality of course materials 109 associated with the different ones of the plurality of instructors 150 at block 1010, the teaching feedback generator 136 determines a difference in content between a portion of the first course material 109 associated with the particular learning concept and a portion of the second course material 109 associated with the particular learning concept.

In an embodiment, the teaching feedback generator 136 further determines that a third course material 109 of the plurality of course materials 109 associated with a third instructor 150 of the plurality of instructors 150 answered a greatest number of the plurality of student queries 504 among the plurality of course materials 109.

Turning now to FIG. 11, an example method 1100 for generating assessment questions is described. The method 1100 may use the course materials 109 (e.g., provided by the instructor 150) in the knowledge database 108, the student query-response data 111 (e.g., between students 140 and the natural language-based TA agent 134) in the experience database 110, and/or student scores 172 of the students 140 stored in the score database 170 to generate targeted questions for student assessment. As shown in FIG. 11, the natural language-based TA agent 134 receives student queries 1102 associated with a particular course 502 from students 140. For example, the student queries 1102 may include student A queries 1102a from a student A 140, student B queries 1102b from a student B 140, and so on. The natural language-based TA agent 134 may respond to the student queries 1102 using the methods 200 and 300 discussed above with reference to FIGS. 2 and 3A-3B, respectively. For instance, the natural language-based TA agent 134 may respond to the student queries 1102 using LLM(s) 112 and the knowledge database 108 (or more specifically, the course materials 109 associated with the particular course 502). The natural language-based TA agent 134 may also request responses from the specific instructor 150 (e.g., when an LLM generated response is determined to be unsatisfactory by a respective student 140). The natural language-based TA agent 134 may also output and store student queries 1102 in association with corresponding responses (e.g., including LLM generated responses and/or human instructor generated responses) as student query-response data 111 in the experience database 110.

The students 140 may also take exams or assessments (e.g., quizzes, midterm exams, final exams, assignments, projects, reports, etc.) associated with the particular course 502 and may receive scores 172. The scores 172 may be stored in the score database 170. In some instances, the scores 172 may be output by an exam grader 162 as shown. For instance, the exam grader 162 may receive student A answers 1104a from the student A 140 for certain assessments, student B answers 1104b from the student B 140 for certain assessments, and so on, and generate corresponding scores 172 for each of the students 140. As discussed above and further below, the exam grader 162 may grade student-by-student and question-by-question and may store the grades or score 172 for each student 140 in association with corresponding student identification information in the score database 170.

The exam generator 160 may use the course materials 109 (e.g., provided by the instructor 150) in the knowledge database 108, the student query-response data 111 (e.g., between students 140 and the natural language-based TA agent 134) in the experience database 110, and/or student scores 172 of the students 140 stored in the score database 170 to generate targeted questions for student assessment. The assessment can be for a class level assessment (e.g., quizzes, midterm exams, final exams, assignments, projects, reports, etc.) and/or an individual or a personalized student assessment (e.g., exercises, quizzes, etc.) for self-learning. A class level assessment may be initiated by the instructor 150 (e.g., a professor or a TA) of the particular course 502. A personalized student assessment may generally be initiated by an individual student 140. However, in some instances, a personalized student assessment may also be initiated by the instructor 150, for example, assigning a specific assessment task to an individual student 140.

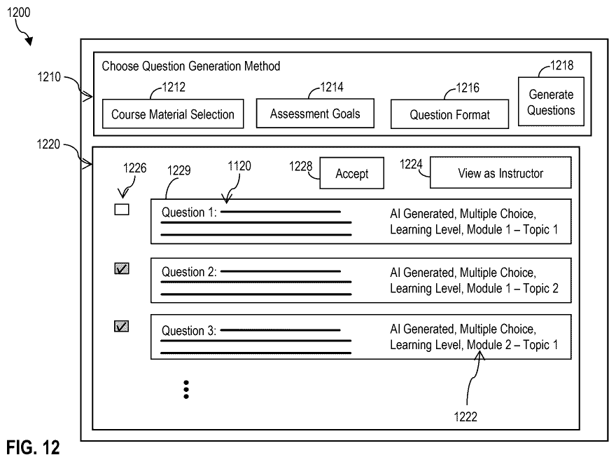

In an embodiment, for class level assessment, the exam generator 160 may receive an instructor request 1112 from an instructor 150 of a particular course 502 to generate questions 1120 for students 140 taking the particular course 502. The instructor request 1112 may be received from a user device (e.g., the instructor computing device 104) of the instructor 150. The instructor request 1112 may include an indication of one or more core learning concepts and an assessment goal. The indication of the one or more core learning concepts may be in the form of topics, sub-topics, chapters, sub-chapters, sections, sub-sections, modules, and/or sub-modules in the course material 109 for the particular course 502, or generally one or more portions of the course material 109 for the particular course 502. The assessment goal may indicate whether questions are to be generated for formative assessment or summative assessment. Formative assessments may be used for monitoring student progress while the course 502 is ongoing. For instance, the instructor 150 may use the exam generator 160 to generate quizzes at the end of certain topics, certain chapters, certain sub-chapters or sections, weekly tests, weekly assignments, minor projects, etc. Summative assessments may be used for evaluating student performance at the end of the course 502. For instance, the instructor 150 may use the exam generator 160 to generate questions 1120 for midterm exams, final exams, major projects, etc. In some instances, the exam generator 160 may receive the instructor request 1112 via a UI (e.g., the UI 1200 shown in FIG. 12).

Upon receiving the instructor request 1112, the exam generator 160 may generate one or more prompts including the course material 109 for the particular course 502, the core learning concepts, and the assessment goal. In some instances, the one or more prompts may also include a question format (e.g., multiple-choice, true or false, free response, word problem-solving, numerical problem-solving, coding, scenario-based, etc.). For instance, the question format may be received from the instructor 150 as part of the instructor request 1112. Alternatively, the question format may be automatically determined by the exam generator 160 based on the knowledge domain of the particular course 502 or the core learning concepts. As an example, if the course material 109 for the particular course 502 is related to computer science, the exam generator 160 may determine that coding questions 1120 are to be generated. As another example, if the course material 109 for the particular course 502 is related to mathematics or physics, the exam generator 160 may determine that numerical problem-solving questions 1120 are to be generated. As another example, if the course material 109 for the particular course 502 is related to humanity, the exam generator 160 may determine that essay questions 1120 are to be generated. In some instances, the one or more prompts may also include information about the students 140 who will be receiving and answering the questions 1120. This information may include information about the students'140 learning levels, such as beginner, intermediate, or advanced.

After generating the one or more prompts, the exam generator 160 may initiate one or more LLMs 112 to generate questions 1120 for the students 140 based on the one or more prompts. The exam generator 160 may receive the one or more questions from the one or more LLMs 112. The exam generator 160 may provide the generated questions 1120 for instructor verification 1130. For instance, the exam generator 160 may output the generated questions 1120 to the user device of the instructor 150. In an example, the exam generator 160 may display the generated questions 1120 via the UI. The instructor 150 may check or verify whether each of the generation questions 1120 is accurate in terms of content and/or phrasing or style. The instructor 150 may accept, reject, or edit each of the generated questions 1120 via the UI. If the instructor 150 accepts a generated question 1120 (e.g., indicating that the question 1120 is verified), the exam generator 160 may add the instructor-verified questions 1120 to the exam library 174 (stored as instructor-verified questions 176).

After the instructor 150 generated and verified a set of questions 1120 for a particular assessment or exam, the instructor 150 may request the exam generator 160 to publish the set of questions 1120. In response to the publish request, the exam generator 160 may provide the questions 1120 to the students 140. For example, when the student 140 requests to take the assessment or exam, the exam generator 160 may transmit the set of questions 1120 to the user device (e.g., the student computing device 102) of the student 140.

In an embodiment, for personalized student assessment, the exam generator 160 may receive a student request 1114 from an individual student 140 (e.g., student A 140) of a particular course 502. The student request 1114 may be received from a user device (e.g., the student computing device 102) of the student 140. Upon receiving the student request 1114, the exam generator 160 may retrieve, from the knowledge database 108, course material 109 associated with the particular course 502. The exam generator 160 may also retrieve, from the experience database 110, student query-response data 111 between the student 140 and the natural language-based TA agent 134. The exam generator 160 may also retrieve, from the score database 170, student scores 172 of the student 140 associated with assessment corresponding to the particular course 502. The student query-response data 111 and the student scores 172 of the student 140 may be retrieved from the respective experience database 110 and the score database 170 based on identification information (e.g., a student name, a student identification number, a student login identifier, etc.) associated with the individual student 140. In some instances, a student profile may be created for each student 140 in the ChaTA system 130, and the student profile may include student identification information and references or links to student-query response data 111 and/or student scores 172 corresponding to the respective student 140.

The retrieved student query-response data 111 may be indicative of certain topics, concepts, or portions (e.g., chapters, sub-chapters, sections, modules, sub-modules, etc.) of the particular course 502 that the student 140 may have difficulty in learning. Similarly, the retrieved student scores 172 may be indicative of the understanding and performance of the student 140 on certain topics, concepts, or portions of the particular course 502. Thus, the exam generator 160 may identify at least one particular knowledge concept in the course material 109 associated with a learning difficulty (e.g., a learning gap) of the student 140 based on the course material 109, the student query-response data 111 of the student 140, and the student scores 172 of the student 140.

Next, the exam generator 160 may generate one or more prompts including the course material 109 for the particular course 502 and the identified at least one knowledge concept. In some instances, the one or more prompts can also include a question format. For example, the question format can be multiple-choice, true or false, free response (e.g., essay or writing assessment), word problem-solving, numerical problem-solving, coding, scenario-based (e.g., adaptive to a student learning level), etc. In some instances, the question format may be received as part of the student request 1114 from the student 140. In some instances, the question format can be generated automatically by the exam generator 160 based on the course material 109 and/or the identified knowledge concept as discussed above.

Next, the exam generator 160 may initiate one or more LLMs 112 to generate questions 1120 for the student 140 based on the one or more prompts. The exam generator 160 may receive the questions 1120 from the one or more LLMs 112. If the one or more prompts include the question format, the questions 1120 may be in the format specified by the one or more prompts. Generally, the questions 1120 may be multiple-choice questions 1120, true or false questions 1120, short answer questions 1120, essay questions 1120, word problem-solving questions 1120, numerical problem-solving questions 1120, coding questions 1120, etc. The exam generator 160 may output the generated questions 1120 to the user device of the student 140.

In some cases, the questions 1120 may be generated based on the learning level or the skill of the student 140 (e.g., using gamification mechanisms). For instance, the instructor 150 may provide a set of criteria to gate the learning progress or pace of a student 140. The set of criteria may specify a list of learning levels (e.g., related to certain topics or a certain depth of a particular topic) and a corresponding expected performance (e.g., in terms of scores, such as above 100% accuracy) for each learning level before the student 140 can advance to the next learning level. In some instances, the learning levels may be beginner, intermediate, or advanced. In some instances, the learning levels may be level 1, level 2, level 3, level 4, etc. Generally, the learning levels may be in any suitable granularities. Accordingly, in some instances, the exam generator 160 may further determine that one or more of the student scores 172 of the student 140 satisfies the expected student performance for a first learning level, and the one or more prompts may further include an indication of a second learning level more advanced than a first learning level based on the student 140 satisfying the expected student performance for the first learning level. By including information about the student's learning level in the one or more prompts, the exam generator 160 can deliver personalized and targeted assessments corresponding to the student's 140 skills.

In some embodiments, as part of generating questions 1120 for class level assessment or personalized student assessment, the one or more LLMs 112 may also generate answers 1122 corresponding to the questions 1120. In one example, the exam generator 160 may output the corresponding answers 1122 to the exam grader 162. In this way, after a student 140 has taken the assessment including the questions 1120, the exam grader 162 may grade the answers provided by the student 140 based on the generated answers 1122. In some examples, for the personalized student assessment, the exam generator 160 may output the corresponding answers 1122 to the user device of the student 140 requesting the questions 1120 for review (e.g., after the student 140 has completed answering the questions 1120). In some examples, the generated answers 1122 may also be provided to the instructor 150 as part of the instructor verification 1130 and the verified answers may also be stored in the exam library 174 (shown by the verified answers 178). The verified answers 178 may be stored in association with corresponding verified questions 176.

In an embodiment, the one or more LLMs 112 used for generating the questions 1120 may include a multimodal LLM such as OpenAI® GPT-4, GPT-5, or higher versions, Google® Gemini, Claude, or any open-source LLMs such as LLaMA 3, Mistral, etc. In some instances, the exam generator 160 can select a particular LLM 112 from multiple different LLMs 112 based on the knowledge domain of the course material 109 and/or the question format. In some instances, the exam generator 160 may use the one or more LLMs 112 in conjunction with RAG-based techniques, RLHF-based techniques, and/or SFT techniques to generate the questions 1120. In some instances, identification of a knowledge concept associated with a learning difficulty of a student 140 (e.g., for a personalized student assessment) discussed above may also be based on LLM processing. In some instances, the same LLM(s) 112 may be used for identifying a knowledge concept associated with a student 140 learning difficulty and generating questions 1120. In other instances, different LLMs 112 may be used for identifying a knowledge concept associated with a student 140 learning difficulty and generating questions 1120.

Generally, the one or more LLMs 112 may include any suitable LLM capable of processing natural language or multimodal inputs. The one or more LLMs 112 may not be limited to LLMs provided by any specific provider, having any specific architecture, or trained using any specific training methodology. In some embodiments, the exam generator 160 may include various modules, such as an LLM orchestration module, a concept identification module, a post-generation validation module, and/or a confidence scoring module. For example, the LLM orchestration module may be configured to interface with and manage multiple LLMs 112. The LLM orchestration module may select an LLM based on one or more criteria, including but not limited to: (i) the knowledge domain associated with the course material, (ii) the expected question format, (iii) the complexity or Bloom-level of the intended question, (iv) computational efficiency, or (v) historical performance of the LLM for similar content. The exam generator 160 may also employ RAG techniques, RLHF techniques, and/or SFT techniques to improve alignment between generated questions and the underlying course concepts. These techniques may be applied to the LLMs 112 used for question generation, concept identification, or both.

In some embodiments, identification of the knowledge concept associated with a student's 140 learning difficulty is performed by the concept identification module that uses one or more LLMs 112 to analyze student conversation data, historical question-response pairs (e.g., the student query-response data 111), and assessment scores 172. The same LLM 112 may be used for both concept identification and question generation, or different LLMs 112 may be applied depending on the nature of the task. For example, a smaller or faster LLM 112 may be used for concept identification, while a more capable multimodal LLM 112 may be used for question generation.

In some embodiments, the exam generator 160 may initiate multiple LLMs 112 in parallel or in sequence to generate candidate exam questions 1120. The post-generation validation module may perform quality checks on the candidate questions 1120, such as verifying alignment with retrieved course content, detecting hallucinations, checking internal consistency, ensuring that questions correspond to the identified knowledge concept, and/or validating answer correctness using a secondary verification model. The confidence scoring module may evaluate each candidate question 1120 using one or more scoring metrics, which may include semantic similarity to authoritative reference content, question clarity, expected difficulty level, or compliance with instructor-defined constraints. The exam generator 160 may then select the question 1120 associated with the highest confidence score. The LLMs 112 invoked by the orchestration module may differ in their architectures, training data sources, optimization methods, or domain-specific adaptations (e.g., fine-tuning on engineering education datasets). In some embodiments, the exam generator 160 may dynamically adjust which LLMs 112 are used over time based on performance feedback (e.g., instructor feedback 1116 and/or student feedback 1118), thereby improving the accuracy and reliability of the generated exam questions.

In some embodiments, the exam generator 160 may receive instructor feedback 1116 from an instructor 150. For instance, the instructor feedback 1116 may be related to the style or phrasing of the generated questions 1120 and/or the content of the generated questions 1120. The instructor feedback 1116 may be provided to the one or more LLMs 112 for training the one or more LLMs 112 and future questions generation. In an example, the exam generator 160 may output a generated question 1120 and a corresponding answer 1122 via the UI, and the instructor 150 may provide the instructor feedback 1116 by editing the generated question 1120 and/or the answer 1122. In some embodiments, the exam generator 160 may also receive student feedback 1118 from and interact with students 140 regarding the generated questions 1120. For instance, a student 140 may provide an answer to a question 1120 generated by the exam generator 160, receive a grade or a score 172 for the answer (e.g., from the exam grader 162), and may be unsatisfied with the score 172. Thus, the student 140 may submit a complaint to the instructor 150, for example, via the natural language-based TA agent 134. The instructor 150 may evaluate the student complaint. If the student complaint is unreasonable, no action will be taken. If, however, the student complaint is reasonable (e.g., due to the content and/or style of the question 1120), the student complaint may be provided as student feedback 1118 to the exam generator 160 for training the one or more LLMs 112.

In some embodiments, the exam generator 160 may also coordinate with a recommendation engine 164 to recommend learning materials for a particular student 140. For instance, after the exam generator 160 identifies a knowledge concept in the course material 109 that the student 140 may have difficulty in learning (e.g., using mechanisms as discussed above), the exam generator 160 may initiate the recommendation engine 164 to recommend learning materials from the course material 109 for the student 140. In an example, the recommendation engine 164 may be a ML model (e.g., a decision tree branching-based models, an XGBoost model, a neural network, etc.). The exam generator 160 may receive the recommended learning material from the recommendation engine 164. The recommended learning material may be in the form of text, audio, and/or video extracted from the course material 109 in the knowledge database 108. The exam generator 160 may output the recommended learning material to the user device of the student 140.

In some instances, the recommendation engine 164 may generate the recommended learning material further based on a learning pattern or preference of the student 140. For instance, if the student 140 frequently selects video format learning materials over a text or audio format learning materials from the course material 109, the recommendation engine 164 may recommend learning materials that are in video format to the student 140. By providing adaptive content delivery according to the student's 140 learning pattern or preference, the student 140 may learn more effectively (e.g., saving time and making faster progress). In some instances, the student 140 may provide feedback about the recommended learning material to the recommendation engine 164, e.g., whether the recommended learning material was helpful or effective, and the recommendation engine 164 may be trained based on the feedback.

In an embodiment, the LLM 112 may be trained by providing the course material 109 as input to the LLM 112 and reference exam questions generated by the instructor 150 based on the corresponding course material 109 as the ground truth. As part of the training, the parameters (e.g., weights) of the LLM 112 may be updated based on an error measure between the output of the LLM 112 (e.g., the LLM generated questions 1120) and the reference exam questions. In some instances, the error measure may be based on a multi-dimensional evaluation of an LLM generated question 1120. The multi-dimensional evaluation may include evaluating the quality (e.g., the effectiveness in eliciting an insightful or relevant answer), the alignment to the learning concepts and/or assessment goal (provided in the prompts), and interpretability of the generated question 1120. In some instances, a gradient descent algorithm may be used to update the parameters of the LLM 112 to minimize the error. The training may go through multiple iterations of parameter adjustment and error measures until the error between the LLM 112 output and the reference exam questions satisfies a certain threshold. In some instances, the LLM 112 may also be trained for generating answers for corresponding questions in a substantially similar way. Similar to training the LLM 112 for question generation, the LLM 112 may receive the course material 109 as input. However, the ground truth or reference for calculating the LLM 112 output error may include reference question-answer pairs provided by the professor, knowledge, and/or a competency list. Generally, the LLMs 112 used for question and/or answer generation and/or the ML model used for recommending learning material may be trained using similar mechanisms discussed above and may be combined with RLHF techniques (e.g., training a reward model to score different outputs of an LLM 112 based on human rankings and optimizing the LLM 112 to maximize its score from the reward model).

The exam grader 162 may interact with the exam generator 160, the knowledge database 108, the experience database 110, and/or the score database 170. In an embodiment, the exam grader 162 generates one or more rubrics 1140 for one or more questions 1120. In order to generate the one or more rubrics 1140, the exam grader 162 may receive one or more reference answers 1122 to a corresponding question 1120. The reference answers 1122 may be received from the exam generator 160 or an instructor 150. In an embodiment, the exam grader 162 generates one or more prompts based on the one or more reference answers 1122 and the corresponding question(s) 1120. After generating the one or more prompts, the exam grader 162 may initiate one or more LLMs 112 to generate a rubric 1140 based on the one or more prompts. The exam grader 162 may receive the rubric 1140 from the one or more LLMs 112.

The rubric 1140 may include predefined scoring points generated by the one or more LLMs 112 based on the reference answers 1122. The rubric 1140 may include one or more evaluation criteria generated by the one or more LLMs 112 based on analyzing the individual question 1120 and a corresponding reference answer 1122. The one or more LLMs 112 may assign a scoring point for each of the one or more evaluation criteria.

The one or more LLMs 112 may generate the rubric 1140 based on chain of thought reasoning performed by the one or more LLMs 112. An instructor 150 may specify a type of evaluation being performed. The one or more LLMs 112 may perform chain of thought reasoning based on this categorization, generating the chain of thought and a tentative answer. The chain of thought may then be converted into a rubric 1140 by the one or more LLMs 112, reflecting how students 140 should learn to think through problems. The one or more LLMs 112 may assign points to each rubric element or evaluation objectives based on the difficulty of that particular aspect of the chain of thought.

In some embodiments, a plurality of LLMs 112 may be used to generate a plurality of rubrics 1140 for each question 1120 for consideration and selection. The exam grader 162 may initiate multiple LLMs 112 in parallel or in sequence to generate the rubrics 1140. The exam grader 162 may also receive a plurality of confidence scores associated with respective ones of the plurality of rubrics 1140. The confidence scores may indicate how certain each LLM 112 was about the rubric 1140 generated. The confidence score may be used by the exam grader 162 to select one of the plurality of rubrics 1140. The confidence score may allow an instructor 150 to identify rubrics 1140 that require closer review. For instance, if confidence scores for all generated rubrics 1140 are below a certain threshold, the exam grader 162 may flag that the rubrics require more detailed instructor review. In some embodiments, the exam generator 162 may dynamically adjust which LLMs 112 are used over time based on performance feedback (e.g., instructor feedback and/or student feedback), thereby improving the accuracy and reliability of the evaluation outputs.

Alternatively or concurrently with the multi-LLM rubric generation approach described above, the exam grader 162 may implement a specialized multi-role LLM architecture wherein different LLMs 112 are tasked with evaluating different aspects of a generated rubric and are assigned specific adversarial or adjudicative roles within the rubric validation process. This role-based architecture provides technical advantages in rubric quality, comprehensiveness, fairness, computational efficiency, and alignment with educational objectives.

In this embodiment, the exam grader 162 may generate one or more candidate rubrics for a question 1120 using one or more LLMs 112 as described above. The exam grader 162 may then assign at least a first LLM 112 to function as an advocate for the generated rubric, at least a second LLM 112 to function as a critic of the generated rubric, and at least a third LLM 112 to function as a judge or jury that evaluates the arguments presented by the advocate and critic LLMs regarding the rubric's quality, completeness, and appropriateness. This adversarial rubric validation framework provides multiple technical benefits by systematically identifying both strengths and potential weaknesses in automatically-generated rubrics before they are presented to instructors 150 or applied to evaluate student answers 1104.

The advocate LLM 112 prompted to identify positive aspects of the generated rubric, such as comprehensive coverage of learning objectives, appropriate allocation of points reflecting question difficulty, clear and unambiguous evaluation criteria, alignment with course materials 109 from the knowledge database 108, logical breakdown of complex problems into evaluable components, and/or consistency with established grading standards for the particular course 502. The advocate LLM 112 may generate an output comprising identified strengths and a recommendation that the rubric is suitable for use (potentially with minor refinements).

The critic LLM 112 may be prompted to identify potential weaknesses, gaps, or issues in the generated rubric, such as missing evaluation objectives that should be assessed based on the question 1120 and reference answer 1122, inappropriate point allocation (e.g., awarding too many points to trivial elements or too few points to challenging elements), ambiguous criteria that could lead to inconsistent grading, rubric elements that are too strict or too lenient relative to the course level and assessment type (formative vs. summative), potential bias or unfairness in evaluation criteria, misalignment with course learning objectives, and/or rubric complexity that may make application difficult or time-consuming. The critic LLM 112 may generate an output comprising identified weaknesses.

The judge LLM 112 may receive the outputs from both the advocate and critic LLMs 112, along with the original generated rubric, question 1120, reference answer 1122, and relevant course materials 109. The judge LLM 112 may synthesize a final assessment that weighs the competing perspectives, determines whether the identified weaknesses are substantive or minor, and generates either: (1) an approval of the rubric with high confidence, (2) a modified rubric that addresses the critic's concerns while preserving the advocate's identified strengths, or (3) a recommendation that the rubric requires significant revision or regeneration. The judge LLM 112 may also generate a confidence score indicating certainty in its assessment.

This adversarial rubric validation architecture may provide improved rubric quality compared to single-LLM generation approaches by systematically surfacing potential issues before rubrics are applied to student work. The advocate role ensures that well-designed aspects of automatically-generated rubrics are recognized and preserved. The critic role ensures that gaps, ambiguities, and potential fairness issues are identified proactively rather than being discovered only after inconsistent grading occurs across student submissions. The judge role provides balanced synthesis that determines whether identified issues require correction.

Furthermore, the exam grader 162 may assign different LLMs 112 to evaluate different aspects or dimensions of the generated rubric. For example, in the context of validating a rubric for a complex engineering problem, a first LLM 112 may be assigned to evaluate whether the rubric appropriately assesses conceptual understanding of underlying principles, a second LLM 112 may be assigned to evaluate whether the rubric appropriately assesses procedural execution and mathematical calculations, a third LLM 112 may be assigned to evaluate whether the rubric appropriately assesses final answer correctness, a fourth LLM 112 may be assigned to evaluate whether the point allocation reflects appropriate weighting between process and outcome (particularly important for formative vs. summative assessment), and a fifth LLM 112 may be assigned to evaluate whether the rubric criteria are clearly written and unambiguous.

Each aspect-specific LLM 112 may generate an evaluation output for its assigned aspect of the rubric, identifying strengths and potential improvements. These aspect-specific evaluation outputs may be aggregated by a coordinating judge LLM 112 or by the exam grader 162 to produce a comprehensive rubric validation output that addresses all relevant dimensions of rubric quality.

This aspect-based distribution of rubric validation tasks provides several technical advantages. First, it enables the exam grader 162 to apply specialized evaluation criteria appropriate to each dimension of rubric quality. Different aspects of rubric quality require different evaluation approaches—assessing conceptual coverage requires domain knowledge and alignment with learning objectives, while assessing clarity and unambiguity requires linguistic analysis and attention to potential multiple interpretations. By assigning different LLMs 112 with appropriate prompting and context to evaluate different aspects, the exam grader 162 ensures comprehensive rubric validation.

Second, aspect-based validation enables parallel processing of different rubric dimensions, reducing total validation time. Rather than requiring a single LLM 112 to sequentially evaluate all aspects of a rubric, multiple LLMs 112 can simultaneously evaluate different aspects in parallel. For a course 502 requiring generation of rubrics for 50 exam questions, parallel aspect-based validation can reduce total rubric generation and validation time.

Third, aspect-based validation enables the exam grader 162 to generate detailed, structured feedback for instructors 150 regarding rubric quality. This structured feedback enables instructors 150 to quickly focus on rubric aspects that require attention while having confidence in other aspects.

The exam grader 162 may leverage locally-run open source small language models (SLMs) for certain rubric validation tasks, while reserving API-based calls to larger, more computationally expensive cloud-hosted LLMs for higher-level judgment tasks. This hybrid local-remote processing architecture provides improvements in computational efficiency, network efficiency, cost efficiency, and system scalability compared to architectures that rely exclusively on cloud-based LLM APIs.

In an embodiment, some of the LLMs 112 tasked with assessing specific aspects of rubric quality may comprise locally-run open source specially trained small language models executing on local computing resources of the ChaTA system 130. For example, a small language model may be fine-tuned on a corpus of high-quality rubrics from the experience database 110 to evaluate whether a generated rubric contains clear, unambiguous language, appropriate formatting, and logical structure. Another local SLM may be fine-tuned on course materials 109 to evaluate whether rubric evaluation objectives align with stated course learning objectives and topics covered in lectures. These locally-run SLMs can rapidly process generated rubrics to identify structural issues, clarity problems, and alignment gaps without requiring network transmission of data or API calls to external services.

The advocate and critic roles in rubric validation may be performed by these locally-run SLMs, which generate detailed analyses identifying rubric strengths and potential weaknesses. The final judgment or synthesis task may be performed by a larger, more sophisticated LLM 112 accessed via API calls to cloud-based services (e.g., GPT-4, Gemini, or Claude accessed via their respective APIs). This architectural approach concentrates the computationally expensive cloud-based LLM processing on the highest-value task—synthesizing competing perspectives and determining whether the rubric is suitable for use—while offloading routine structural checking, clarity analysis, and alignment verification tasks to efficient local SLMs.

This hybrid architecture provides a number of technical benefits including computation efficiency via the use of locally-run SLMs, network efficiency by minimizing network data transmission through processing a majority of evaluation asks locally, and/or latency reduction via the use of locally-run SLMs (e.g., processing within milliseconds to seconds via locally run SLMs as compared to tens of seconds or more via cloud-based LLMs depending on network conditions and API service load).

The exam grader 162 may select which rubric to use from among a plurality of generated rubrics, or how to synthesize an optimal rubric from multiple candidates, based on what aspect each LLM 112 was evaluating and the assigned role of the particular LLM 112 (e.g., advocate, critic, judge, or aspect-specific validator). For example, when multiple rubrics are generated by different LLMs 112 for the same question 1120, each rubric may be evaluated by advocate-critic-judge trios. The exam grader 162 may select the rubric that receives the highest judge confidence score, or alternatively, may synthesize a combined rubric that incorporates the best elements identified by advocates across multiple candidate rubrics while avoiding the weaknesses identified by critics.

The one or more criteria used to select one of the plurality of rubrics may be based on what aspect each LLM 112 was evaluating and the role of the particular LLM 112. For instance, if an advocate LLM 112 (e.g., a locally-run SLM) identifies that a first generated rubric has good clarity and structure, while a critic LLM 112 (e.g., a locally-run SLM) identifies that the same rubric has inappropriate point allocation (such as too many points for simple elements), and separately an advocate LLM 112 identifies that a second generated rubric has appropriate point allocation but awkward phrasing, the judge LLM 112 (e.g., a cloud-based API) may synthesize these analyses and generate a hybrid rubric that combines the clear structure and appropriate point allocation from both candidates. The exam grader 162 may select this judge-synthesized rubric as the final rubric based on the criterion that judge-role outputs represent optimal synthesis of competing rubric candidates.

In some embodiments, the confidence scores received from different LLMs 112 regarding rubric quality may be weighted based on the role assigned to each LLM 112 and the aspect being evaluated. For example, confidence scores from judge-role LLMs 112 may be weighted more heavily than confidence scores from advocate-role or critic-role LLMs 112 when determining which rubric to select. Similarly, confidence scores from aspect-specific LLMs 112 may be weighted based on the pedagogical importance of each aspect (e.g., an LLM 112 evaluating alignment with learning objectives may have its confidence score weighted more heavily than an LLM 112 evaluating formatting consistency, as alignment is more pedagogically critical than formatting).

The exam grader 162 may implement a multi-stage rubric validation workflow that progressively applies more sophisticated (and computationally expensive) validation as rubric quality uncertainty increases. In a first stage, local SLMs perform rapid initial validation checking for obvious structural issues, missing elements, or clarity problems. If local SLMs identify significant issues or express low confidence (e.g., confidence below 70%), the exam grader 162 may escalate the rubric to a second validation stage involving cloud-based LLM API calls for more sophisticated analysis. If cloud-based LLM validation also expresses uncertainty or identifies unresolvable issues, the exam grader 162 may flag the rubric for mandatory human instructor review. This progressive validation workflow helps to optimize resource utilization by applying expensive cloud-based processing only when necessary, while enabling rapid approval of high-quality rubrics that pass local SLM validation.

The exam grader 162 may generate different kinds of rubrics 1140 depending upon the assessment type (e.g., homework assignments, projects, exams, etc.), the type of evaluation (e.g., formative or summative), and/or what is being evaluated (e.g., factual knowledge, procedural items, conceptual items, or comprehensive diagnostic ability). The exam grader 162 may evaluate whether the assessment tests factual knowledge, procedural execution, conceptual understanding, or the ability to diagnose situations (planning ability from an engineering perspective). Based on this evaluation, the exam grader 162 may generate rubrics 1140 with evaluation objectives and scoring points appropriate for the particular type of assessment. The exam grader 162 may enable configurable weighting between process evaluation and outcome evaluation. For example, a rubric 1140 may place a heavier weighting on a final answer as opposed to the process steps, or conversely, emphasize the process steps over the final answer based on instructor preference for a given evaluation.

The exam grader 162 may provide the rubric 1140 for instructor verification 1130. For instance, the exam grader 162 may output the rubric 1140 to the user device of the instructor 150. In an example, the exam grader 162 may display the rubric 1140 via the UI. The instructor 150 may check or verify whether the rubric 1140 is accurate and fair. The instructor 150 may accept, reject, or edit the rubric 1140 (e.g., the evaluation criteria and/or the assigned scoring points) via a UI such as the UI 1600 shown in FIG. 16A. If the instructor 150 accepts the rubric 1140 (e.g., indicating that the rubric 11140 is verified), the exam grader 162 may use the rubric 1140 for grading. The exam grader 162 may also store the rubric 1140 such as in exam library 174.

As discussed above, the exam generator 160 may transmit one or more questions 1120 associated with a particular course 502 to a user device 102 associated with a student 140. The exam grader 162 may receive, from the user device 102 of the student 140, a data object comprising one or more answers 1104 (e.g., text answers, etc.) corresponding to the one or more questions 1120. In embodiments where student answers 1104 are handwritten, the exam grader 162 applies OCR processing to the data object to obtain the one or more text answers. This OCR capability converts handwritten information into machine-readable text before processing by the LLMs 112. For instance, a student 140 may take a photograph of a handwritten exam or lab report and submit the photograph as the data object, and the exam grader 162 may automatically extract text from the photograph using OCR processing.

The exam grader 162 may generate one or more prompts comprising the one or more questions 1120 and the corresponding one or more answers 1104 and the rubric(s) 1140. In an embodiment, the exam grader 162 initiates a plurality of LLMs 112 to independently evaluate the one or more answers 1104 based on the rubric 1140. The plurality of LLMs 112 may each generate an evaluation output 1150 based on the one or more prompts. The plurality of LLMs 112 may comprise different LLM models including, but not limited to, a multimodal LLM such as OpenAI® GPT-4, GPT-5 or higher versions, Google® Gemini, OpenAI, Claude, or any open-source LLMs such as LLaMA 3, Mistral, etc. The plurality of LLMs 112 may comprise different model architectures, or the plurality of LLMs 112 may be tuned based on different input data, different reference data, or different error evaluation metrics. This diversity in LLM architecture and training enables the system to leverage different strengths of different LLMs 112.

Different LLMs 112 often excel at different tasks. For example, certain LLMs 112 such as ChatGPT may perform well for general evaluations, while Claude (from Anthropic) and similar models may perform better for coding exams. The exam grader 162 may select particular LLMs 112 based on the particular subject matter of the course and/or the particular subject matter of the question 1120. For instance, for computer science courses identified as programming-heavy classes based on course catalog descriptions, the exam grader 162 may select LLMs 112 particularly suited for evaluating code. The exam grader 162 may determine the subject matter of the course based on information in the knowledge database 108 (e.g., course catalog descriptions, course materials 109, etc.).

In an embodiment, the one or more LLMs 112 used for evaluating the student answers 1104 and generating the evaluation output(s) 1150 may include a multimodal LLM such as OpenAI® GPT-4, GPT-5 or higher versions, Google® Gemini, OpenAI, Claude, or any open-source LLMs such as LLaMA 3, Mistral, etc. In some instances, the exam grader 162 can select a particular LLM 112 from multiple different LLMs 112 based on the knowledge domain of the course material 109 and/or the question 1120. In some instances, the exam grader 162 may use the one or more LLMs 112 in conjunction with RAG-based techniques, RLHF-based techniques, and/or SFT techniques to generate the evaluation outputs 1150. In some instances, generation of the rubric(s) 1140 discussed above may also be based on LLM processing. In some instances, the same LLM(s) 112 may be used for generating the rubric(s) 1140 and generating the evaluation output(s) 1150. In other instances, different LLMs 112 may be used for generating the rubric(s) 1140 and generating the evaluation output(s) 1150.

In an embodiment, the exam grader 162 receives a plurality of evaluation outputs 1150 for an individual question 1120 from the plurality of LLMs 112. Each evaluation output 1150 may comprise one or more of the individual question 1120, the student answer 1104, the correct answer, the correct solution, the evaluation objectives and corresponding scoring points, the awarded scoring points for each object, contextual comments, and/or other information. The exam grader 162 may also receive a plurality of confidence scores associated with respective ones of the plurality of evaluation outputs for the individual question 1120. The confidence scores indicate how certain each LLM 112 was about the grade it assigned. The confidence score may be used by the exam grader 162 to select one of the plurality of evaluations. For instance, the exam grader 162 may select a particular evaluation output 1150 of the plurality of evaluation outputs from an LLM 112 of the plurality of the LLMs 112 for the individual question 1120 based on one or more criteria. The one or more criteria used for selecting the particular evaluation output 1150 from among the plurality of evaluation outputs for the individual question 1120 may comprise the confidence scores discussed above.

The confidence score may allow an instructor 150 to identify evaluations that require closer review. For instance, when a confidence score for a particular evaluation output 1150 is below a certain threshold (e.g., 70%, 75%, 80%, etc.), the exam grader 162 may flag that evaluation output 1150 for instructor review via a UI such as the UI 1650 shown in FIG. 16B. The exam grader 162 may receive, from the user device 104 associated with the instructor 150, for example via a UI such as the UI 1650 shown in FIG. 16B, feedback associated with the evaluation output 1150. The exam grader 162 may then initiate training of the one or more LLMs 112 based on the feedback, enabling continuous improvement of the exam grader 162.

In embodiments, the evaluation outputs from multiple LLMs 112 (e.g., at least two LLMs 112) are provided to another LLM 112 to consolidate the results and determine which evaluation should be selected. The consolidating LLM 112 may analyze the outputs and provide an explanation of the selection.

Alternatively or concurrently with the multi-LLM independent evaluation approach described above, the exam grader 162 may implement a specialized multi-role LLM architecture wherein different LLMs 112 are tasked with evaluating different aspects of the student answer 1104 and are assigned specific adversarial or adjudicative roles within the evaluation process. This role-based architecture provides technical advantages in computational efficiency, evaluation accuracy, and system scalability.

In this embodiment, the exam grader 162 may assign at least a first LLM 112 to function as an advocate for the student answer 1104, at least a second LLM 112 to function as a critic of the student answer 1104, and at least a third LLM 112 to function as a judge or jury that evaluates the arguments presented by the advocate and critic LLMs. This adversarial evaluation framework mimics legal proceedings and provides multiple technical benefits. The advocate LLM 112 may be prompted to identify positive aspects, correct elements, and partial credit opportunities within the student answer 1104, while the critic LLM 112 may be prompted to identify errors, omissions, conceptual misunderstandings, and deviations from the reference answer 1122 or rubric requirements. The judge LLM 112 receives the outputs from both the advocate and critic LLMs 112 and synthesizes a final evaluation output that weighs the competing perspectives.

This adversarial architecture provides improved evaluation accuracy compared to single-LLM approaches by systematically surfacing both strengths and weaknesses in student work through dedicated analysis pathways. The advocate role ensures that students 140 receive appropriate credit for correct portions of their work even when other portions contain errors, which is particularly valuable for formative assessment. The critic role ensures that errors and misconceptions are identified and addressed in feedback. The judge role provides balanced synthesis that avoids the extremes of overly lenient or overly harsh grading.

Furthermore, the exam grader 162 may assign different LLMs 112 to evaluate different aspects or dimensions of the student answer 1104. For example, in the context of evaluating a lab report, a first LLM 112 may be assigned to evaluate the methodology section, a second LLM 112 may be assigned to evaluate the results and data analysis section, a third LLM 112 may be assigned to evaluate the discussion and conclusions section, and a fourth LLM 112 may be assigned to evaluate the overall structure, formatting, and writing quality. Each aspect-specific LLM 112 may generate an evaluation output for its assigned aspect, and these aspect-specific evaluation outputs may be aggregated by a coordinating LLM 112 or by the exam grader 162 to produce a comprehensive evaluation output for the entire student answer 1104.

This aspect-based distribution of evaluation tasks provides several technical advantages. First, it enables the exam grader 162 to select LLMs 112 that are particularly well-suited for specific evaluation aspects. For example, an LLM 112 that excels at evaluating code (such as Claude) may be assigned to evaluate programming assignments, while an LLM 112 that excels at evaluating written explanations (such as GPT-4) may be assigned to evaluate conceptual explanation questions. Second, it enables parallel processing of different aspects of the student answer 1104, reducing total evaluation time. Rather than requiring a single LLM 112 to sequentially evaluate all aspects of a complex student submission, multiple LLMs 112 can simultaneously evaluate different aspects in parallel, significantly reducing latency, particularly for large classes with hundreds of student submissions.

The exam grader 162 may leverage locally-run open source small language models (SLMs) for certain evaluation tasks, while reserving API-based calls to larger, more computationally expensive cloud-hosted LLMs for higher-level judgment tasks. This hybrid local-remote processing architecture provides improvements in computational efficiency, network efficiency, cost efficiency, and system scalability compared to architectures that rely exclusively on cloud-based LLM APIs.

In an embodiment, some of the LLMs 112 tasked with assessing specific knowledge domains, factual correctness, or procedural compliance may comprise locally-run open source specially trained small language models executing on local computing resources of the ChaTA system 130. For example, a small language model (e.g., a model with millions or low billions of parameters rather than hundreds of billions of parameters) may be fine-tuned on course-specific materials 109 from the knowledge database 108 to evaluate whether student answers 1104 contain specific required elements, correct terminology, appropriate equations, or proper procedural steps. These locally-run SLMs can rapidly process student answers 1104 to identify factual correctness, extract key elements, and generate preliminary assessments without requiring network transmission of data or API calls to external services.

The advocate and critic roles may be performed by these locally-run SLMs, which generate detailed analyses identifying strengths and weaknesses in student answers 1104. The final judgment or synthesis task may be performed by a larger, more sophisticated LLM 112 accessed via API calls to cloud-based services (e.g., GPT-4, Gemini, or Claude accessed via their respective APIs). This architectural approach concentrates the computationally expensive cloud-based LLM processing on the highest-value task—synthesizing competing perspectives into a final evaluation—while offloading routine element-checking and analysis tasks to efficient local SLMs. This hybrid architecture provides a number of technical benefits including computation efficiency via the use of locally-run SLMs, network efficiency by minimizing network data transmission through processing a majority of evaluation asks locally, latency reduction via the use of locally-run SLMs (e.g., processing within milliseconds to seconds via locally run SLMs as compared to tens of seconds or more via cloud-based LLMs depending on network conditions and API service load), and/or enhancing privacy and security by processing the student answers 1104 locally using SLMs and transmitting anonymized or condensed outputs to the cloud-based APIs.

The hybrid architecture provides robustness by enabling the exam grader 162 to continue processing student answers 1104 using local SLMs even if cloud-based APIs are temporarily unavailable. The exam grader 162 may queue final judgment tasks for processing when API connectivity is restored, while providing instructors 150 with preliminary advocate and critic analyses in the interim.

The exam grader 162 may select which evaluation outputs to use, or how to weight different evaluation outputs, based on what aspect each LLM 112 was evaluating and the assigned role of the particular LLM 112 (e.g., advocate, critic, judge, or aspect-specific evaluator). For example, when synthesizing a final evaluation output, the exam grader 162 may weigh the judge LLM's 112 output most heavily, while using the advocate and critic outputs to generate detailed comments and feedback. Alternatively, the exam grader 162 may weight aspect-specific evaluation outputs according to the importance assigned to each aspect in the rubric (e.g., if methodology is worth 40% of the total score and discussion is worth 30%, the outputs from the methodology-evaluating LLM 112 and discussion-evaluating LLM 112 may be weighted 40% and 30% respectively in the final score calculation).

The one or more criteria used to select one of the plurality of evaluation outputs may be based on what aspect each LLM 112 was evaluating and the role of the particular LLM 112. For instance, if the advocate LLM 112 (e.g., a locally-run SLM) identifies that a student answer 1104 contains all required elements and awards full points, while the critic LLM 112 (e.g., a locally-run SLM) identifies that the reasoning is flawed and awards zero points, the judge LLM 112 (e.g., a cloud-based API) may synthesize these competing analyses and award partial credit with a detailed comment explaining that the student included required elements but needs to improve reasoning. The exam grader 162 may select this judge LLM output as the final evaluation output based on the criterion that judge-role outputs take precedence over advocate-role and critic-role outputs.

In some embodiments, the confidence scores received from different LLMs 112 may be weighted based on the role assigned to each LLM 112. For example, confidence scores from judge-role LLMs 112 may be weighted more heavily than confidence scores from advocate-role or critic-role LLMs 112 when determining which evaluation output to select. Similarly, confidence scores from aspect-specific LLMs 112 may be weighted based on the complexity of the aspect being evaluated—an LLM 112 evaluating a straightforward factual element may have its confidence score weighted differently than an LLM 112 evaluating a complex conceptual argument.

The exam grader 162 may dynamically determine the optimal distribution of evaluation tasks among local SLMs and cloud-based LLMs based on system load, available computational resources, network conditions, and/or API constraints. For example, during periods of low system load and low API constraints, the exam grader 162 may utilize cloud-based LLMs for more evaluation tasks. During periods of high system load, high API constraints, or network connectivity issues, the exam grader 162 may shift more evaluation tasks to local SLMs. This dynamic load balancing and resource allocation helps to optimize system performance and cost-effectiveness.

The exam grader 162 may output the particular evaluation output 1150 selected to the user device 102 of the student 140. For instance, the exam grader 162 may provide the evaluating output 1150 to the student 140 via a UI such as the UI 1650 shown in FIG. 16B. In an embodiment, the particular evaluation output 1150 is not provided to the user device 102 of the student 140 until it has been reviewed and approved by the instructor 150, maintaining instructor oversight and grading responsibility. The exam grader 162 may provide the evaluating output 1150 to the instructor 150 via a UI such as the UI 1650 shown in FIG. 16B for approval before providing the evaluation output 1150 to the student 140.

In an embodiment, the exam grader 162 generates contextual comments associated with and included in the evaluation outputs 1150. For example, the exam grader 162 may generate a comment associated with the particular evaluation output 1150 based on at least one of course material 109 associated with the individual question 1120, the individual question 1120, and/or a corresponding one of the one or more answers 1104. The comments may be automatically generated by the one or more LLMs 112. The comments may comprise specific feedback tied to particular portions or sections of the student's 140 work. The comments may be contextual to the individual student's 140 specific mistakes, explaining what the student 140 did wrong and how many points were lost. This contextual commenting performed by the exam grader 162 helps enable students 140 to understand their errors and improve. The comments may be embedded within a copy of the student's 140 answer or report.

The exam grader 162 enables dynamic rubric updates and batch re-evaluation. The exam grader 162 may maintain the evaluation outputs (including the contextual comments if any) 1150 in association with the corresponding student answers 1104 in the score database 170, preserving the computational state and enabling subsequent reprocessing. The score database 170 may maintain associations between student identification information, questions 1120, answers 1104, rubrics 1140, and/or evaluation outputs 1150. This persistent state enables efficient retrieval and reprocessing operations without data loss or degradation.

In an embodiment, the exam grader 162 subsequently receives, from the user device 104 of the instructor 150, a modification to the rubric 1140. For instance, the instructor 150 may discover during review that something is wrong with the rubric 1140 based on patterns observed across multiple student evaluations or the instructor 150 may receive a complaint from a student 140. For example, if the instructor 150 reviews the plurality of evaluation outputs 1150 and notices that many students 140 received low scores on a particular rubric item, the instructor 150 may determine that the rubric item was unclear or incorrectly specified. The modification to the rubric 1140 received from the instructor 150 may comprise: (1) a modification to at least one of the evaluation objectives or one of the scoring points, (2) a deletion of at least one of the evaluation objectives or a corresponding one of the scoring points, and/or (3) an addition of one or more additional evaluation objectives or additional scoring points.

Upon receiving the rubric modification, the exam grader 162 may automatically initiate a batch re-evaluation process. For example, the exam grader 162 may initiate the one or more LLMs 112 to re-evaluate each of the plurality of student answers 1104 based on the modified rubric 1140. This re-evaluation leverages the system's maintained data structures and processing pipelines to efficiently reprocess the entire batch of student answers 1104 without re-input or re-formatting of data, thereby promoting computational efficiency.

The exam grader 162 may receive, from the one or more LLMs 112, a plurality of second evaluation outputs for the plurality of student answers 1104 based on the modified rubric 1140. The exam grader 162 may then transmit, to the user device 104 of the instructor 150, the plurality of student answers 1104 and corresponding ones of the plurality of second evaluation outputs 1150 for instructor review. If the instructor 150, for example via a UI such as the UI 1650 shown in FIG. 16B, approves the second evaluation outputs 1150, the exam grader 162 may then publish the plurality of second evaluation outputs for the plurality of students 140 and store them in the score database 170.

In some embodiments, the exam grader 162 evaluates unstructured documents such as lab reports or project reports. The exam grader 162 may receive, from a user device 102 associated with a student 140, a report for a particular assignment associated with a particular course 502. The exam grader 162 may generate one or more prompts comprising the report, a rubric 1140, and a reference report. The reference report may comprise an example of a good report rather than a rigid template. The reference report serves as an exemplar showing what the instructor 150 is looking for. The rubric 1140 may indicate how closely the student report must match the structure of the reference report versus the content of the report.

The exam grader 162 may initiate one or more LLMs 112 to evaluate the report based on the rubric 1140 and the reference report. In some embodiments, the exam grader 162 initiates a plurality of LLMs 112 to evaluate the report based on the rubric 1140 and the reference report and selects one of a plurality of evaluation outputs based on one or more criteria (e.g., confidence scores) as discussed above. The exam grader 162, via the one or more LLMs 112, may intelligently interpret the report structure and match content to rubric requirements, eliminating the need for manual section identification. The exam grader 162 may receive, from the one or more LLMs 112, an evaluation output 1150 for the report. The evaluation output 1150 may comprise: (1) a plurality of scoring points, each for a corresponding one of the evaluation objectives and based on a corresponding one of the scoring points, and/or (2) a copy of the report with at least one comment associated with one of the evaluation objectives and embedded in a corresponding portion of the copy of the report.

A first content of the received report may be organized differently than a second content of the reference report. The exam grader 162 can handle this situation. For example, one of the evaluation objectives in the rubric may comprise evaluation of a first content of the received report based on a second content of the reference report. This flexibility enables the system to evaluate content regardless of its organizational structure.

The exam grader 162 may output, to a user device 104 associated with an instructor 150, the report and the evaluation output 1150 of the report. The exam grader 162 may receive, from the user device 104 associated with the instructor 150, for example via a UI such as the UI 1650 shown in FIG. 16B, feedback associated with at least one of the comment or one of the plurality of scoring points in the evaluation output 1150. The exam grader 162 may then initiate training of the one or more LLMs 112 based on the feedback, enabling continuous improvement of the exam grader 162.

The exam grader 162 may include multiple levels of verification to ensure grading accuracy and appropriateness. For example, the exam grader 162 may check whether there is consistency in grading among students 140 in the particular course 502 (e.g., regardless of instructor 150) and whether the comments from the one or more LLMs 112 are related to course material 109 in the knowledge database 108 associated with the particular course 502. Additionally, the exam grader 162 may implement a verification process that maintains instructor authority while leveraging AI capabilities. For instance, evaluation outputs 1150 may not be displayed to students 140 until they have been reviewed and approved by the instructor 150 such as via the UI 1650 shown in FIG. 16B.

The exam grader 162 may provide multiple different reports to the instructor 150 via a UI to support instructional decision-making. For example, reports may be generated per student 140 to track individual performance across all assessments, per exam to identify which questions 1120 students 140 had difficulty with, and/or per topic to track performance on the same conceptual material across multiple assessments. The exam grader 162 may provide student performance distribution reports to the instructor 150 via the UI to show overall class performance. The exam grader 162 may provide student participation analytics to the instructor 150 via the UI to show engagement with course materials and discussion boards. The exam grader 162 may provide performance by chapter or concept reports to the instructor 150 via the UI to illustrate which conceptual areas require additional instruction. This comprehensive analytics capability provided by the exam grader 162 enables instructors 150 to identify weaknesses for their students 140 and adjust their teaching accordingly. For instance, if the performance by chapter report indicates that many students 140 struggled with a particular concept, the instructor 150 may determine to spend additional class time reviewing that concept.

The exam grader 162 may integrate with the knowledge database 108. The exam grader 162 may include course material 109 (e.g., lectures, transcripts, instructor notes, textbooks, instructor presentations, instructor question-answer pairs, etc.) in the prompts provided to the one or more LLMs 112 for the generation of rubrics 1140 and evaluation of student assessments or work. When generating rubrics and evaluating student assessments or work, the one or more LLMs 112 may utilize course materials 109 including lecture recordings, transcripts of lecture recordings, instructor-specific notes, textbooks, instructor-specific documents, instructor-specific presentations, and instructor-specific question-answer pairs stored in the knowledge database 108. This integration ensures that evaluation is aligned with the specific course materials 109 and teaching approach of the instructor 150 for the particular course 502.

In an embodiment, the exam grader 162 incorporates mechanisms for continuous improvement through instructor and student feedback. For example, the exam grader 162 may receive, from the user device 104 associated with an instructor 150 of the particular course 502, feedback associated with evaluation outputs 1150. The exam grader 162 may then initiate training of the LLMs 112 based on this feedback. The feedback may relate to the style or phrasing of generated rubrics 1140, the appropriateness of assigned scores, and/or the clarity of generated comments. Student complaints about grades can also provide feedback for system refinement. When students 140 believe a question 1120 was confusing or inappropriately graded, the instructor 150 may evaluate the complaint. Reasonable complaints can be fed back to the exam grader 162 for training the LLMs 112. Reasonable complaints may also cause updating of the rubric 1140 and reassessment of the answer(s) 1104 by the exam grader 162. The iterative refinement process, applied across a plurality of different courses 502 and course sections, enables continuous enhancements of grading accuracy and appropriateness.

Turning now to FIG. 12, an example UI 1200 associated with assessment question generation is described. In an embodiment, the UI 1200 may be rendered by the instructor client application 152 and communicate with the exam generator 160 (e.g., via APIs). For instance, the instructor 150 may execute the instructor client application 152 on the instructor computing device 104 and may communicate with the exam generator 160 using the UI 1200.

As shown in FIG. 12, the UI 1200 may include a top panel 1210 and a bottom panel 1220. The top panel 1210 may accept various inputs for an instructor 150 to choose an exam generation method. The inputs may include a course material selection 1212 input, assessment goals 1214 input, a question format 1216 input, and a generate questions 1218 input. The course material selection 1212 input may include selections for a particular course 502 (e.g., Mechanical Engineering 603—Theory of Elasticity—Fall 2025), one or more chapters, one or more modules, etc. in the course material 109 for the particular course 502. The assessment goals 1214 input may include selections for a quiz, a midterm exam, a final exam, an assignment, projects, a report, etc. The question format 1216 input may include selections for multiple-choice, true or false, free response (e.g., essay or writing assessment), word problem-solving, numerical problem-solving, coding, scenario-based, etc. Generally, each of the course material selection 1212 input, the assessment goals 1214 input, and the question format 1216 input can be in the form of a selection list and/or an input edit box. In some instances, for scenario-based question format, the instructor 150 may also provide a set of criteria including a list of learning levels (e.g., related to certain topics or a certain depth of a particular topic) and a corresponding expected performance (e.g., in terms of scores, such as above 100% accuracy) for each learning level before a student 140 can advance to the next learning level.

The generate questions 1218 input may be clicked after the instructor 150 has made selections for and/or edited the course material selection 1212 input, the assessment goals 1214 input, and the question format 1216 input. In some examples, the question format 1216 can be optional. In an example, a click on the generate questions 1218 may send a request (e.g., the instructor request 1112) to the exam generator 160, and the exam generator 160 may generate prompts based on the selections and/or content of the course material selection 1212 input, the assessment goals 1214 input, and/or the question format 1216 input.

The bottom panel 1220 may output a list of questions 1120 generated by the exam generator 160 based on the course material selection 1212 input, the assessment goals 1214 input, and/or the question format 1216 input. The exam generator 160 may generate the questions 1120 as discussed above with reference to FIGS. 1 and 11. The bottom panel 1220 may also list miscellaneous information 1222 for each question 1120. The miscellaneous information 1222 may include an indication of whether the respective question 1120 is AI generated (e.g., generated by the exam generator 160 using the LLMs 112), the format of the respective question 1120, a learning level of the respective question 1120, and the module, concept, or the portion of the course material 109 associated with the respective question 1120.

The bottom panel 1220 may also indicate whether the bottom panel 1220 is for viewing by an instructor 150 or a student 140 (e.g., shown by the indicator 1224). In the illustrated example of FIG. 12, the UI 1200 is viewed by an instructor 150. In an example, the UI 1200 may indicate whether the viewing is an instructor 150 or a student 140 based on the login information used for accessing the UI 1200. The bottom panel 1220 may also include checkboxes 1226 where the instructor 150 may select corresponding questions 1120 for assessment. For instance, the instructor 150 may review and verify the accuracy of the generated questions 1120 and may determine whether to accept the questions 1120. The instructor 150 may click the checkbox 1226 next to a question 1120 to select the question 1120 (e.g., shown by the checkmark) for acceptance and click the accept 1228 input. That is, a checked box 1226 that is unchecked may indicate that the corresponding question 1120 is rejected by the instructor 150. The instructor 150 may edit one or more of the questions 1120 before accepting the questions 1120. For instance, each question 1120 is included in an edit box 1229 that can accept edits from the instructor 150.

The UI 1200 may also be used by a student 140 to generate questions 1120 (e.g., exercises, quizzes, etc.) for self-learning or review. For instance, the UI 1200 may be rendered by the student client application 142 and communicate with the exam generator 160 (e.g., via APIs). For instance, the student 140 may execute the student client application 142 on the student computing device 102 and may communicate with the exam generator 160 using the UI 1200. In an example, when the login information used for accessing the UI 1200 indicates the respective user is a student 140, the indicator 1224 may show “View as student”. Further, the assessment goals 1214 input may include selection(s) for exercises or quizzes but may not include selection(s) for midterm exam, final exam, assignment, project, or report that are only for class-level assessment. Further, the UI 1200 may not allow the questions 1120 to be edited and may exclude the accept 1228 input. In some instances, the UI 1200 can include an interface for the student 140 to enter feedback, such as like, dislike, difficult level, etc.

FIG. 12 is merely an example of components of a UI 1200, and variations are contemplated to be within the scope of the present disclosure. In embodiments, the UI 1200 may include other components not illustrated in FIG. 12. In embodiments, the UI 1200 may not include every component illustrated in FIG. 12. In embodiments, the components of the UI 1200 may be arranged differently than those illustrated in FIG. 12. Such and other embodiments are contemplated to be within the scope of the present disclosure.

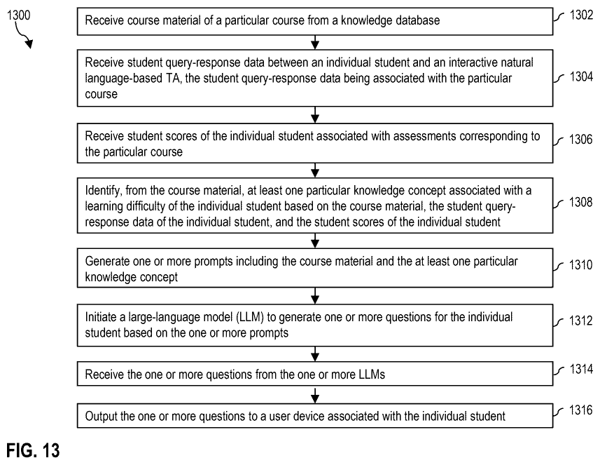

Turning now to FIG. 13, an example method 1300 for providing personalized adaptive assessment question generation is described. The method 1300 may include similar mechanisms as discussed above with reference to FIGS. 1, 11, and 12. The method 1300 may be implemented by the exam generator 160. In embodiments, the method 1300 may be implemented using a computer system with components as shown in FIG. 20. As illustrated, FIG. 13 includes a number of enumerated operations, but embodiments of the operations in FIG. 13 may include additional operations before, after, and in between the enumerated operations. In some embodiments, one or more of the enumerated operations may be omitted or performed in a different order.

At block 1302, the exam generator 160 receives course material 109 for a particular course 502 from a knowledge database 108. At block 1304, the exam generator 160 receives student query-response data 111 between an individual student 140 (a particular student 140) and an interactive natural language-based TA 134. The student query-response data 111 is associated with the particular course 502. In some instances, the student query-response data 111 may be received from the experience database 110 based on identification information (e.g., a student name, a student identification number, a student login identifier, etc.) associated with the individual student 140. At block 1306, the exam generator 160 receives student scores 172 of the individual student 140 associated with assessments corresponding to the particular course 502. In some instances, the student scores 172 of the student 140 are received from the score database 170 based on identification information (e.g., a student name, a student identification number, a student login identifier, etc.) associated with the individual student 140. In an embodiment, the assessments associated with the student scores 172 of the individual student 140 include at least one of a quiz, a midterm exam, a final exam, an assignment, or a project associated with the course material 109. In an embodiment, at least one of the student scores 172 of the individual student 140 is based on an output of an AI-based exam grader (e.g., exam grader 162), where the output is based on a corresponding one of the assessments. For instance, the student 140 may have taken an exam and the AI-based exam grader may have graded the student's 140 exam.

At block 1308, the exam generator 160 identifies, from the course material 109, at least one particular knowledge concept associated with a learning difficulty of the individual student 140 based on the course material 109, the student query-response data 111 of the individual student 140, and the student scores 172 of the individual student 140. At block 1310, the exam generator 160 generates one or more prompts including the course material 109 and the at least one particular knowledge concept. In an embodiment, the one or prompts are generated responsive to a request from the user device associated with the individual student 140 (e.g., via a UI similar to the UI 1200).

At block 1312, the exam generator 160 initiates one or more LLMs 112 to generate one or more questions 1120 for the individual student 140 based on the one or more prompts. At block 1314, the exam generator 160 receives the one or more questions 1120 from the one or more LLMs 112. At block 1316, the exam generator 160 outputs the one or more questions 1120 to a user device (e.g., the student computing device 102) associated with the individual student 140.

In an embodiment, the exam generator 160 further receives, from a user device (e.g., the instructor computing device 104) associated with an instructor 150 of the particular course 502, an expected student performance for a first learning level associated with the course material 109. The exam generator 160 further determines that one or more of the student scores 172 of the individual student 140 satisfies the expected student performance for the first learning level. In such an embodiment, the one or more prompts generated at block 1310 further includes an indication of a second learning level more advanced than the first learning level based on the one or more of the student scores 172 of the individual student 140 satisfying the expected student performance for the first learning level. By including information about the student's 140 learning level (e.g., the second learning level) in the one or more prompts, the exam generator 160 can deliver personalized and targeted assessments corresponding to the individual student's 140 skills.

In an embodiment, the exam generator 160 receives, from the one or more LLMs 112, one or more answers 1122 corresponding to the one or more questions 1120. The exam generator 160 further outputs the one or more questions 1120 and the corresponding one or more answers 1122 to an AI-based exam grader (e.g., exam grader 162). In this way, the AI-based exam grader can grade the one or more questions 1120 based on the corresponding one or more answers 1122.

In an embodiment, the exam generator 160 further initiates, based on the identified learning difficulty of the individual student 140, one or more ML models (e.g., the recommendation engine 164) to identify recommended learning material for the individual student 140 from the course material 109 in the knowledge database 110. The exam generator 160 further receives the recommended learning material for the individual student 140 from the one or more ML models. The exam generator 160 further outputs the recommended learning material to the user device associated with the individual student 140. For instance, the student 140 may study the recommended learning material before taking a further quiz (e.g., the one or more questions 1120 provided to the student at block 1316). In other instances, the recommendation engine 164 may generate recommended learning material for the student 140 after the student has taken an assessment and the recommended learning material may be generated based on the outcome or result of the assessment. In some instances, the recommendation engine 164 may generate the recommended learning material further based on a learning pattern or preference of the individual student 140.

In an embodiment, the exam generator 160 further receives, from the user device associated with the individual student 140, feedback (e.g., the student feedback 1114) about the one or more questions 1120. The exam generator 160 further initiates training of the one or more LLMs 112 based on the feedback (e.g., using mechanisms as discussed above with reference to FIG. 11).

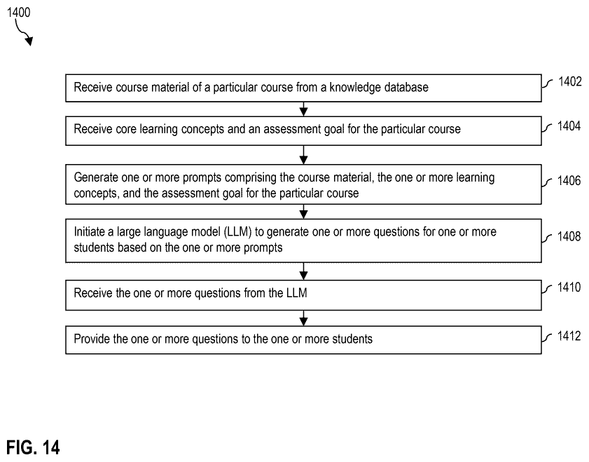

Turning now to FIG. 14, an example method 1400 for providing course-specific class level assessment question generation is described. The method 1400 may include similar mechanisms as discussed above with reference to FIGS. 1 and 11-13. The method 1400 may be implemented by an exam generator 160. In embodiments, the method 1400 may be implemented using a computer system with components as shown in FIG. 20. As illustrated, FIG. 14 includes a number of enumerated operations, but embodiments of the operations in FIG. 14 may include additional operations before, after, and in between the enumerated operations. In some embodiments, one or more of the enumerated operations may be omitted or performed in a different order.

At block 1402, the exam generator 160 receives course material 109 for a particular course 502 from a knowledge database 110. At block 1404, the exam generator 160 receives, from a user device (e.g., the instructor computing device 104) associated with an instructor 150 of the particular course 502, one or more learning concepts and an assessment goal for the particular course 502. In an embodiment, the assessment goal in the one or more prompts includes an indication of an exam category associated with a quiz, a midterm exam, a final exam, an assignment, or a project.

At block 1406, the exam generator 160 generates one or more prompts including the course material 109, the one or more learning concepts, and the assessment goal for the particular course 502. In an embodiment, the one or prompts are generated responsive to a request (e.g., the instructor request 1112) from the user device associated with the instructor 150 of the particular course 502. In an embodiment, the one or more prompts further include a question format for the one or more questions 1120. The question format may indicate multiple-choice, true or false, free response (e.g., essay or writing assessment), word problem-solving, numerical problem-solving, coding, scenario-based (e.g., adaptive to a student learning level), etc. In some instances, the question format may be received as part of the request from the instructor 150. In other instances, the question format can be generated automatically by the exam generator 160 based on the knowledge domain (e.g., science, humanity, engineering, medical, law, etc.) of the course material 109 and/or the identified knowledge concept. In an embodiment, the one or more prompts further include a learning level (e.g., advanced, intermediate, or beginner, etc.) of the one or more students 140. In an example, the learning level may be received as part of the request from the instructor 150.

At block 1408, the exam generator 160 initiates an LLM 112 to generate one or more questions 1120 for one or more students 140 based on the one or more prompts. At block 1410, the exam generator 160 receives the one or more questions 1120 from the LLM 112. At block 1412, the exam generator 160 provides the one or more questions 1120 to the one or more students 140.

In an embodiment, the exam generator 160 receives feedback (e.g., the instructor feedback 1116 and/or the student feedback 1118) about the one or more questions 1120 from at least one of the user device associated with the instructor 150 of the particular course 502 or a user device (e.g., the student computing device 102) associated with a student 140 of the particular course 502. The exam generator 160 further trains the one or more LLMs 112 based on the feedback from the at least one of the user device associated with the instructor 150 or the user device associated with the student 140 (e.g., using mechanisms as discussed above with reference to FIG. 11).

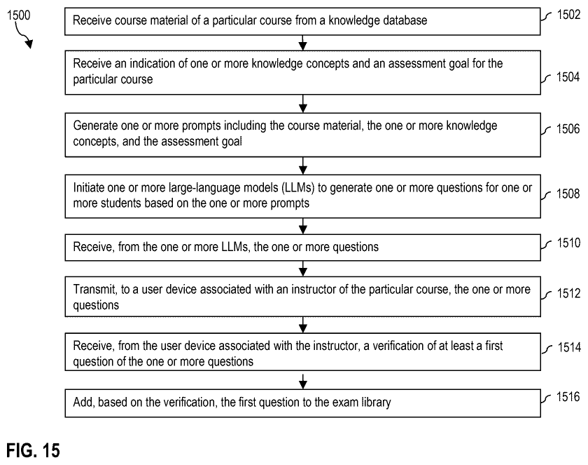

Turning now to FIG. 15, an example method 1500 for providing assessment question generation with dynamic exam library augmentation is described. The method 1500 may include similar mechanisms as discussed above with reference to FIGS. 1 and 11-14. The method 1500 may be implemented by an exam generator 160. In embodiments, the method 1500 may be implemented using a computer system with components as shown in FIG. 20. As illustrated, FIG. 15 includes a number of enumerated operations, but embodiments of the operations in FIG. 15 may include additional operations before, after, and in between the enumerated operations. In some embodiments, one or more of the enumerated operations may be omitted or performed in a different order.

At block 1502, the exam generator 160 receives course material 109 for a particular course 502 from a knowledge database 110. At block 1504, the exam generator 160 receive an indication of one or more knowledge concepts (e.g., topics, sub-topics, chapters, sub-chapters, sections, modules, etc.) and an assessment goal (e.g., quizzes, assignments, projects, reports, midterm exams, final exams, etc.) for particular course 502. At block 1506, the exam generator 160 generates one or more prompts including the course material 109, the one or more knowledge concepts, and the assessment goal. At block 1508, the exam generator 160 initiates one or more LLMs 112 to generate one or more questions 1120 for one or more students based on the one or more prompts. At block 1510, the exam generator 160 receives, from the one or more LLMs 112, the one or more questions 1120.

At block 1512, the exam generator 160 transmits, to a user device (e.g., the instructor computing device 104) associated with an instructor 150 of the particular course 501, the one or more questions 1120. At block 1514, the exam generator 160 receives, from the user device associated with the instructor 150, a verification (e.g., an acceptance) of at least a first question 1120 of the one or more questions 1120. At block 1516, the exam generator 160 adds, based on the verification, the first question 1120 to an exam library 174.

In an embodiment, the initiating the one or more LLMs 112 to generate the one or more questions 1120 at block 1508 is based on an absence of the one or more questions 1120 associated with the one or more knowledge concepts in the exam library 174. In other words, the exam generator 160 may reuse questions 176 stored in the exam library 174, if available. In this way, resource utilization and processing overhead may be reduced.

In an embodiment, the exam generator 160 further receives, from a user device (e.g., the student computing device 102) associated with a student 140 of the particular course 502 or the user device associated with the instructor 150 of the particular course 502, feedback (e.g., the instructor feedback 1116 and/or the student feedback 1118) associated with a first verified question 176 of the verified questions 176 in the exam library 170. The exam generator 160 may remove the first verified question 176 from the exam library 174 based on the feedback. For instance, the feedback may indicate that the first verified question 176 has a content issue or a phrasing or style issue that causes confusion to students 140 (e.g., resulting in a large number of students 140 having a low score 172 for that question 176 wrong).

In an embodiment, the exam generator 160 further receives, from the user device associated with the instructor 150, an update to the first question 1120 before receiving the verification of the first question 1120 at block 1514. For instance, the instructor 150 may edit the first question 1120 (e.g., via the UI 1200) and then indicate the verification. In an embodiment, the exam generator 160 further receives, from the user device associated with the instructor 150, feedback (e.g., the instructor feedback 1116) associated with at least a second question 1120 of the generated one or more questions 1120. The exam generator 160 further trains the one or more LLMs 112 based on the feedback associated with the second question 1120.

In an embodiment, the one or more prompts further include an indication to prioritize a first portion of the course material 109 associated with the one or more knowledge concepts over a second portion of the course material 109 associated with the one or more knowledge concepts for generating the one or more questions 1120. The prioritizing is based on an indicator associated with the first portion of the course material. In an example, the indicator may be a tag generated by the instructor 150. In another example, the indicator may be a highlight indicator, where the first portion of the course material is highlighted. In yet another example, the indicator may indicate that the first portion includes the instructor's 150 response to a student's 140 query (e.g., that was stored in the experience database 110 and promoted to the knowledge database 108 as part of the course material 109 as discussed above with reference to FIGS. 3A-3B).

Turning now to FIG. 16A, an example UI 1600 associated with evaluation of student assessment is described. In an embodiment, the UI 1600 may be rendered by the instructor client application 152 and communicate with the exam grader 162 (e.g., via APIs). For instance, the instructor 150 may execute the instructor client application 152 on the instructor computing device 104 and may communicate with the exam grader 162 using the UI 1600.

As shown in FIG. 16A, the UI 1600 may include a question 1120, an answer 1122, a solution 1602, and a rubric 1140. The question 1120, answer 1122, solution 1602, and rubric 1140 may be generated by one or more LLMs 112. The question 1120, answer 1122, solution 1602, and rubric 1140 may be modifiable by the instructor 150. In an embodiment, the rubric 1140 comprises a plurality of rubric elements 1604 or evaluation objectives and the number of scoring points 1606 for each rubric element 1604. The plurality of rubric elements 1604 and/or the number of scoring points 1606 for each rubric element 1604 may be modifiable by the instructor 150. A rubric element 1604 and corresponding number of scoring points 1606 may be deleted by the instructor via a deletion button 1608. The UI 1600 may also include an add rubric button 1610 if the instructor 150 prefers to add a different rubric.

FIG. 16A is merely an example of components of a UI 1600, and variations are contemplated to be within the scope of the present disclosure. In embodiments, the UI 1600 may include other components not illustrated in FIG. 16A. In embodiments, the UI 1600 may not include every component illustrated in FIG. 16A. In embodiments, the components of the UI 1600 may be arranged differently than those illustrated in FIG. 16A. Such and other embodiments are contemplated to be within the scope of the present disclosure.

Turning now to FIG. 16B, an example UI 1650 associated with an evaluation output is described. In an embodiment, the UI 1650 may be rendered by the instructor client application 152 and communicate with the exam grader 162 (e.g., via APIs). For instance, the instructor 150 may execute the instructor client application 152 on the instructor computing device 104 and may communicate with the exam grader 162 using the UI 1650. In other embodiments, such as after the instructor 150 publishes the evaluation output, the UI 1650 may be rendered by the student client application 142 and communicate with the exam grader 162 (e.g., via APIs). For instance, the student 140 may execute the student client application 142 on the student computing device 102 and may communicate with the exam grader 162 using the UI 1650.

As shown in FIG. 16B, the UI 1650 may include the question 1120, the answer 1122, the solution 1602, and the rubric 1140. The UI 1650 may also include a student answer 1104 as well as comments 1652. The rubric 1140 in the UI 1650 may comprise the plurality of rubric elements 1604 and the number of scoring points 1606 for each rubric element 1604 as well as the number of scoring points awarded 1654. The comments 1652 and the number of scoring points awarded 1654 may be generated by one or more LLMs 112. The instructor 150 may have to approve or publish the evaluation output before the student 140 is able to access UI 1650.

FIG. 16B is merely an example of components of a UI 1650, and variations are contemplated to be within the scope of the present disclosure. In embodiments, the UI 1650 may include other components not illustrated in FIG. 16B. In embodiments, the UI 1650 may not include every component illustrated in FIG. 16B. In embodiments, the components of the UI 1650 may be arranged differently than those illustrated in FIG. 16B. Such and other embodiments are contemplated to be within the scope of the present disclosure.

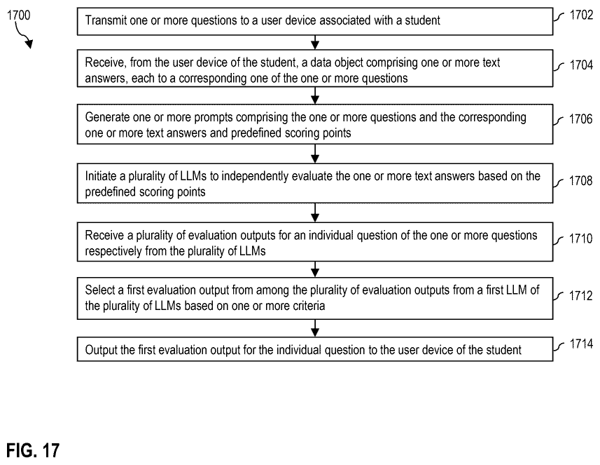

Turning now to FIG. 17, an example method 1700 of providing automatic evaluation of student assessment based on multiple independent large language model (LLMs) is described. The method 1700 may include similar mechanisms as discussed above with reference to FIGS. 1, 11, and 16. The method 1700 may be implemented by the exam grader 162. In embodiments, the method 1700 may be implemented using a computer system with components as shown in FIG. 20. As illustrated, FIG. 17 includes a number of enumerated operations, but embodiments of the operations in FIG. 17 may include additional operations before, after, and in between the enumerated operations. In some embodiments, one or more of the enumerated operations may be omitted or performed in a different order.

At block 1702, one or more questions are transmitted to a user device associated with a student 140. For example, the exam generator 160 may transmit the one or more questions 1120 to the user device associated with the student 140. The one or more questions 1120 and the student 140 are associated with a particular course. At block 1704, the exam grader 162 receives, from the user device of the student 140, a data object comprising one or more text answers 1104, each to a corresponding one of the one or more questions 1120. At block 1706, the exam grader 162 generates one or more prompts comprising the one or more questions and the corresponding one or more text answers and predefined scoring points. At block 1708, the exam grader 162 initiates a plurality of LLMs 112 to independently evaluate the one or more text answers 1104 based on the predefined scoring points. At block 1710, the exam grader 162 receives a plurality of evaluation outputs for an individual question of the one or more questions 1120 respectively from the plurality of LLMs 112. At block 1712, the exam grader 162 selects a first evaluation from among the plurality of evaluation outputs from a first LLM of the plurality of LLMs 112 based on one or more criteria. At block 1714, the exam grader 162 outputs the first evaluation output for the individual question to the user device of the student 140.

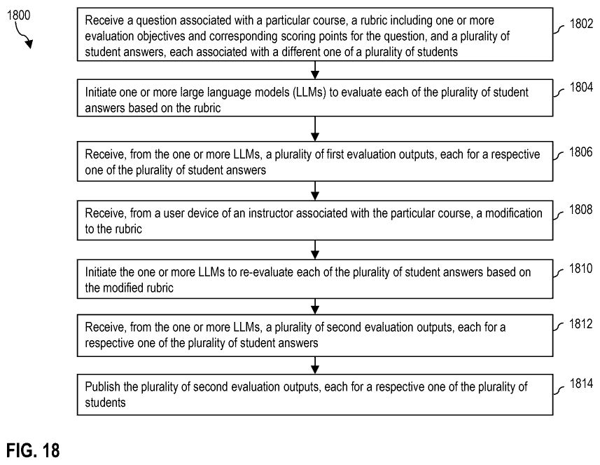

Turning now to FIG. 18, an example method 1800 of providing assessment evaluation with dynamic rubric update and batch re-evaluation is described. The method 1800 may include similar mechanisms as discussed above with reference to FIGS. 1, 11, 16, and 17. The method 1800 may be implemented by the exam grader 162. In embodiments, the method 1800 may be implemented using a computer system with components as shown in FIG. 20. As illustrated, FIG. 18 includes a number of enumerated operations, but embodiments of the operations in FIG. 18 may include additional operations before, after, and in between the enumerated operations. In some embodiments, one or more of the enumerated operations may be omitted or performed in a different order.

At block 1802, the exam grader 162 receives a question 1120 associated with a particular course, a rubric 1140 including one or more evaluation objectives and corresponding scoring points for the questions, and a plurality of student answers 1104, each associated with a different one of a plurality of students 140. At block 1804, the exam grader 162 initiates one or more large language models (LLMs) 112 to evaluate each of the plurality of student answers 1104 based on the rubric 1140. In some embodiments, the exam grader 162 initiates a plurality of LLMs 112 to evaluate each of the plurality of student answer 1104 based on a plurality of rubrics according to a role for the particular LLM (e.g., advocate, critic, jury, etc.).

At block 1806, the exam grader 162 receives, from the one or more LLMs 112, a plurality of first evaluation outputs, each for a respective one of the plurality of student answers 1104. At block 1808, the exam grader 162 receives, from a user device of an instructor 150 associated with the particular course, a modification to the rubric 1140. At block 1810, the exam grader 162 initiates the one or more LLMs 112 to re-evaluate each of the plurality of student answers 1104 based on the modified rubric 1140. In some embodiments, the exam grader 162 initiates a plurality of LLMs 112 to evaluate each of the plurality of student answer 1104 based on a plurality of modified rubrics according to a role for the particular LLM (e.g., advocate, critic, jury, etc.). At block 1812, the exam grader 162 receives, from the one or more LLMs 112, a plurality of second evaluation outputs, each for a respective one of the plurality of student answers 1104. At block 1814, the exam grader 162 publishes the plurality of second evaluation outputs, each for a respective one of the plurality of students 140.

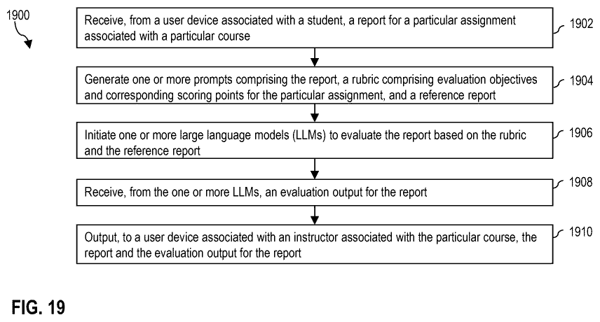

Turning now to FIG. 19, an example method 1900 of providing automatic evaluation of reports with evaluation comments embedded in the reports is described. The method 1900 may include similar mechanisms as discussed above with reference to FIGS. 1, 11, and 16-18. The method 1900 may be implemented by the exam grader 162. In embodiments, the method 1900 may be implemented using a computer system with components as shown in FIG. 20. As illustrated, FIG. 19 includes a number of enumerated operations, but embodiments of the operations in FIG. 19 may include additional operations before, after, and in between the enumerated operations. In some embodiments, one or more of the enumerated operations may be omitted or performed in a different order.

At block 1902, the exam grader 162 receives, from a user device associated with a student 140, a report for a particular assignment associated with a particular course. At block 1904, the exam grader 162 generates one or more prompts comprising the report, a rubric 1140 comprising evaluation objectives and corresponding scoring points for the particular assignment, and a reference report. At block 1906, the exam grader 162 initiates one or more large language models (LLMs) 112 to evaluate the report based on the rubric 1140 and the reference report. At block 1908, the exam grader 162 receives, from the one or more LLMs 112, an evaluation output for the report. The evaluation output comprises (1) a plurality of scoring points, each for a corresponding one of the evaluation objectives and based on a corresponding one of the predefined scoring points, and (2) a copy of the report with at least one comment associated with one of the evaluation objectives and embedded in a corresponding portion of the copy of the report. At block 1910, the exam grader 162 outputs, to a user device associated with an instructor 150 associated with the particular course, the report and the evaluation output for the report.

FIG. 20 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method of providing artificial intelligence (AI)-driven personalized adaptive assessment question generation based on instructor-specific course material, student-specific query-response data, and student-specific assessment scores, the method comprising:
receiving, by an exam generator stored in non-transitory memory of a computer system and executable by a processor of the computer system, course material for a particular course from a knowledge database;
receiving, by the exam generator, student query-response data between an individual student and an interactive natural language-based teaching assistant (TA), the student query-response data being associated with the particular course;
receiving, by the exam generator, student scores of the individual student associated with assessments corresponding to the particular course;
identifying, by the exam generator, at least one particular knowledge concept associated with a learning difficulty of the individual student based on the course material, the student query-response data of the individual student, and the student scores of the individual student;
generating, by the exam generator, one or more prompts including the course material and the at least one particular knowledge concept;
initiating, by the exam generator, one or more large-language models (LLMs) to generate one or more questions for the individual student based on the one or more prompts;
receiving, by the exam generator, the one or more questions from the one or more LLMs; and
outputting, by the exam generator, the one or more questions to a user device associated with the individual student.

2. The method of claim 1, wherein the one or prompts are generated responsive to a request from the user device associated with the individual student.

3. The method of claim 1, wherein the assessments associated with the student scores of the individual student comprise at least one of a quiz, a midterm exam, a final exam, an assignment, or a project associated with the course material.

4. The method of claim 1, wherein at least one of the student scores of the individual student is based on an output of an artificial intelligence (AI)-based exam grader, the output being based on a corresponding one of the assessments.

5. The method of claim 1, further comprising:
receiving, by the exam generator, from a user device associated with an instructor of the particular course, an expected student performance for a first learning level associated with the course material; and
determining, by the exam generator, that one or more of the student scores of the individual student satisfy the expected student performance for the first learning level,
wherein the one or more prompts further comprise an indication of a second learning level more advanced than the first learning level based on the one or more of the student scores of the individual student satisfying the expected student performance for the first learning level.

6. The method of claim 1, further comprising:
receiving, by the exam generator, from the one or more LLMs, one or more answers corresponding to the one or more questions; and
outputting, by the exam generator, the one or more questions and the corresponding one or more answers to an artificial intelligence (AI)-based exam grader.

7. The method of claim 1, further comprising:
initiating, by the exam generator, based on the identified learning difficulty of the individual student, one or more machine learning (ML) models to identify recommended learning material for the individual student from the course material in the knowledge database;
receiving, by the exam generator, the recommended learning material for the individual student from the one or more ML models; and
outputting, by the exam generator, the recommended learning material to the user device associated with the individual student.

8. The method of claim 1, further comprising:
receiving, by the exam generator, from the user device associated with the individual student, feedback about the one or more questions; and
initiating, by the exam generator, training of the one or more LLMs based on the feedback.

9. A computer-implemented method of providing artificial intelligence (AI)-driven course-specific assessment question generation based on an instructor-defined framework, the method comprising:
receiving, by an exam generator platform comprising at least one memory and at least one processor, course material for a particular course from a knowledge database;
receiving, by the exam generator platform, from a user device associated with an instructor of the particular course, one or more learning concepts and an assessment goal for the particular course;
generating, by the exam generator platform, one or more prompts comprising the course material, the one or more learning concepts, and the assessment goal for the particular course;
initiating, by the exam generator platform, a large language model (LLM) to generate one or more questions for one or more students based on the one or more prompts;
receiving, by the exam generator platform, the one or more questions from the one or more LLMs; and
providing, by the exam generator platform, the one or more questions to the one or more students.

10. The method of claim 9, wherein the assessment goal in the one or more prompts comprises an indication of an exam category associated with a quiz, a midterm exam, a final exam, an assignment, or a project.

11. The method of claim 9, wherein the one or more prompts further comprise a learning level of the one or more students.

12. The method of claim 9, wherein the one or more prompts further comprise a question format for the one or more questions.

13. The method of claim 9, wherein the one or prompts are generated responsive to a request from the user device associated with the instructor of the particular course.

14. The method of claim 9, further comprising:
receiving, by the exam generator platform, feedback about the one or more questions from at least one of the user device associated with the instructor of the particular course or a user device associated with a student of the particular course; and
training the one or more LLMs based on the feedback from the at least one of the user device associated with the instructor or the user device associated with the student.

15. A system for providing interactive course-specific assessment question generation with dynamic augmentation to an exam library based on instructor-verified questions, the system comprising:
at least one processor;
at least one non-transitory memory;
a knowledge database comprising course material of a particular course;
an exam library comprising verified questions associated with the course material of the particular course; and
an exam generator comprising instructions stored in the at least one non-transitory memory and executable by the at least one processor, when executed by the processor, causes the exam generator to:
receive an indication of one or more knowledge concepts and an assessment goal for the particular course;
generate one or more prompts including the course material, the one or more knowledge concepts, and the assessment goal;
initiate one or more large-language models (LLMs) to generate one or more questions for one or more students based on the one or more prompts;
receive, from the one or more LLMs, the one or more questions;
transmit, to a user device associated with an instructor of the particular course, the one or more questions;
receive, from the user device associated with the instructor, a verification of at least a first question of the one or more questions; and
add, based on the verification, the first question to the exam library.

16. The system of claim 15, wherein the initiating the one or more LLMs to generate the one or more questions is based on an absence of the one or more questions associated with the one or more knowledge concepts of the course material in the exam library.

17. The system of claim 15, wherein the exam generator is further caused to:
receive, from a user device associated with a student of the particular course or the user device associated with the instructor of the particular course, feedback associated with a first verified question of the verified questions in the exam library; and
remove the first verified question from the exam library based on the feedback.

18. The system of claim 15, wherein the exam generator is further caused to:
receive, from the user device associated with the instructor, an update to the first question before receiving the verification of the first question.

19. The system of claim 15, wherein the exam generator is further caused to:
receive, from the user device associated with the instructor, feedback associated with at least a second question of the generated one or more questions; and
training, by the exam generator, the one or more LLMs based on the feedback associated with the second question.

20. The system of claim 15, wherein:
the one or more prompts further comprise an indication to prioritize a first portion of the course material associated with the one or more knowledge concepts over a second portion of the course material associated with the one or more knowledge concepts for generating the one or more questions, and
the prioritizing is based on an indicator associated with the first portion of the course material.
